(19) United States
(12) Patent Application Publication
(10) Pub. No.: US 2026/0362327 A1
(43) Pub. Date: Nov. 12, 2026

(54) Wake-Up Receiver (WUR) Operation

(71) Applicant: Telefonaktiebolaget LM Ericsson (publ), Stockholm (SE)

(72) Inventors: Andreas Höglund, Solna (SE); Zhilan Xiong, Solna (SE); Mohammad Mozaffari, Fremont, CA (US); Kittipong Kittichokechai, Järfälla (SE); Mattias Andersson, Sundbyberg (SE)

(21) Appl. No.: 19/126,349

(22) PCT Filed: Nov. 1, 2023
(86) PCT No.: PCT/SE2023/051102

§ 371 Date: May 1, 2025

Related U.S. Application Data
(60) Provisional application No. 63/421,975, filed on Nov. 2, 2022.

(51) Int. Cl. H04W 52/02; H04W 36/00

(52) U.S. Cl. CPC H04W 52/0235; H04W 36/0085

(57) ABSTRACT

A method performed by a communication device (12) is disclosed. The communication device (12) receives signaling (20) indicating which type of signal (18) and/or which type of receiver (16) the communication device (12) is to use for mobility measurements. The communication device (12) uses the indicated type of signal (18) and/or the indicated type of receiver (16) for mobility measurements.

### TECHNICAL FIELD

The present application relates generally to a communication device and relates more particularly to operation of a wake-up receiver of the communication device.

### BACKGROUND

A communication network transmits a paging message to a communication device in order to trigger the device to connect to the communication network, e.g., for receiving downlink user data. The paging message may for instance be transmitted over a downlink control channel, e.g., a Physical Downlink Control Channel (PDCCH). A communication device in this case must monitor and decode the downlink control channel in order to determine whether any paging message is intended for the device. Such monitoring and decoding, however, consumes device power and negatively impacts device battery life.

Reduced power consumption and improved battery life can be realized by the use of a so-called wake-up signal (WUS). A wake-up signal is a signal that indicates a communication device is to wake-up one or more receiver components, if needed, and monitor a downlink control channel, e.g., for any paging message intended for the device. A wake-up signal is designed so that it can be detected more quickly and/or without consuming as much power as compared to monitoring and decoding a downlink control channel. Exploiting a wake-up signal affords a communication device more frequent opportunities to operate in a low power mode, e.g., in between occasions in which the device is to monitor for the wake-up signal.

Yet additional power conservation and battery life can be realized by using a so-called wake-up receiver (WUR) to monitor for and receive the wake-up signal. A wake-up receiver is a receiver that is capable of receiving a wake-up signal and that is separate from another receiver (referred to as a main receiver) which is woken up upon the wake-up receiver receiving the wake-up signal. The wake-up receiver's circuitry is less complex and/or more power efficient than the main receiver. This may mean that the main receiver is capable of receiving some signals or channels that the wake-up receiver cannot. For example, the main receiver may be capable of receiving one or more other signals or channels (e.g., PDCCH) needed for connecting to the communication network, but the wake-up receiver may not be capable of receiving such signals or channels. Relieved of the need to receive the other signal(s) or channel(s), the wake-up receiver can be simplified and more power efficient than the main receiver. The wake-up receiver may for instance be dedicated for receiving the wake-up signal, and optionally, a synchronization signal. Or, even if not so dedicated, the wake-up receiver may be dedicated or tailored for receiving one or more signals or channels in a Radio Resource Control (RRC) idle state or an RRC inactive state, i.e., to the exclusion of one or more other signals or channels in an RRC connected state. In these and other cases, a communication device may be equipped with both a wake-up receiver and another receiver (e.g., referred to as a main receiver) capable of receiving the other signal(s) or channel(s) that the wake-up receiver is not capable of receiving. The communication device can then power down one or more components of its main receiver unless and until its wake-up receiver receives a wake-up signal.

One potential benefit of a WUR is thereby lower energy consumption and longer device battery life. This proves especially beneficial at the cell edge. Alternatively, for a fixed energy consumption, a WUR can advantageously reduce downlink latency, e.g., via shorter discontinuous reception (DRX) duty-cycles and more frequent checks for incoming transmissions.

Challenges nonetheless still exist in minimizing device power consumption and prolonging battery life. Indeed, even if a communication device can use a wake-up receiver to reduce how often the device has to monitor a downlink control channel, a communication device heretofore still must use its main receiver to handle mobility, since a wake-up receiver is heretofore incapable of receiving the type of signal on which mobility measurements are to be performed. But performing mobility measurements frequently using the main receiver will severely limit the gains achievable from the wake-up receiver, since the main receiver would have to be started up relatively frequently and therefore cannot be kept in a deep sleep state. And introducing a new type of signal usable by a wake-up receiver would undesirably increase signal overhead, network energy consumption, inter-cell interference, and difficulties for spectrum sharing. Challenges therefore exist for how to realize the benefits of a wake-up receiver, especially at the cell edge, yet still handle device mobility.

### SUMMARY

Some embodiments herein generally provide flexibility regarding which type of receiver and/or which type of signal is used for a purpose, such as mobility measurements. For example, some embodiments provide flexibility regarding whether a communication device uses its main receiver or its wake-up receiver for mobility measurements. Such flexibility may advantageously enable configurability and/or adaptability in this regard on an as-needed basis, to realize the benefits of a wake-up receiver when needed (e.g., at cell edge) but otherwise minimize signal overhead, network energy consumption, and inter-cell interference.

More particularly, embodiments herein include a method performed by a communication device. The method comprises receiving signaling indicating which type of signal and/or which type of receiver the communication device is to use for a purpose.

In some embodiments, the signaling indicates which type of signal the communication device is to use for a purpose, out of multiple types of signals that are usable for the purpose. In one embodiment, the multiple types of signals include a first type of signal that is receivable by a first type of receiver, and a second type of signal that is receivable by a second type of receiver and is not receivable by the first type of receiver. In some embodiments, the first type of receiver is a wake-up receiver, WUR. In some embodiments, the first type of receiver is a receiver configured to receive a wake-up signal that triggers the communication device to awaken the second type of receiver from a sleep state. In some embodiments, the first type of receiver is a non-coherent receiver and the second type of receiver is a coherent receiver.

In some embodiments, the signaling indicates which type of signal the communication device is to use for a purpose, out of multiple types of signals that are usable for the purpose. In one embodiment, the multiple types of signals include a first type of signal that is an on-off keying, OOK, signal or a frequency shift keying, FSK, signal. In some embodiments, the multiple types of signals include a second type of signal that is based on a Zadoff-Chu sequence or a maximum length sequence, m-sequence.

In some embodiments, the signaling indicates which type of signal the communication device is to use for a purpose, out of multiple types of signals that are usable for the purpose. In one embodiment, the multiple types of signals include a first type of signal that is a WUR synchronization signal, WUR-SS, or that is included in a WUR synchronization signal block, WUR-SSB. In some embodiments, the WUR-SS or WUR-SSB is receivable by and/or specific for a WUR. In some embodiments, the multiple types of signals include a second type of signal that is a SS or SSB which is not receivable by and/or is not specific for a WUR.

In some embodiments, the signaling indicates which type of signal the communication device is to use for a purpose, out of multiple types of signals that are usable for the purpose. In one embodiment, the multiple types of signals include a first type of synchronization signal and a second type of synchronization signal. In other embodiments, the multiple types of signals include a synchronization signal in a first type of synchronization signal block, SSB, and a synchronization signal in a second type of SSB.

In some embodiments, the signaling indicates which type of signal the communication device is to use for a purpose, out of multiple types of signals that are usable for the purpose. In one embodiment, the multiple types of signals include a first type of reference signal and a second type of reference signal.

In some embodiments, the purpose is mobility measurements or radio resource management, RRM, measurements.

In some embodiments, the purpose is cell identification.

In some embodiments, the purpose is synchronization.

In some embodiments, the signaling indicates which type of signal and/or which type of receiver the communication device is to use for the purpose in a Radio Resource Control, RRC, idle state or in an RRC inactive state.

In some embodiments, the signaling indicates which type of signal and/or which type of receiver the communication device is to use for the purpose in a cell.

In some embodiments, the signaling is broadcast signaling and/or is included in System Information.

In some embodiments, the signaling is included in a wake-up receiver configuration that configures a wake-up receiver of the communication device.

In some embodiments, the signaling comprises a message. In some embodiments, a value of, or a presence or absence of, a certain information element, IE, in the message indicates which type of signal and/or which type of receiver the communication device is to use for the purpose.

In some embodiments, the method further comprises using the indicated type of signal and/or the indicated type of receiver for the purpose.

In other embodiments, the signaling indicates which type of receiver the communication device is to use for the purpose, out of multiple types of receivers usable for the purpose, wherein the multiple types include a first type of receiver and a second type of receiver. In one embodiment, the first type of receiver is a wake-up receiver, WUR. In another embodiment, the first type of receiver is a receiver configured to receive a wake-up signal that triggers the communication device to awaken the second type of receiver from a sleep state. In another embodiment, the first type of receiver is a non-coherent receiver and the second type of receiver is a coherent receiver.

Other embodiments herein include a method performed by a communication device. The method comprises receiving signaling indicating which type of signal and which type of receiver the communication device is to use for mobility measurements and/or cell identification.

In some embodiments, the signaling indicates whether the communication device is to use, for mobility measurements and/or cell identification a first type of signal that is a WUR synchronization signal, WUR-SS, or that is included in a WUR synchronization signal block, WUR-SSB. In some embodiments, the WUR-SS or WUR-SSB is receivable by and/or specific for a WUR. In other embodiments, the signaling indicates whether the communication device is to use, for mobility measurements and/or cell identification a second type of signal that is a SS or SSB which is not receivable by and/or is not specific for a WUR.

Other embodiments herein include a method performed by a communication device. The method comprises performing a serving cell measurement on a serving cell of the communication device. In this case, the method further comprises, based on a result of the serving cell measurement, making a decision on whether or not to perform a neighbor cell measurement on one or more neighbor cells of the communication device. In this case, the method further comprises performing, or not performing, the neighbor cell measurement in accordance with the decision.

In some embodiments, the serving cell measurement is a reference signal received power, RSRP, measurement or a reference signal received quality, RSRQ, measurement.

In some embodiments, making the decision comprises making the decision to perform the neighbor cell measurement if the result of the serving cell measurement is below a first threshold. In some embodiments, making the decision comprises making the decision to not perform the neighbor cell measurement if the result of the serving cell measurement is above a second threshold, wherein either the first and second thresholds are the same or the first threshold is below the second threshold.

In some embodiments, the decision is a decision on in which of multiple measurement modes the communication device is to operate. In some embodiments, the multiple measurement modes include a serving cell only measurement mode in which the communication device performs the serving cell measurement, without performing any neighbor cell measurement. In some embodiments, the multiple measurement modes include a full measurement mode in which the communication device performs both the serving cell measurement and the neighbor cell measurement.

In some embodiments, the serving cell measurement is performed on a signal that the communication device receives from the serving cell using a wake-up receiver of the communication device.

In some embodiments, the serving cell measurement is performed on a WUR-SS or WUR-SSB received on the serving cell.

In some embodiments, the decision is to perform the neighbor cell measurement, and the method comprises performing the neighbor cell measurement. In some embodiments, the method further comprises, for each of the one or more neighbor cells, receiving a signal from the neighbor cell using a wake-up receiver of the communication device and performing the neighbor cell measurement on the received signal.

Other embodiments herein include a method performed by a communication device. The method comprises making a decision on which type of signal and/or which type of receiver to use for performing a measurement. In this case, the method also comprises performing the measurement according to the decision.

In some embodiments, the decision is made based on a result of the measurement as previously performed. In some embodiments, the decision is alternatively or additionally made based on a distance between the communication device and a serving radio network node serving the communication device.

In some embodiments, making the decision comprises deciding to use a first type of signal and/or a first type of receiver for performing the measurement if a result of the measurement as previously performed using the first type of signal and/or the first type of receiver is above a first threshold. In some embodiments, making the decision comprises deciding to use a second type of signal and/or a second type of receiver for performing the measurement if the result of the measurement as previously performed using the first type of signal and/or the first type of receiver is below a second threshold.

In some embodiments, making the decision comprises deciding to use a first type of signal and/or a first type of receiver for performing the measurement if a distance between the communication device and a serving radio network node serving the communication device is below a first threshold. In some embodiments, deciding to use a second type of signal and/or a second type of receiver for performing the measurement if the distance between the communication device and the serving radio network node serving the communication device is above a second threshold.

In some embodiments, making the decision comprises deciding to use a second type of signal and/or a second type of receiver for performing the measurement if one or more attempts to perform the measurement using a first type of signal and/or a first type of receiver have failed a threshold number of times, have failed for a threshold amount of time, and/or have failed over a threshold number of duty cycles. In other embodiments, making the decision alternatively or additionally comprises deciding to use a second type of signal and/or a second type of receiver for performing the measurement if a timer expires. In some embodiments, the communication device is configured to start the timer upon failure of one or more attempts to perform the measurement using a first type of signal and/or a first type of receiver, and the communication device is configured to stop the timer upon success of one or more attempts to perform the measurement using the first type of signal and/or the first type of receiver.

In some embodiments, the decision is made as part of making decisions to use different types of signals and/or different types of receivers at different times. In some embodiments, making the decisions comprises periodically deciding to perform the measurement with a first type of signal and/or a first type of receiver, according to a first period. In some embodiments, making the decisions comprises periodically deciding to perform the measurement with a second type of signal and/or a second type of receiver, according to a second period that is longer than the first period. In some embodiments, the method further comprises receiving signaling indicating the first period and/or the second period. In some embodiments, the second period is a multiple of the first period. In some embodiments, the second period is aligned with the first period, with the measurement being performed only with the second type of signal and/or the second type of receiver during any overlap between the first period and the second period.

In some embodiments, the communication device is powered by a battery, and wherein the decision is made based on a charge level of the battery. In some embodiments, making the decision comprises deciding to use a first type of signal and/or a first type of receiver for performing the measurement if the charge level is below a first threshold. In some embodiments, making the decision comprises deciding to use a second type of signal and/or a second type of receiver for performing the measurement if the charge level is above a second threshold.

In some embodiments, the decision is made based on a deployment scenario or radio environment of the communication device. In other embodiments, the decision is alternatively or additionally made based on sensitivities or architectures of types of receivers of the communication device.

In some embodiments, making the decision comprises deciding to use a first type of signal and/or a first type of receiver for performing the measurement if the communication device is in an indoor environment or a dense urban deployment. In some embodiments, making the decision comprises deciding to use a second type of signal and/or a second type of receiver for performing the measurement if the communication device is in an outdoor environment or a rural deployment.

In some embodiments, the decision is made based on which type of signal and/or which type of receiver a serving cell, or a target cell, of the communication device supports.

In some embodiments, the decision is made based on whether or not the communication device needs to change, or has changed, a serving cell of the communication device. In some embodiments, the decision is made to preferentially use a second type of signal and/or a second type of receiver when the communication device needs to change, or has changed, a serving cell of the communication device.

In some embodiments, the decision is a decision on which type of signal to use for performing the measurement. In some embodiments, the decision is a decision on which type of signal to use for performing the measurement, out of multiple types of signals with which the communication device is capable of performing the measurement. In some embodiments, the multiple types of signals include a first type of signal and a second type of signal. In some embodiments, the first type of signal is an on-off keying, OOK, signal or a frequency shift keying, FSK, signal. In some embodiments, the second type of signal is based on a Zadoff-Chu sequence or a maximum length sequence, m-sequence. In some embodiments, the first type of signal is WUR synchronization signal, WUR-SS, or that is included in a WUR synchronization signal block, WUR-SSB, and the WUR-SS or WUR-SSB is receivable by and/or specific for a WUR. In some embodiments, the second type of signal is a SS or SSB which is not receivable by and/or is not specific for a WUR. In some embodiments, the first type of signal and the second type of signal are a first type of synchronization signal and a second type of synchronization signal. In other embodiments, the first type of signal and the second type of signal are a synchronization signal in a first type of synchronization signal block, SSB, and a synchronization signal in a second type of SSB. In some embodiments, the first type of signal and the second type of signal are a first type of reference signal and a second type of reference signal.

In some embodiments, the decision is a decision on which type of receiver to use for performing the measurement. In some embodiments, the decision is a decision on which type of receiver to use for performing the measurement, out of multiple types of receivers with which the communication device is equipped. In some embodiments, the multiple types include a first type of receiver and a second type of receiver. In some embodiments, the first type of receiver is a wake-up receiver, WUR. In some embodiments, the first type of receiver is a receiver configured to receive a wake-up signal that triggers the communication device to awaken the second type of receiver from a sleep state. In some embodiments, the first type of receiver is a non-coherent receiver and the second type of receiver is a coherent receiver.

In some embodiments, the measurement is a mobility measurement, a radio resource management, RRM, measurement, a synchronization measurement, or a cell identification measurement.

In some embodiments, the measurement is a reference signal received power, RSRP, measurement or a reference signal received quality, RSRQ, measurement.

In some embodiments, the method further comprises using a result of the measurement for mobility, RRM, synchronization, or cell identification.

In some embodiments, the decision is made according to one or more rules, and the method further comprises receiving signaling configuring at least one of the one or more rules.

Other embodiments herein include a method performed by a communication device. The method comprises performing a measurement at different times with different types of signals and/or different types of receivers.

In some embodiments, performing the measurement comprises periodically performing the measurement with a first type of signal and/or a first type of receiver, according to a first period. In this case, performing the measurement also comprises periodically performing the measurement with a second type of signal and/or a second type of receiver, according to a second period that is longer than the first period.

In some embodiments, the method further comprises receiving signaling indicating the first period and/or the second period.

In some embodiments, the second period is a multiple of the first period.

In some embodiments, the second period is aligned with the first period, with the measurement being performed only with the second type of signal and/or the second type of receiver during any overlap between the first period and the second period.

Other embodiments herein include a method performed by a communication device. The method comprises receiving signaling indicating a first period according to which the communication device is to periodically perform a measurement with a first type of signal and/or a first type of receiver. In other embodiments, method alternatively or additionally comprises receiving signaling indicating a second period according to which the communication device is to periodically perform a measurement with a second type of signal and/or a second type of receiver.

In some embodiments, the method further comprises performing the measurement at different times with different types of signals and/or different types of receivers. In some embodiments, performing the measurement comprises periodically performing the measurement with the first type of signal and/or the first type of receiver, according to the first period. In some embodiments, performing the measurement comprises periodically performing the measurement with the second type of signal and/or the second type of receiver, according to the second period.

In some embodiments, the second period is longer than the first period. In some embodiments, the signaling indicates the first period and the second period.

In some embodiments, the second period is a multiple of the first period.

In some embodiments, the second period is aligned with the first period, with the measurement being performed only with the second type of signal and/or the second type of receiver during any overlap between the first period and the second period.

Other embodiments herein include a method performed by a communication device. The method comprises determining a period with which the communication device is to periodically perform a measurement, based on whether or not the communication device has or is operating with a wake-up receiver. In this case, the method also comprises periodically performing the measurement with the determined period.

In some embodiments, determining the period comprises determining the period to be a first period if the communication device has or is operating with a wake-up receiver. In some embodiments, determining the period comprises determining the period to be a second periodicity if the communication device does not have or is not operating with a wake-up receiver. In some embodiments, the second period is shorter than the first period. In some embodiments, the method further comprises receiving signaling indicating the first period and/or the second period.

In some embodiments, periodically performing the measurement comprises periodically performing the measurement with a receiver that is not a wake-up receiver.

Other embodiments herein include a method performed by a communication device. The method comprises making a decision of whether or not to relax measurements, based on whether or not the communication device has or is operating with a wake-up receiver. In this case, the method also comprises relaxing or not relaxing measurements according to the decision.

In some embodiments, the decision is made to relax measurements if the communication device has or is operating with a wake-up receiver.

In some embodiments, the measurements are mobility measurements, radio resource management, RRM, measurements, synchronization measurements, or cell identification measurements.

Other embodiments herein include a method performed by a communication device that has a first receiver and a second receiver. The method comprises using the first receiver to monitor for a wake-up signal that is to trigger the communication device to awaken the second receiver. In this case, the method also comprises periodically awakening the second receiver, even if no wake-up signal is received, to check for signaling indicating an update to System Information.

In some embodiments, the second receiver is periodically awakened to check for a value tag in System Information Block #1, SIB1, indicating an update to System Information. In some embodiments, SIB1 includes scheduling information for one or more other System Information Blocks.

In some embodiments, the second receiver is periodically awakened with a period that is longer than a period of wake-up signal occasions that the first receiver monitors for a wake-up signal.

In some embodiments, the second receiver is periodically awakened upon expiration of a timer.

In some embodiments, periodically awakening the second receiver comprises awakening the second receiver if the first receiver has been unable to monitor for the wake-up signal, and/or if the communication device has been out of coverage, for at least a threshold amount of time.

Other embodiments herein include a method performed by a communication device that has a first receiver and a second receiver. The method includes receiving a signal that indicates an update to System Information, wherein the signal is a wake-up signal, a WUR reference signal, a WUR synchronization signal, or a signal included in a WUR SSB.

In some embodiments, the signal is specific for indicating an update to System Information that governs a configuration of a WUR of the communication device.

In some embodiments, the signal is generic for indicating an update to any kind of System Information.

Other embodiments herein include a method performed by a network node. The method comprises transmitting, to a communication device, signaling indicating which type of signal and/or which type of receiver the communication device is to use for a purpose.

In some embodiments, the signaling indicates which type of signal the communication device is to use for a purpose, out of multiple types of signals that are usable for the purpose.

In some embodiments, the multiple types of signals include a first type of signal that is receivable by a first type of receiver, and a second type of signal that is receivable by a second type of receiver and is not receivable by the first type of receiver. In some embodiments, the first type of receiver is a wake-up receiver, WUR. In some embodiments, the first type of receiver is a receiver configured to receive a wake-up signal that triggers the communication device to awaken the second type of receiver from a sleep state. In some embodiments, the first type of receiver is a non-coherent receiver and the second type of receiver is a coherent receiver.

In some embodiments, the multiple types of signals include a first type of signal that is an on-off keying, OOK, signal or a frequency shift keying, FSK, signal, and a second type of signal that is based on a Zadoff-Chu sequence or a maximum length sequence, m-sequence.

In some embodiments, the multiple types of signals include first type of signal that is a WUR synchronization signal, WUR-SS, or that is included in a WUR synchronization signal block, WUR-SSB, wherein the WUR-SS or WUR-SSB is receivable by and/or specific for a WUR. In some embodiments, the multiple types of signals include a second type of signal that is a SS or SSB which is not receivable by and/or is not specific for a WUR.

In some embodiments, the multiple types of signals include a first type of synchronization signal and a second type of synchronization signal. In other embodiments, the multiple types of signals include a synchronization signal in a first type of synchronization signal block, SSB, and a synchronization signal in a second type of SSB.

In some embodiments, the multiple types of signals include a first type of reference signal and a second type of reference signal.

In some embodiments, the purpose is mobility measurements or radio resource management, RRM, measurements.

In some embodiments, the purpose is cell identification.

In some embodiments, the purpose is synchronization.

In some embodiments, the signaling indicates which type of signal and/or which type of receiver the communication device is to use for the purpose in a Radio Resource Control, RRC, idle state or in an RRC inactive state.

In some embodiments, the signaling indicates which type of signal and/or which type of receiver the communication device is to use for the purpose in a cell.

In some embodiments, the signaling is broadcast signaling and/or is included in System Information.

In some embodiments, the signaling is included in a wake-up receiver configuration that configures a wake-up receiver of the communication device.

In some embodiments, the signaling comprises a message. In some embodiments, a value of, or a presence or absence of, a certain information element, IE, in the message indicates which type of signal the communication device is to use for the purpose.

In other embodiments, the signaling indicates which type of receiver the communication device is to use for the purpose, out of multiple types of receivers usable for the purpose, wherein the multiple types include a first type of receiver and a second type of receiver. In one embodiment, the first type of receiver is a wake-up receiver, WUR. In another embodiment, the first type of receiver is a receiver configured to receive a wake-up signal that triggers the communication device to awaken the second type of receiver from a sleep state. In another embodiment, the first type of receiver is a non-coherent receiver and the second type of receiver is a coherent receiver.

In some embodiments, the method further comprises making a decision about which type of signal and/or which type of receiver the communication device is to use for the purpose.

Other embodiments herein include a method performed by a network node. The method comprises transmitting, to a communication device, signaling indicating which type of signal the communication device is to use for mobility measurements and/or cell identification.

In some embodiments, the signaling indicates whether the communication device is to use, for mobility measurements and/or cell identification a first type of signal that is a WUR synchronization signal, WUR-SS, or that is included in a WUR synchronization signal block, WUR-SSB, wherein the WUR-SS or WUR-SSB is receivable by and/or specific for a WUR. In other embodiments, the signaling indicates whether the communication device is to use, for mobility measurements and/or cell identification a second type of signal that is a SS or SSB which is not receivable by and/or is not specific for a WUR.

In some embodiments, the method further comprises making a decision about which type of signal and/or which type of receiver the communication device is to use for the mobility measurements and/or cell identification.

Other embodiments herein include a method performed by a network node. The method comprises transmitting, to a communication device, signaling that indicates a serving cell measurement threshold based on which the communication device is to make a decision on whether or not to perform a neighbor cell measurement on one or more neighbor cells of the communication device.

In some embodiments, the serving cell measurement threshold is a reference signal received power, RSRP, measurement threshold or a reference signal received quality, RSRQ, measurement threshold.

In some embodiments, the communication device is configured to make the decision to perform the neighbor cell measurement if a result of a serving cell measurement is below the serving cell measurement threshold. In other embodiments, the communication device is configured to make the decision to not perform the neighbor cell measurement if a result of a serving cell measurement is above the serving cell measurement threshold.

In some embodiments, the decision is a decision on in which of multiple measurement modes the communication device is to operate. In some embodiments, the multiple measurement modes include a serving cell only measurement mode in which the communication device performs a serving cell measurement, without performing any neighbor cell measurement. In other embodiments, the multiple measurement modes include a full measurement mode in which the communication device performs both a serving cell measurement and the neighbor cell measurement.

In some embodiments, the decision is to be made based on a serving cell measurement performed on a signal that the communication device receives from a serving cell using a wake-up receiver of the communication device.

In some embodiments, the decision is to be made based on a serving cell measurement performed on a WUR-SS or WUR-SSB received on a serving cell.

Other embodiments herein include a method performed by a network node. The method comprises transmitting, to a communication device, signaling that configures or governs a decision by the communication device on which type of signal and/or which type of receiver the communication device is to use for performing a measurement.

In some embodiments, the decision is to be made based on a result of the measurement as previously performed. In other embodiments, the decision is to be made alternatively or additionally based on a distance between the communication device and a serving radio network node serving the communication device.

In some embodiments, the signaling configures the communication device to decide to use a first type of signal and/or a first type of receiver for performing the measurement if a result of the measurement as previously performed using the first type of signal and/or the first type of receiver is above a first threshold. In some embodiments, the signaling configures the communication device to decide to use a second type of signal and/or a second type of receiver for performing the measurement if the result of the measurement as previously performed using the first type of signal and/or the first type of receiver is below a second threshold. In some embodiments, the signaling indicates the first threshold and/or the second threshold.

In some embodiments, the signaling configures the communication device to decide to use a first type of signal and/or a first type of receiver for performing the measurement if a distance between the communication device and a serving radio network node serving the communication device is above a first threshold. In some embodiments, the signaling configures the communication device to decide to use a second type of signal and/or a second type of receiver for performing the measurement if the distance between the communication device and the serving radio network node serving the communication device is below a second threshold. In some embodiments, the signaling indicates the first threshold and/or the second threshold.

In some embodiments, the signaling configures the communication device to decide to use a first type of signal and/or a first type of receiver for performing the measurement if a distance between the communication device and a serving radio network node serving the communication device is below a first threshold. In some embodiments, the signaling configures the communication device to decide to use a second type of signal and/or a second type of receiver for performing the measurement if the distance between the communication device and the serving radio network node serving the communication device is above a second threshold. In some embodiments, the signaling indicates the first threshold and/or the second threshold

In some embodiments, the signaling configures the communication device to use a second type of signal and/or a second type of receiver for performing the measurement if one or more attempts to perform the measurement using a first type of signal and/or a first type of receiver have failed a threshold number of times, have failed for a threshold amount of time, and/or have failed over a threshold number of duty cycles. In some embodiments, the signaling indicates the threshold number of times, the threshold amount of time, and/or the threshold number of duty cycles. In other embodiments, the signaling configures the communication device to use a second type of signal and/or a second type of receiver for performing the measurement if, alternatively or additionally, a timer expires. In some embodiments, the communication device is configured to start the timer upon failure of one or more attempts to perform the measurement using a first type of signal and/or a first type of receiver, and the communication device is configured to stop the timer upon success of one or more attempts to perform the measurement using the first type of signal and/or the first type of receiver. In some embodiments, the signaling indicates a duration of the timer.

In some embodiments, the signaling configures the communication device to make the decision as part of making decisions to use different types of signals and/or different types of receivers at different times. In some embodiments, the signaling configures the communication device to periodically decide to perform the measurement with a first type of signal and/or a first type of receiver, according to a first period. In some embodiments, the signaling configures the communication device to periodically decide to perform the measurement with a second type of signal and/or a second type of receiver, according to a second period that is longer than the first period. In some embodiments, the signaling indicates the first period and/or the second period. In some embodiments, the second period is a multiple of the first period. In some embodiments, the second period is aligned with the first period. In some embodiments, the signaling configures the communication device to perform the measurement only with the second type of signal and/or the second type of receiver during any overlap between the first period and the second period.

In some embodiments, the communication device is powered by a battery, and the decision is to be made based on a charge level of the battery.

In some embodiments, the signaling configures the communication device to decide to use a first type of signal and/or a first type of receiver for performing the measurement if the charge level is below a first threshold. In some embodiments, the signaling configures the communication device to decide to use a second type of signal and/or a second type of receiver for performing the measurement if the charge level is above a second threshold. In some embodiments, the signaling indicates the first threshold and/or the second threshold.

In some embodiments, the signaling configures the communication device to make the decision based on a deployment scenario or radio environment of the communication device. In other embodiments, the signaling configures the communication device to make the decision alternatively or additionally based on sensitivities or architectures of types of receivers of the communication device.

In some embodiments, the signaling configures the communication device to decide to use a first type of signal and/or a first type of receiver for performing the measurement if the communication device is in an indoor environment or a dense urban deployment. In some embodiments, the signaling configures the communication device to decide to use a second type of signal and/or a second type of receiver for performing the measurement if the communication device is in an outdoor environment or a rural deployment.

In some embodiments, the signaling configures the communication device to make the decision based on which type of signal and/or which type of receiver a serving cell, or a target cell, of the communication device supports.

In some embodiments, the signaling configures the communication device to make the decision based on whether or not the communication device needs to change, or has changed, a serving cell of the communication device. In some embodiments, the signaling configures the communication device to decide to preferentially use a second type of signal and/or a second type of receiver when the communication device needs to change, or has changed, a serving cell of the communication device.

In some embodiments, the decision is a decision on which type of signal to use for performing the measurement. In some embodiments, the decision is a decision on which type of signal to use for performing the measurement, out of multiple types of signals with which the communication device is capable of performing the measurement, wherein the multiple types of signals include a first type of signal and a second type of signal. In some embodiments, the first type of signal is an on-off keying, OOK, signal or a frequency shift keying, FSK, signal, and the second type of signal is based on a Zadoff-Chu sequence or a maximum length sequence, m-sequence. In some embodiments, the first type of signal is WUR synchronization signal, WUR-SS, or that is included in a WUR synchronization signal block, WUR-SSB, wherein the WUR-SS or WUR-SSB is receivable by and/or specific for a WUR. In some embodiments, the second type of signal is a SS or SSB which is not receivable by and/or is not specific for a WUR. In some embodiments, the first type of signal and the second type of signal are a first type of synchronization signal and a second type of synchronization signal. In other embodiments, the first type of signal and the second type of signal are a synchronization signal in a first type of synchronization signal block, SSB, and a synchronization signal in a second type of SSB. In some embodiments, the first type of signal and the second type of signal are a first type of reference signal and a second type of reference signal.

In some embodiments, the decision is a decision on which type of receiver to use for performing the measurement. In some embodiments, the decision is a decision on which type of receiver to use for performing the measurement, out of multiple types of receivers with which the communication device is equipped. In some embodiments, the multiple types include a first type of receiver and a second type of receiver. In some embodiments, the first type of receiver is a wake-up receiver, WUR. In some embodiments, the first type of receiver is a receiver configured to receive a wake-up signal that triggers the communication device to awaken the second type of receiver from a sleep state. In some embodiments, the first type of receiver is a non-coherent receiver and the second type of receiver is a coherent receiver.

In some embodiments, the measurement is a mobility measurement, a radio resource management, RRM, measurement, a synchronization measurement, or a cell identification measurement.

In some embodiments, the measurement is a reference signal received power, RSRP, measurement or a reference signal received quality, RSRQ, measurement.

In some embodiments, the method further comprises receiving a result of the measurement for mobility, RRM, synchronization, or cell identification.

In some embodiments, the decision is made according to one or more rules, and wherein the signaling configures at least one of the one or more rules.

Other embodiments herein include a method performed by a network node. The method comprises transmitting signaling to a communication device. In some embodiments, the signaling indicates a first period with which the communication device is to periodically perform a measurement when the communication device has or is operating with a wake-up receiver. In other embodiments, the signaling alternatively or additionally indicates a second period with which the communication device is to periodically perform a measurement when the communication device does not have or is not operating with a wake-up receiver.

In some embodiments, the first period is a period with which the communication device is to periodically perform the measurement with a receiver that is not a wake-up receiver, when the communication device has or is operating with a wake-up receiver. In other embodiments, the second period is a period with which the communication device is to periodically perform the measurement with a receiver that is not a wake-up receiver, when the communication device does not have or is not operating with a wake-up receiver.

Other embodiments herein include a method performed by a network node. The method comprises transmitting, to a communication device, signaling that configures the communication device to make a decision of whether or not to relax measurements based on whether or not the communication device has or is operating with a wake-up receiver.

In some embodiments, the signaling configures the communication device to decide to relax measurements if the communication device has or is operating with a wake-up receiver.

In some embodiments, the measurements are mobility measurements, radio resource management, RRM, measurements, synchronization measurements, or cell identification measurements.

Other embodiments herein include a method performed by a network node. The method comprises transmitting a signal that indicates an update to System Information. In some embodiments, the signal is a wake-up signal, a WUR reference signal, a WUR synchronization signal, or a signal included in a WUR SSB.

In some embodiments, the signal is specific for indicating an update to System Information that governs a configuration of a WUR of a communication device.

In some embodiments, the signal is generic for indicating an update to any kind of System Information.

### BRIEF DESCRIPTION OF THE DRAWINGS

FIG. 1 is a block diagram of a communication network according to some embodiments.

FIG. 2 is a logic flow diagram of a method performed by a communication device according to certain embodiments.

FIG. 3 depicts a method performed by the communication device in accordance with other particular embodiments.

FIG. 4 depicts a method performed by the communication device in accordance with still other particular embodiments.

FIG. 5 depicts a method performed by a communication device in accordance with other particular embodiments.

FIG. 6 depicts a method performed by a communication device in accordance with other particular embodiments.

FIG. 7 depicts a method performed by a communication device in accordance with other particular embodiments.

FIG. 8 depicts a method performed by a communication device in accordance with other particular embodiments.

FIG. 9 depicts a method performed by a communication device that has a first receiver and a second receiver in accordance with other particular embodiments.

FIG. 10 depicts a method performed by a communication device that has a first receiver and a second receiver in accordance with other particular embodiments.

FIG. 11 depicts a method performed by the communication device in accordance with yet other particular embodiments.

FIG. 12 depicts a method performed by a network node in accordance with other particular embodiments.

FIG. 13 depicts a method performed by a network node in accordance with other particular embodiments.

FIG. 14 depicts a method performed by a network node in accordance with other particular embodiments.

FIG. 15 depicts a method performed by a network node in accordance with other particular embodiments.

FIG. 16 depicts a method performed by a communication device in accordance with other particular embodiments.

FIG. 17 depicts a method performed by a network node in accordance with other particular embodiments.

FIG. 18 depicts a method performed by a network node in accordance with other particular embodiments.

FIG. 19 is a block diagram illustrating the location of a WUS and the paging occasion to which it is associated.

FIG. 20 is a block diagram illustrating a WUS of variable length up to a configured maximum WUS duration.

FIG. 21 is a block diagram on an exemplary use of eDRX and DRX WUS gaps for NB-IoT and LTE-M.

FIG. 22 is a block diagram illustrating a cell change for UE in WUR operation.

FIG. 23 is a block diagram of a communication device according to some embodiments.

FIG. 24 is a block diagram of a network node according to some embodiments.

FIG. 25 is a block diagram of a communication system in accordance with some embodiments.

FIG. 26 is a block diagram of a host according to some embodiments.

FIG. 27 is a block diagram of a host communicating via a network node with a UE over a partially wireless connection in accordance with some embodiments.

### DETAILED DESCRIPTION

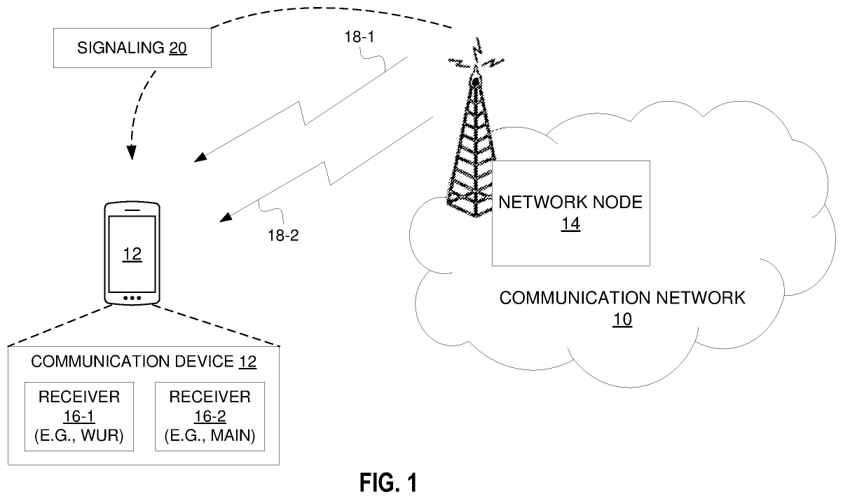

FIG. 1 shows a communication network 10 according to some embodiments, e.g., a 5G network. The communication network 10 is configured to provide communication service to a communication device 12, e.g., in the form of a user equipment (UE). The communication network 10 as shown may for instance include a network node 14 serving the communication device 12, e.g., in the form of a serving radio network node.

The communication device 12 in some embodiments has multiple types of receivers 16. FIG. 1 for example shows the communication device 12 as having at least a first type of receiver 16-1 and a second type of receiver 16-2. Different ones of the receivers 16 may accordingly be capable of receiving at least some different types of signals. As one example in this regard, the second type of receiver 16-2 may be a “main” receiver whereas the first type of receiver 16-1 may be a low power (LP) receiver, e.g., configured for lower power use when the main receiver is not needed. Alternatively or additionally, the second type of receiver 16-2 may be a coherent receiver whereas the first type of receiver 16-2 may be a non-coherent receiver.

For example, in some embodiments, the first type of receiver 16-1 is a wake-up receiver (WUR) designed for receiving a wake-up signal (WUS) (not shown) and the second type of receiver 16-2 is a “main” receiver capable of receiving one or more other types of signals. The wake-up signal has relatively low demands on receiver capability, complexity, and/or power consumption. Monitoring for the WUS using the WUR may consume less power than monitoring for the WUS using the main receiver. In this case, then, the communication device 12 may operate the main receiver in a sleep state while monitoring for the WUS using the WUR. Since the WUR consumes less power than the main receiver, this conserves device power. However, the WUR may be incapable of receiving one or more other signals (e.g., a Physical Downlink Control Channel (PDCCH) transmission) that have relatively higher demands on receiver capability, complexity, and/or power consumption. The WUS nonetheless indicates when the communication device 12 needs to monitor for other signal(s). Accordingly, when the WUR receives a WUS, the communication device 12 awakens the main receiver so that the main receiver can monitor for other signal(s). The WUS thereby triggers the communication device 12 to awaken the main receiver from the sleep state.

Alternatively or additionally to the communication device 12 being equipped with multiple types of receivers 16, the communication network 10 may be configurable to transmit multiple types of signals 18, including at least a first type of signal 18-1 and a second type of signal 18-2. In one embodiment, the first type of signal 18-1 is an on-off keying (OOK) signal, a frequency shift keying (FSK) signal, or some other type of signal that has relatively low demands on receiver capability, complexity, and/or power consumption. In these and other embodiments, the first type of signal 18-1 may be receivable by and/or specific for the first type of receiver 16-1 (e.g., a WUR). For example, the first type of signal 18-1 may be a first type of reference signal (e.g., a WUR reference signal), a first type of synchronization signal (e.g., a WUR synchronization signal), or a synchronization signal in a first type of synchronization signal block (e.g., a WUR synchronization signal block, WUR-SSB). By contrast, the second type of signal 18-2 may be based on a Zadoff-Chu sequence, be based on a maximum length sequence (m-sequence), or be some other type of signal that has relatively higher demands on receiver capability, complexity, and/or power consumption. In these and other embodiments, the second type of signal 18-2 may not be receivable by and/or not be specific for the first type of receiver 16-1 (e.g., a WUR). For example, the second type of signal 18-2 may be a second type of reference signal, a second type of synchronization signal (e.g., a synchronization signal), or a synchronization signal in a second type of synchronization signal block (e.g., a synchronization signal block, SSB).

Some embodiments herein generally provide flexibility regarding which type of receiver 16 and/or which type of signal 18 is used for a purpose, such as mobility measurements, radio resource management (RRM) measurements, synchronization, cell identification, etc. For example, some embodiments provide flexibility regarding whether the communication device 12 uses its main receiver or its WUR for the purpose.

Consider now various embodiments herein applicable for the context in FIG. 1.

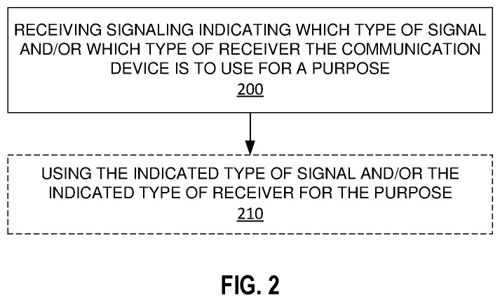

FIG. 2 depicts a method performed by the communication device 12 in accordance with particular embodiments. The method includes receiving signaling 20 indicating which type of signal 18 and/or which type of receiver 16 the communication device 12 is to use for a purpose, e.g., where the purpose may be mobility measurements, radio resource management (RRM) measurements, synchronization, cell identification, etc. (Block 200). In some embodiments, the method also comprises using the indicated type of signal 18 and/or the indicated type of receiver 16 for the purpose (Block 210).

In some embodiments, the signaling 20 indicates which type of signal 18-1 or 18-2 the communication device 12 is to use for a purpose, out of multiple types of signals 18-1, 18-2 that are usable for the purpose. In one embodiment, the multiple types of signals 18-1, 18-2 include a first type of signal 18-1 that is receivable by a first type of receiver 18-1, and a second type of signal 18-2 that is receivable by a second type of receiver 18-1 and is not receivable by the first type of receiver 16-1. In some embodiments, the first type of receiver 16-1 is a wake-up receiver, WUR, and/or is a receiver configured to receive a wake-up signal that triggers the communication device 12 to awaken the second type of receiver 16-2 from a sleep state. In some embodiments, the first type of receiver 16-1 is a non-coherent receiver and the second type of receiver 16-2 is a coherent receiver.

In some embodiments, the signaling 20 indicates which type of signal 18-1, 18-2 the communication device 12 is to use for a purpose, out of multiple types of signals that are usable for the purpose. In one embodiment, the multiple types of signals 18-1, 18-2 include a first type of signal 18-1 that is an on-off keying, OOK, signal or a frequency shift keying, FSK, signal. In some embodiments, the multiple types of signals 18-1, 18-2 include a second type of signal 18-2 that is based on a Zadoff-Chu sequence or a maximum length sequence, m-sequence.

In some embodiments, the signaling 20 indicates which type of signal 18-1, 18-2 the communication device 12 is to use for a purpose, out of multiple types of signals that are usable for the purpose. In one embodiment, the multiple types of signals 18-1, 18-2 include a first type of signal 18-1 that is a WUR synchronization signal, WUR-SS, or that is included in a WUR synchronization signal block, WUR-SSB. In some embodiments, the WUR-SS or WUR-SSB is receivable by and/or specific for a WUR. In some embodiments, the multiple types of signals include a second type of signal 18-2 that is a SS or SSB which is not receivable by and/or is not specific for a WUR.

In some embodiments, the signaling 20 indicates which type of signal the communication device 12 is to use for a purpose, out of multiple types of signals that are usable for the purpose. In one embodiment, the multiple types of signals 18-1, 18-2 include a first type of synchronization signal and a second type of synchronization signal. In other embodiments, the multiple types of signals 18-1, 18-2 include a synchronization signal in a first type of synchronization signal block, SSB, and a synchronization signal in a second type of SSB.

In some embodiments, the signaling 20 indicates which type of signal the communication device is to use for a purpose, out of multiple types of signals 18-1, 18-2 that are usable for the purpose. In one embodiment, the multiple types of signals include a first type of reference signal and a second type of reference signal.

In some embodiments, the purpose is mobility measurements or radio resource management, RRM, measurements.

In some embodiments, the purpose is cell identification.

In some embodiments, the purpose is synchronization.

In some embodiments, the signaling 20 indicates which type of signal 18-1, 18-2 and/or which type of receiver 16-1, 16-2 the communication device 12 is to use for the purpose in a Radio Resource Control, RRC, idle state or in an RRC inactive state.

In some embodiments, the signaling 20 indicates which type of signal 18-1, 18-2 and/or which type of receiver 16-1, 16-2 the communication device 12 is to use for the purpose in a cell.

In some embodiments, the signaling 20 is broadcast signaling and/or is included in System Information.

In some embodiments, the signaling 20 is included in a wake-up receiver configuration that configures a wake-up receiver of the communication device 12.

In some embodiments, the signaling 20 comprises a message. In some embodiments, a value of, or a presence or absence of, a certain information element, IE, in the message indicates which type of signal and/or which type of receiver the communication device 12 is to use for the purpose.

In some embodiments, the method further comprises using the indicated type of signal 18-1, 18-2 and/or the indicated type of receiver 16-1, 16-2 for the purpose (Block 210).

In other embodiments, the signaling 20 indicates which type of receiver 16-1, 16-2 the communication device 12 is to use for the purpose, out of multiple types of receivers 16-1, 16-2 usable for the purpose, wherein the multiple types include a first type of receiver 16-1 and a second type of receiver 16-2. In one embodiment, the first type of receiver 16-1 is a wake-up receiver, WUR, and/or is a receiver configured to receive a wake-up signal that triggers the communication device 12 to awaken the second type of receiver 16-2 from a sleep state. In another embodiment, the first type of receiver 16-1 is a non-coherent receiver and the second type of receiver 16-2 is a coherent receiver.

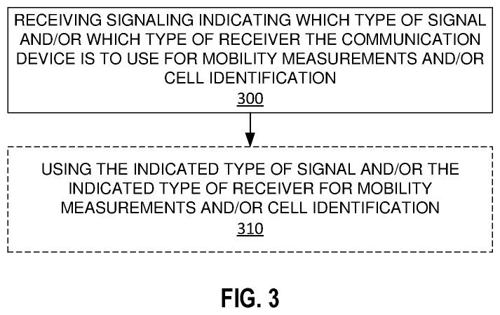

FIG. 3 depicts a method performed by the communication device 12 in accordance with other particular embodiments. The method includes receiving signaling 20 indicating which type of signal 18-1, 18-2 and/or which type of receiver 16-1, 16-2 the communication device 12 is to use for mobility measurements and/or cell identification (Block 300). In some embodiments, the method further comprises using the indicated type of signal 18-1, 18-2 and/or the indicated type of receiver 16-1, 16-2 for mobility measurements and/or cell identification (Block 310).

In some embodiments, the signaling 20 indicates whether the communication device 20 is to use, for mobility measurements and/or cell identification a first type of signal 18-1 that is a WUR synchronization signal, WUR-SS, or that is included in a WUR synchronization signal block, WUR-SSB. In some embodiments, the WUR-SS or WUR-SSB is receivable by and/or specific for a WUR. In other embodiments, the signaling 20 indicates whether the communication device 20 is to use, for mobility measurements and/or cell identification a second type of signal 18-2 that is a SS or SSB which is not receivable by and/or is not specific for a WUR.

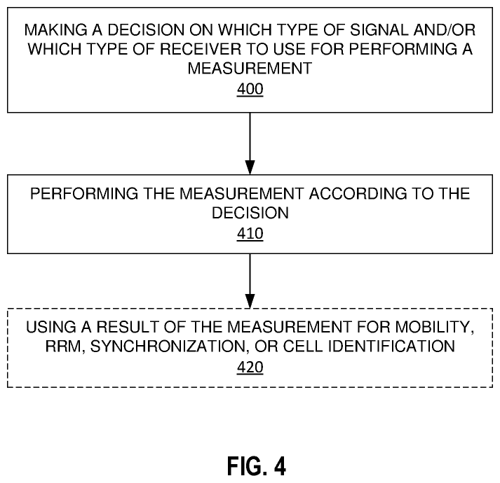

FIG. 4 depicts a method performed by the communication device 12 in accordance with still other particular embodiments. The method includes making a decision on which type of signal 18-1, 18-2 and/or which type of receiver 16-1, 16-2 to use for performing a measurement, e.g., a mobility measurement (Block 400). In this case, the method also includes performing the measurement according to the decision (Block 410).

In some embodiments, the decision is made based on a result of the measurement as previously performed. In some embodiments, the decision is alternatively or additionally made based on a distance between the communication device 12 and a serving radio network node serving the communication device 12.

In some embodiments, making the decision comprises deciding to use a first type of signal 18-1 and/or a first type of receiver 16-1 for performing the measurement if a result of the measurement as previously performed using the first type of signal 18-1 and/or the first type of receiver 16-1 is above a first threshold. In some embodiments, making the decision comprises deciding to use a second type of signal 18-2 and/or a second type of receiver 16-2 for performing the measurement if the result of the measurement as previously performed using the first type of signal 18-1 and/or the first type of receiver 16-1 is below a second threshold.

In some embodiments, making the decision comprises deciding to use a first type of signal 18-1 and/or a first type of receiver 16-1 for performing the measurement if a distance between the communication device 12 and a serving radio network node serving the communication device 12 is below a first threshold. In some embodiments, deciding to use a second type of signal 18-2 and/or a second type of receiver 16-2 for performing the measurement if the distance between the communication device 12 and the serving radio network node serving the communication device 12 is above a second threshold.

In some embodiments, making the decision comprises deciding to use a second type of signal 18-2 and/or a second type of receiver 16-2 for performing the measurement if one or more attempts to perform the measurement using a first type of signal 18-1 and/or a first type of receiver 16-1 have failed a threshold number of times, have failed for a threshold amount of time, and/or have failed over a threshold number of duty cycles. In other embodiments, making the decision alternatively or additionally comprises deciding to use a second type of signal 18-2 and/or a second type of receiver 16-2 for performing the measurement if a timer expires. In some embodiments, the communication device 12 is configured to start the timer upon failure of one or more attempts to perform the measurement using a first type of signal 18-1 and/or a first type of receiver 16-1, and the communication device 12 is configured to stop the timer upon success of one or more attempts to perform the measurement using the first type of signal 18-1 and/or the first type of receiver 16-1.

In some embodiments, the decision is made as part of making decisions to use different types of signals and/or different types of receivers at different times. In some embodiments, making the decisions comprises periodically deciding to perform the measurement with a first type of signal 18-1 and/or a first type of receiver 16-1, according to a first period. In some embodiments, making the decisions comprises periodically deciding to perform the measurement with a second type of signal 18-2 and/or a second type of receiver 16-2, according to a second period that is longer than the first period. In some embodiments, the method further comprises receiving signaling 20 indicating the first period and/or the second period. In some embodiments, the second period is a multiple of the first period. In some embodiments, the second period is aligned with the first period, with the measurement being performed only with the second type of signal 18-2 and/or the second type of receiver 16-2 during any overlap between the first period and the second period.

In some embodiments, the communication device 12 is powered by a battery, and wherein the decision is made based on a charge level of the battery. In some embodiments, making the decision comprises deciding to use a first type of signal 18-1 and/or a first type of receiver 16-1 for performing the measurement if the charge level is below a first threshold. In some embodiments, making the decision comprises deciding to use a second type of signal 18-2 and/or a second type of receiver 16-2 for performing the measurement if the charge level is above a second threshold.

In some embodiments, the decision is made based on a deployment scenario or radio environment of the communication device 12. In other embodiments, the decision is alternatively or additionally made based on sensitivities or architectures of types of receivers of the communication device 12.

In some embodiments, making the decision comprises deciding to use a first type of signal 18-1 and/or a first type of receiver 16-1 for performing the measurement if the communication device 12 is in an indoor environment or a dense urban deployment. In some embodiments, making the decision comprises deciding to use a second type of signal 18-2 and/or a second type of receiver 16-2 for performing the measurement if the communication device 12 is in an outdoor environment or a rural deployment.

In some embodiments, the decision is made based on which type of signal and/or which type of receiver a serving cell, or a target cell, of the communication device 12 supports.

In some embodiments, the decision is made based on whether or not the communication device 12 needs to change, or has changed, a serving cell of the communication device 12. In some embodiments, the decision is made to preferentially use a second type of signal 18-2 and/or a second type of receiver 16-2 when the communication device 12 needs to change, or has changed, a serving cell of the communication device 12.

In some embodiments, the decision is a decision on which type of signal to use for performing the measurement. In some embodiments, the decision is a decision on which type of signal to use for performing the measurement, out of multiple types of signals with which the communication device 12 is capable of performing the measurement. In some embodiments, the multiple types of signals include a first type of signal 18-1 and a second type of signal 18-2. In some embodiments, the first type of signal 18-1 is an on-off keying, OOK, signal or a frequency shift keying, FSK, signal. In some embodiments, the second type of signal 18-2 is based on a Zadoff-Chu sequence or a maximum length sequence, m-sequence. In some embodiments, the first type of signal 18-1 is WUR synchronization signal, WUR-SS, or that is included in a WUR synchronization signal block, WUR-SSB, and the WUR-SS or WUR-SSB is receivable by and/or specific for a WUR. In some embodiments, the second type of signal 18-2 is a SS or SSB which is not receivable by and/or is not specific for a WUR. In some embodiments, the first type of signal 18-1 and the second type of signal 18-2 are a first type of synchronization signal and a second type of synchronization signal. In other embodiments, the first type of signal 18-1 and the second type of signal 18-2 are a synchronization signal in a first type of synchronization signal block, SSB, and a synchronization signal in a second type of SSB. In some embodiments, the first type of signal 18-1 and the second type of signal 18-2 are a first type of reference signal and a second type of reference signal.

In some embodiments, the decision is a decision on which type of receiver to use for performing the measurement. In some embodiments, the decision is a decision on which type of receiver to use for performing the measurement, out of multiple types of receivers with which the communication device 12 is equipped. In some embodiments, the multiple types include a first type of receiver 16-1 and a second type of receiver 16-2. In some embodiments, the first type of receiver 16-1 is a wake-up receiver, WUR. In some embodiments, the first type of receiver 16-1 is a receiver configured to receive a wake-up signal that triggers the communication device 12 to awaken the second type of receiver 16-2 from a sleep state. In some embodiments, the first type of receiver 16-1 is a non-coherent receiver and the second type of receiver 16-2 is a coherent receiver.

In some embodiments, the measurement is a mobility measurement, a radio resource management, RRM, measurement, a synchronization measurement, or a cell identification measurement.

In some embodiments, the measurement is a reference signal received power, RSRP, measurement or a reference signal received quality, RSRQ, measurement.

In some embodiments, the method further comprises using a result of the measurement for mobility, RRM, synchronization, or cell identification (Block 420).

In some embodiments, the decision is made according to one or more rules, and the method further comprises receiving signaling 20 20 configuring at least one of the one or more rules.

Although the method in FIG. 4 is illustrated with respect to performing a measurement, the method may be generalized for any purpose, e.g., performing a measurement, cell identification, etc.

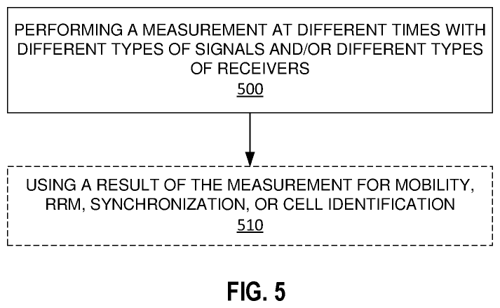

FIG. 5 depicts a method performed by a communication device 12 in accordance with other particular embodiments. The method includes performing a measurement at different times with different types of signals and/or different types of receivers (Block 500).

In some embodiments, the method further comprises using a result of the measurement for mobility, RRM, synchronization, or cell identification (Block 510).

In some embodiments, performing the measurement comprises periodically performing the measurement with a first type of signal 18-1 and/or a first type of receiver 16-1, according to a first period. In this case, performing the measurement also comprises periodically performing the measurement with a second type of signal 18-2 and/or a second type of receiver 16-2, according to a second period that is longer than the first period.

In some embodiments, the method further comprises receiving signaling 20 indicating the first period and/or the second period.

In some embodiments, the second period is a multiple of the first period.

In some embodiments, the second period is aligned with the first period, with the measurement being performed only with the second type of signal 18-2 and/or the second type of receiver 16-2 during any overlap between the first period and the second period.

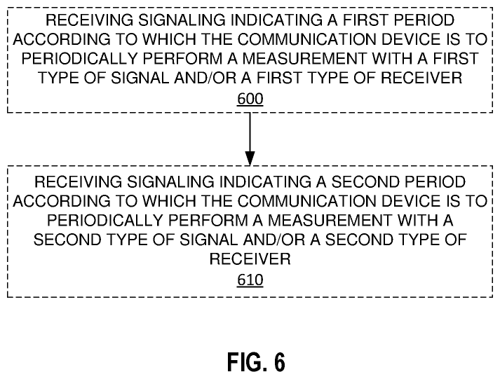

FIG. 6 depicts a method performed by a communication device 12 in accordance with other particular embodiments. The method includes receiving signaling 20 indicating a first period according to which the communication device 12 is to periodically perform a measurement with a first type of signal 18-1 and/or a first type of receiver 16-1 (Block 600). In this case, the method additionally or alternatively includes receiving signaling 20 indicating a second period according to which the communication device 12 is to periodically perform a measurement with a second type of signal 18-2 and/or a second type of receiver 16-2 (Block 610).

In some embodiments, the method further comprises performing the measurement at different times with different types of signals and/or different types of receivers. In some embodiments, performing the measurement comprises periodically performing the measurement with the first type of signal 18-1 and/or the first type of receiver 16-1, according to the first period. In some embodiments, performing the measurement comprises periodically performing the measurement with the second type of signal 18-2 and/or the second type of receiver 16-2, according to the second period.

In some embodiments, the second period is longer than the first period. In some embodiments, the signaling 20 indicates the first period and the second period.

In some embodiments, the second period is a multiple of the first period.

In some embodiments, the second period is aligned with the first period, with the measurement being performed only with the second type of signal 18-2 and/or the second type of receiver 16-2 during any overlap between the first period and the second period.

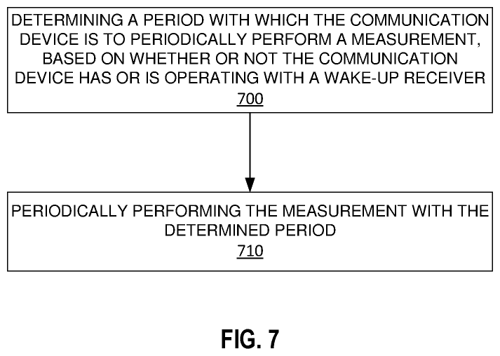

FIG. 7 depicts a method performed by a communication device 12 in accordance with other particular embodiments. The method includes determining a period with which the communication device 12 is to periodically perform a measurement, based on whether or not the communication device 12 has or is operating with a wake-up receiver (Block 700). In this case, the method also includes periodically performing the measurement with the determined period (Block 710).

In some embodiments, determining the period comprises determining the period to be a first period if the communication device 12 has or is operating with a wake-up receiver. In some embodiments, determining the period comprises determining the period to be a second periodicity if the communication device 12 does not have or is not operating with a wake-up receiver. In some embodiments, the second period is shorter than the first period. In some embodiments, the method further comprises receiving signaling 20 indicating the first period and/or the second period.

In some embodiments, periodically performing the measurement comprises periodically performing the measurement with a receiver that is not a wake-up receiver.

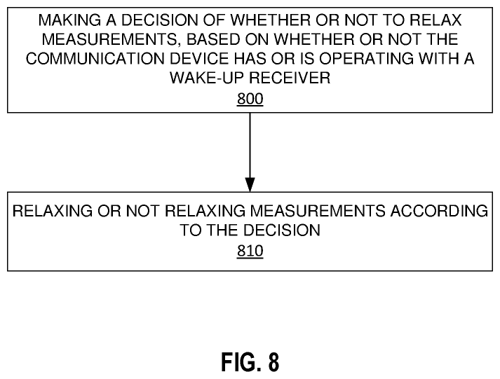

FIG. 8 depicts a method performed by a communication device 12 in accordance with other particular embodiments. The method includes making a decision of whether or not to relax measurements, based on whether or not the communication device 12 has or is operating with a wake-up receiver (Block 800). In this case, the method also includes relaxing or not relaxing measurements according to the decision (Block 810).

In some embodiments, the decision is made to relax measurements if the communication device 12 has or is operating with a wake-up receiver.

In some embodiments, the measurements are mobility measurements, radio resource management, RRM, measurements, synchronization measurements, or cell identification measurements.

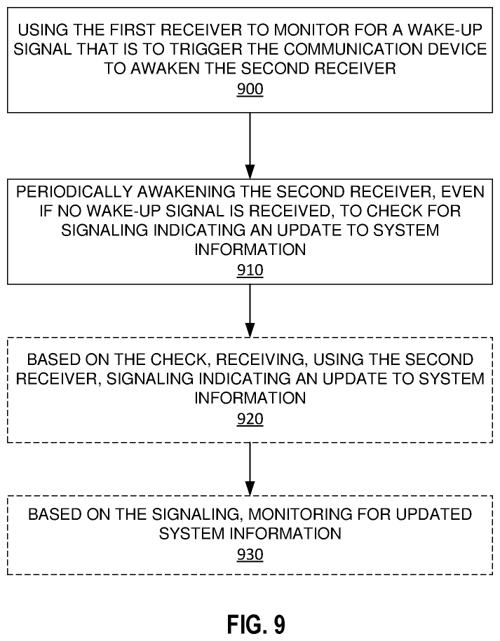

FIG. 9 depicts a method performed by a communication device 12 that has a first receiver 16-1 and a second receiver 16-2 in accordance with other particular embodiments. The method includes using the first receiver 16-1 to monitor for a wake-up signal that is to trigger the communication device 12 to awaken the second receiver 16-2 (Block 900). In this case, the method also includes periodically awakening the second receiver 16-2, even if no wake-up signal is received, to check for signaling 20 indicating an update to System Information (Block 910).

In some embodiments, the second receiver 16-2 is periodically awakened to check for a value tag in System Information Block #1, SIB1, indicating an update to System Information. In some embodiments, SIB1 includes scheduling information for one or more other System Information Blocks.

In some embodiments, the second receiver 16-2 is periodically awakened with a period that is longer than a period of wake-up signal occasions that the first receiver 16-1 monitors for a wake-up signal.

In some embodiments, the second receiver 16-2 is periodically awakened upon expiration of a timer.

In some embodiments, periodically awakening the second receiver 16-2 comprises awakening the second receiver 16-2 if the first receiver 16-1 has been unable to monitor for the wake-up signal, and/or if the communication device 12 has been out of coverage, for at least a threshold amount of time.

In some embodiments, the method further comprises, based on the check, receiving, using the second receiver 16-2, signaling 20 indicating an update to System Information (Block 920) and, based on the signaling 20, monitoring for updated System Information (Block 930).

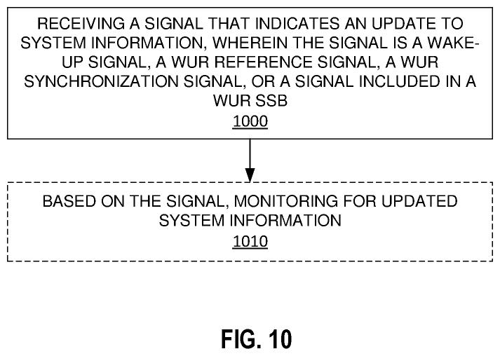

FIG. 10 depicts a method performed by a communication device 12 that has a first receiver 16-1 and a second receiver 16-2 in accordance with other particular embodiments. The method includes receiving a signal that indicates an update to System Information, wherein the signal is a wake-up signal, a WUR reference signal, a WUR synchronization signal, or a signal included in a WUR SSB (Block 1000).

In some embodiments, the signal is specific for indicating an update to System Information that governs a configuration of a WUR of the communication device 12.

In some embodiments, the signal is generic for indicating an update to any kind of System Information.

In some embodiments, the method further comprises, based on the signal, monitoring for updated System Information (Block 1010).

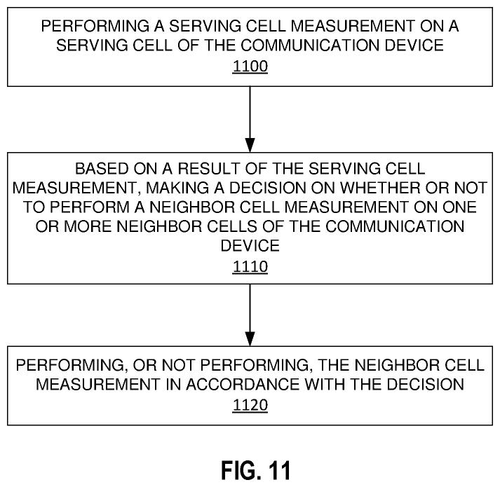

FIG. 11 depicts a method performed by the communication device 12 in accordance with yet other particular embodiments. The method includes performing a serving cell measurement on a serving cell of the communication device 12 (Block 1100). In this case, the method also includes, based on a result of the serving cell measurement, making a decision on whether or not to perform a neighbor cell measurement on one or more neighbor cells of the communication device 12 (Block 1110). In this case, the method also includes performing, or not performing, the neighbor cell measurement in accordance with the decision (Block 1120).

In some embodiments, the serving cell measurement is a reference signal received power, RSRP, measurement or a reference signal received quality, RSRQ, measurement.

In some embodiments, making the decision comprises making the decision to perform the neighbor cell measurement if the result of the serving cell measurement is below a first threshold. In some embodiments, making the decision comprises making the decision to not perform the neighbor cell measurement if the result of the serving cell measurement is above a second threshold, wherein either the first and second thresholds are the same or the first threshold is below the second threshold.

In some embodiments, the decision is a decision on in which of multiple measurement modes the communication device 12 is to operate. In some embodiments, the multiple measurement modes include a serving cell only measurement mode in which the communication device 12 performs the serving cell measurement, without performing any neighbor cell measurement. In some embodiments, the multiple measurement modes include a full measurement mode in which the communication device 12 performs both the serving cell measurement and the neighbor cell measurement.

In some embodiments, the serving cell measurement is performed on a signal that the communication device 12 receives from the serving cell using a wake-up receiver of the communication device 12.

In some embodiments, the serving cell measurement is performed on a WUR-SS or WUR-SSB received on the serving cell.

In some embodiments, the decision is to perform the neighbor cell measurement, and the method comprises performing the neighbor cell measurement. In some embodiments, the method further comprises, for each of the one or more neighbor cells, receiving a signal from the neighbor cell using a wake-up receiver of the communication device 12 and performing the neighbor cell measurement on the received signal.

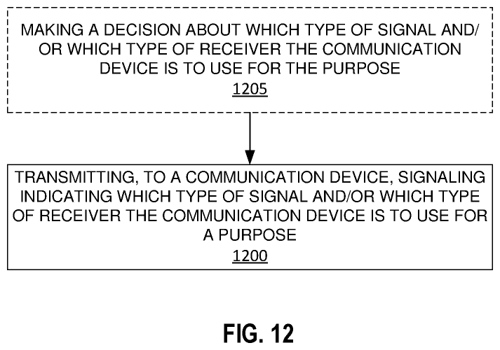

FIG. 12 depicts a method performed by a network node 14 in accordance with other particular embodiments. The method includes transmitting, to a communication device 12, signaling 20 indicating which type of signal and/or which type of receiver the communication device 12 is to use for a purpose (Block 1200).

In some embodiments, the signaling 20 indicates which type of signal the communication device 12 is to use for a purpose, out of multiple types of signals that are usable for the purpose.

In some embodiments, the multiple types of signals include a first type of signal 18-1 that is receivable by a first type of receiver 16-1, and a second type of signal 18-2 that is receivable by a second type of receiver 16-2 and is not receivable by the first type of receiver 16-1. In some embodiments, the first type of receiver 16-1 is a wake-up receiver, WUR. In some embodiments, the first type of receiver 16-1 is a receiver configured to receive a wake-up signal that triggers the communication device 12 to awaken the second type of receiver 16-2 from a sleep state. In some embodiments, the first type of receiver 16-1 is a non-coherent receiver and the second type of receiver 16-2 is a coherent receiver.

In some embodiments, the multiple types of signals include a first type of signal 18-1 that is an on-off keying, OOK, signal or a frequency shift keying, FSK, signal, and a second type of signal 18-2 that is based on a Zadoff-Chu sequence or a maximum length sequence, m-sequence.

In some embodiments, the multiple types of signals include first type of signal 18-1 that is a WUR synchronization signal, WUR-SS, or that is included in a WUR synchronization signal block, WUR-SSB, wherein the WUR-SS or WUR-SSB is receivable by and/or specific for a WUR. In some embodiments, the multiple types of signals include a second type of signal 18-2 that is a SS or SSB which is not receivable by and/or is not specific for a WUR.

In some embodiments, the multiple types of signals include a first type of synchronization signal and a second type of synchronization signal. In other embodiments, the multiple types of signals include a synchronization signal in a first type of synchronization signal block, SSB, and a synchronization signal in a second type of SSB.

In some embodiments, the multiple types of signals include a first type of reference signal and a second type of reference signal.

In some embodiments, the purpose is mobility measurements or radio resource management, RRM, measurements.

In some embodiments, the purpose is cell identification.

In some embodiments, the purpose is synchronization.

In some embodiments, the signaling 20 indicates which type of signal and/or which type of receiver the communication device 12 is to use for the purpose in a Radio Resource Control, RRC, idle state or in an RRC inactive state.

In some embodiments, the signaling 20 indicates which type of signal and/or which type of receiver the communication device 12 is to use for the purpose in a cell.

In some embodiments, the signaling 20 is broadcast signaling and/or is included in System Information.

In some embodiments, the signaling 20 is included in a wake-up receiver configuration that configures a wake-up receiver of the communication device 12.

In some embodiments, the signaling 20 comprises a message. In some embodiments, a value of, or a presence or absence of, a certain information element, IE, in the message indicates which type of signal the communication device 12 is to use for the purpose.

In other embodiments, the signaling 20 indicates which type of receiver the communication device 12 is to use for the purpose, out of multiple types of receivers usable for the purpose, wherein the multiple types include a first type of receiver 16-1 and a second type of receiver 16-2. In one embodiment, the first type of receiver 16-1 is a wake-up receiver, WUR. In another embodiment, the first type of receiver 16-1 is a receiver configured to receive a wake-up signal that triggers the communication device 12 to awaken the second type of receiver 16-2 from a sleep state. In another embodiment, the first type of receiver 16-1 is a non-coherent receiver and the second type of receiver 16-2 is a coherent receiver.

In some embodiments, the method further comprises making a decision about which type of signal and/or which type of receiver the communication device 12 is to use for the purpose (Block 1205).

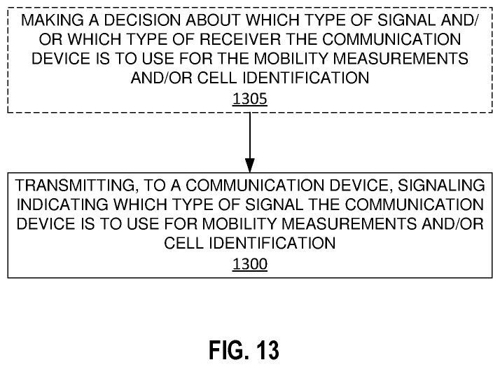

FIG. 13 depicts a method performed by a network node 14 in accordance with other particular embodiments. The method includes transmitting, to a communication device 12, signaling 20 indicating which type of signal the communication device 12 is to use for mobility measurements and/or cell identification (Block 1300).

In some embodiments, the signaling 20 indicates whether the communication device 12 is to use, for mobility measurements and/or cell identification a first type of signal 18-1 that is a WUR synchronization signal, WUR-SS, or that is included in a WUR synchronization signal block, WUR-SSB, wherein the WUR-SS or WUR-SSB is receivable by and/or specific for a WUR. In other embodiments, the signaling 20 indicates whether the communication device 12 is to use, for mobility measurements and/or cell identification a second type of signal 18-2 that is a SS or SSB which is not receivable by and/or is not specific for a WUR.

In some embodiments, the method further comprises making a decision about which type of signal and/or which type of receiver the communication device 12 is to use for the mobility measurements and/or cell identification (Block 1305).

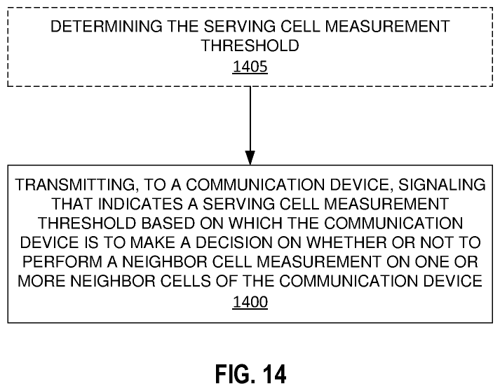

FIG. 14 depicts a method performed by a network node 14 in accordance with other particular embodiments. The method includes transmitting, to a communication device 12, signaling 20 that indicates a serving cell measurement threshold based on which the communication device 12 is to make a decision on whether or not to perform a neighbor cell measurement on one or more neighbor cells of the communication device 12 (Block 1400).

In some embodiments, the serving cell measurement threshold is a reference signal received power, RSRP, measurement threshold or a reference signal received quality, RSRQ, measurement threshold.

In some embodiments, the communication device 12 is configured to make the decision to perform the neighbor cell measurement if a result of a serving cell measurement is below the serving cell measurement threshold. In other embodiments, the communication device 12 is configured to make the decision to not perform the neighbor cell measurement if a result of a serving cell measurement is above the serving cell measurement threshold.

In some embodiments, the decision is a decision on in which of multiple measurement modes the communication device 12 is to operate. In some embodiments, the multiple measurement modes include a serving cell only measurement mode in which the communication device 12 performs a serving cell measurement, without performing any neighbor cell measurement. In other embodiments, the multiple measurement modes include a full measurement mode in which the communication device 12 performs both a serving cell measurement and the neighbor cell measurement.

In some embodiments, the decision is to be made based on a serving cell measurement performed on a signal that the communication device 12 receives from a serving cell using a wake-up receiver of the communication device 12.

In some embodiments, the decision is to be made based on a serving cell measurement performed on a WUR-SS or WUR-SSB received on a serving cell.

In some embodiments, the method comprises determining the serving cell measurement threshold (Block 1405).

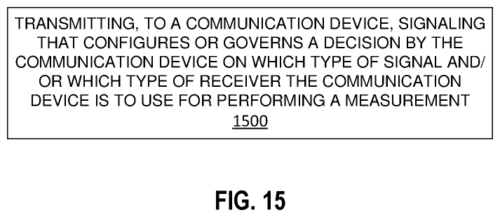

FIG. 15 depicts a method performed by a network node 14 in accordance with other particular embodiments. The method includes transmitting, to a communication device 12, signaling 20 that configures or governs a decision by the communication device 12 on which type of signal and/or which type of receiver the communication device 12 is to use for performing a measurement (Block 1500).

In some embodiments, the decision is to be made based on a result of the measurement as previously performed. In other embodiments, the decision is to be made alternatively or additionally based on a distance between the communication device 12 and a serving radio network node 14 serving the communication device 12.

In some embodiments, the signaling 20 configures the communication device 12 to decide to use a first type of signal 18-1 and/or a first type of receiver 16-1 for performing the measurement if a result of the measurement as previously performed using the first type of signal 18-1 and/or the first type of receiver 16-1 is above a first threshold. In some embodiments, the signaling 20 configures the communication device 12 to decide to use a second type of signal 18-2 and/or a second type of receiver 16-2 for performing the measurement if the result of the measurement as previously performed using the first type of signal 18-1 and/or the first type of receiver 16-1 is below a second threshold. In some embodiments, the signaling 20 indicates the first threshold and/or the second threshold.

In some embodiments, the signaling 20 configures the communication device 12 to decide to use a first type of signal 18-1 and/or a first type of receiver 16-1 for performing the measurement if a distance between the communication device 12 and a serving radio network node 14 serving the communication device 12 is above a first threshold. In some embodiments, the signaling 20 configures the communication device 12 to decide to use a second type of signal 18-2 and/or a second type of receiver 16-2 for performing the measurement if the distance between the communication device 12 and the serving radio network node 14 serving the communication device 12 is below a second threshold. In some embodiments, the signaling 20 indicates the first threshold and/or the second threshold.

In some embodiments, the signaling 20 configures the communication device 12 to decide to use a first type of signal 18-1 and/or a first type of receiver 16-1 for performing the measurement if a distance between the communication device 12 and a serving radio network node 14 serving the communication device 12 is below a first threshold. In some embodiments, the signaling 20 configures the communication device 12 to decide to use a second type of signal 18-2 and/or a second type of receiver 16-2 for performing the measurement if the distance between the communication device 12 and the serving radio network node 14 serving the communication device 12 is above a second threshold. In some embodiments, the signaling 20 indicates the first threshold and/or the second threshold

In some embodiments, the signaling 20 configures the communication device 12 to use a second type of signal 18-2 and/or a second type of receiver 16-2 for performing the measurement if one or more attempts to perform the measurement using a first type of signal 18-1 and/or a first type of receiver 16-1 have failed a threshold number of times, have failed for a threshold amount of time, and/or have failed over a threshold number of duty cycles. In some embodiments, the signaling 20 indicates the threshold number of times, the threshold amount of time, and/or the threshold number of duty cycles. In other embodiments, the signaling 20 configures the communication device 12 to use a second type of signal 18-2 and/or a second type of receiver 16-2 for performing the measurement if, alternatively or additionally, a timer expires. In some embodiments, the communication device 12 is configured to start the timer upon failure of one or more attempts to perform the measurement using a first type of signal 18-1 and/or a first type of receiver 16-1, and the communication device 12 is configured to stop the timer upon success of one or more attempts to perform the measurement using the first type of signal 18-1 and/or the first type of receiver 16-1. In some embodiments, the signaling 20 indicates a duration of the timer.

In some embodiments, the signaling 20 configures the communication device 12 to make the decision as part of making decisions to use different types of signals and/or different types of receivers at different times. In some embodiments, the signaling 20 configures the communication device 12 to periodically decide to perform the measurement with a first type of signal 18-1 and/or a first type of receiver 16-1, according to a first period. In some embodiments, the signaling 20 configures the communication device 12 to periodically decide to perform the measurement with a second type of signal 18-2 and/or a second type of receiver 16-2, according to a second period that is longer than the first period. In some embodiments, the signaling 20 indicates the first period and/or the second period. In some embodiments, the second period is a multiple of the first period. In some embodiments, the second period is aligned with the first period. In some embodiments, the signaling 20 configures the communication device 12 to perform the measurement only with the second type of signal 18-2 and/or the second type of receiver 16-2 during any overlap between the first period and the second period.

In some embodiments, the communication device 12 is powered by a battery, and the decision is to be made based on a charge level of the battery.

In some embodiments, the signaling 20 configures the communication device 12 to decide to use a first type of signal 18-1 and/or a first type of receiver 16-1 for performing the measurement if the charge level is below a first threshold. In some embodiments, the signaling 20 configures the communication device 12 to decide to use a second type of signal 18-2 and/or a second type of receiver 16-2 for performing the measurement if the charge level is above a second threshold. In some embodiments, the signaling 20 indicates the first threshold and/or the second threshold.

In some embodiments, the signaling 20 configures the communication device 12 to make the decision based on a deployment scenario or radio environment of the communication device 12. In other embodiments, the signaling 20 configures the communication device 12 to make the decision alternatively or additionally based on sensitivities or architectures of types of receivers of the communication device 12.

In some embodiments, the signaling 20 configures the communication device 12 to decide to use a first type of signal 18-1 and/or a first type of receiver 16-1 for performing the measurement if the communication device 12 is in an indoor environment or a dense urban deployment. In some embodiments, the signaling 20 configures the communication device 12 to decide to use a second type of signal 18-2 and/or a second type of receiver 16-2 for performing the measurement if the communication device 12 is in an outdoor environment or a rural deployment.

In some embodiments, the signaling 20 configures the communication device 12 to make the decision based on which type of signal and/or which type of receiver a serving cell, or a target cell, of the communication device 12 supports.

In some embodiments, the signaling 20 configures the communication device 12 to make the decision based on whether or not the communication device 12 needs to change, or has changed, a serving cell of the communication device 12. In some embodiments, the signaling 20 configures the communication device 12 to decide to preferentially use a second type of signal 18-2 and/or a second type of receiver 16-2 when the communication device 12 needs to change, or has changed, a serving cell of the communication device 12.

In some embodiments, the decision is a decision on which type of signal to use for performing the measurement. In some embodiments, the decision is a decision on which type of signal to use for performing the measurement, out of multiple types of signals with which the communication device 12 is capable of performing the measurement, wherein the multiple types of signals include a first type of signal 18-1 and a second type of signal 18-2. In some embodiments, the first type of signal 18-1 is an on-off keying, OOK, signal or a frequency shift keying, FSK, signal, and the second type of signal 18-2 is based on a Zadoff-Chu sequence or a maximum length sequence, m-sequence. In some embodiments, the first type of signal 18-1 is WUR synchronization signal, WUR-SS, or that is included in a WUR synchronization signal block, WUR-SSB, wherein the WUR-SS or WUR-SSB is receivable by and/or specific for a WUR. In some embodiments, the second type of signal 18-2 is a SS or SSB which is not receivable by and/or is not specific for a WUR. In some embodiments, the first type of signal 18-1 and the second type of signal 18-2 are a first type of synchronization signal and a second type of synchronization signal. In other embodiments, the first type of signal 18-1 and the second type of signal 18-2 are a synchronization signal in a first type of synchronization signal block, SSB, and a synchronization signal in a second type of SSB. In some embodiments, the first type of signal 18-1 and the second type of signal 18-2 are a first type of reference signal and a second type of reference signal.

In some embodiments, the decision is a decision on which type of receiver to use for performing the measurement. In some embodiments, the decision is a decision on which type of receiver to use for performing the measurement, out of multiple types of receivers with which the communication device 12 is equipped. In some embodiments, the multiple types include a first type of receiver 16-1 and a second type of receiver 16-2. In some embodiments, the first type of receiver 16-1 is a wake-up receiver, WUR. In some embodiments, the first type of receiver 16-1 is a receiver configured to receive a wake-up signal that triggers the communication device 12 to awaken the second type of receiver 16-2 from a sleep state. In some embodiments, the first type of receiver 16-1 is a non-coherent receiver and the second type of receiver 16-2 is a coherent receiver.

In some embodiments, the measurement is a mobility measurement, a radio resource management, RRM, measurement, a synchronization measurement, or a cell identification measurement.

In some embodiments, the measurement is a reference signal received power, RSRP, measurement or a reference signal received quality, RSRQ, measurement.

In some embodiments, the method further comprises receiving a result of the measurement for mobility, RRM, synchronization, or cell identification.

In some embodiments, the decision is made according to one or more rules, and wherein the signaling 20 configures at least one of the one or more rules.

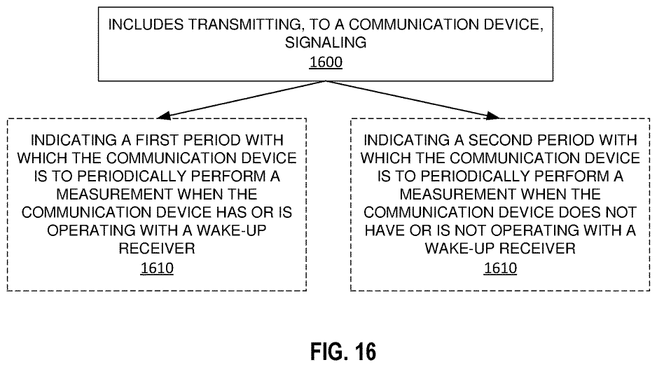

FIG. 16 depicts a method performed by a communication device 12 in accordance with other particular embodiments. The method includes transmitting, to a communication device 12, signaling 20 (Block 1600). In some embodiments, the signaling 20 indicates a first period with which the communication device 12 is to periodically perform a measurement when the communication device 12 has or is operating with a wake-up receiver (Block 1610). In other embodiments, the signaling 20 alternatively or additionally indicates a second period with which the communication device 12 is to periodically perform a measurement when the communication device 12 does not have or is not operating with a wake-up receiver (Block 1620).

In some embodiments, the first period is a period with which the communication device 12 is to periodically perform the measurement with a receiver that is not a wake-up receiver, when the communication device 12 has or is operating with a wake-up receiver. In other embodiments, the second period is a period with which the communication device 12 is to periodically perform the measurement with a receiver that is not a wake-up receiver, when the communication device 12 does not have or is not operating with a wake-up receiver.

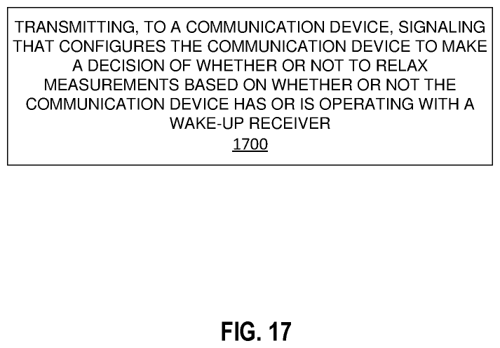

FIG. 17 depicts a method performed by a network node 14 in accordance with other particular embodiments. The method includes transmitting, to a communication device 12, signaling 20 that configures the communication device 12 to make a decision of whether or not to relax measurements based on whether or not the communication device 12 has or is operating with a wake-up receiver (Block 1700).

In some embodiments, the signaling 20 configures the communication device 12 to decide to relax measurements if the communication device 12 has or is operating with a wake-up receiver.

In some embodiments, the measurements are mobility measurements, radio resource management, RRM, measurements, synchronization measurements, or cell identification measurements.

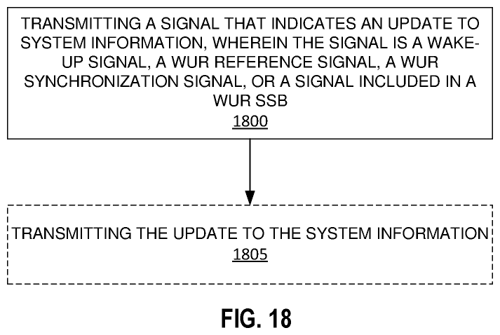

FIG. 18 depicts a method performed by a network node 14 in accordance with other particular embodiments. The method includes transmitting a signal that indicates an update to System Information, wherein the signal is a wake-up signal, a WUR reference signal, a WUR synchronization signal, or a signal included in a WUR SSB (Block 1800).

In some embodiments, the signal is specific for indicating an update to System Information that governs a configuration of a WUR of a communication device 12.

In some embodiments, the signal is generic for indicating an update to any kind of System Information.

In some embodiments, the method further comprises transmitting the update to the System Information (Block 1805).

Consider now specific examples of some embodiments herein as applicable in the following context where the communication device 12 is exemplified as a user equipment (UE), the first type of receiver 16-1 is a WUR, and the second type of receiver 16-2 is a main receiver.

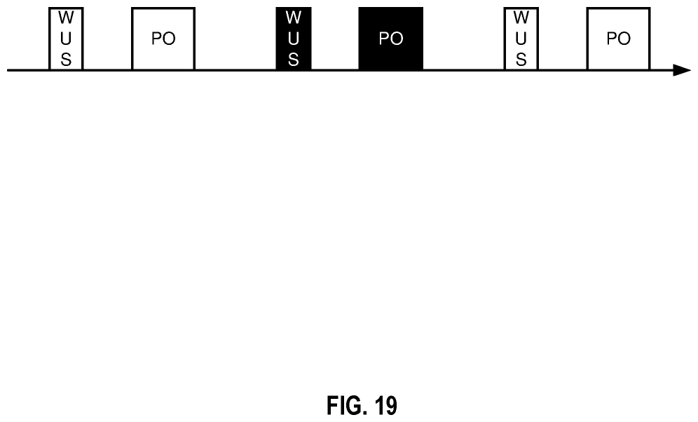

Wake-up receiver (WUR), sometimes also referred to as ‘wake-up radio’, is about enabling a low power receiver in UEs, which, in case of the detection of a wake-up signal (WUS), wakes up the main (baseband/higher power) receiver to detect an incoming message, typically paging (e.g., PDCCH in paging occasions (PO), scheduling the paging message on the Physical Downlink Shared Channel, PDSCH). One benefit of employing WUR is lowering energy consumption and lengthening device battery life, or at a fixed energy consumption the downlink latency can be reduced (shorter discontinuous reception (DRX)/duty-cycles and more frequent checks for incoming transmissions). FIG. 19 for example shows the location of a WUS and the paging occasion to which it is associated.

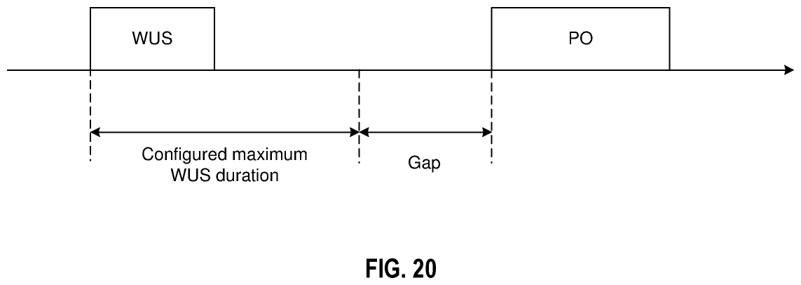

Some embodiments herein are applicable to a WUS for Narrowband Internet of Things (NB) (IoT) and/or Long Term Evolution Machine Type Communication (LTE-M), e.g., as specified since 3GPP Rel-15. One motivation for introducing WUS was UE energy consumption reduction since with the coverage enhancement PDCCH could be repeated many times, and the WUS is relatively much shorter and hence requires less reception time for the UE. The logic is that a UE would check for a WUS a certain time before its PO. Only if a WUS is detected the UE would continue to check for PDCCH in the PO, and if not, which is most of the time, the UE can go back to a sleep state to conserve energy. Due to the coverage enhancements the WUS can be of variable length depending on the UE's coverage. See FIG. 20 which shows a WUS can be of variable length up to a configured maximum WUS duration, and which shows that there may be a gap between the end of the configured maximum WUS duration and the start of the associated PO.

A ‘Wake-up signal’ (WUS) in some embodiments is based on the transmission of a short signal that indicates to the UE that it should continue to decode the downlink (DL) control channel e.g., full Narrowband PDCCH (NPDCCH) for NB-IoT. If such signal is absent (DTX i.e., UE does not detect it) then the UE can go back to sleep without decoding the DL control channel. The decoding time for a WUS is considerably shorter than that of the full NPDCCH since it essentially only needs to contain one bit of information, whereas the NPDCCH may contain up to 35 bits of information. This in turn reduces UE power consumption and leads to longer UE battery life. The WUS would be transmitted only when there is a paging for the UE. But if there is no paging for the UE then the WUS will not be transmitted (i.e., implying a discontinuous transmission, DTX) and the UE would go back to deep sleep, e.g., upon detecting DTX instead of WUS. This is illustrated in FIG. 19, where white blocks indicate possible WUS and PO positions, whereas the black boxes indicate actual WUS and PO positions.

Some embodiments accordingly apply to Rel-15 WUS as specified out over several parts of the LTE 36-series standard, e.g., 36.211 V15.14.0, 36.213 V15.16.0, 36.304 V15.8.0, and 36.331 V15.19.0.

In some embodiments, a UE will report its WUS capability to the network, and WUS gap capability (see below). Further WUS information may be added to the paging message/request from Mobility Management Entity (MME) to eNB. In this case, eNB may use WUS for paging the UE if and only if 1) WUS is enabled in the cell (i.e., WUS-Config present in System Information, SI), and 2) the UE supports WUS according to the wakeUpSignal-r15 UE capability.

In some embodiments, WUS is supported for both LTE-M and NB-IoT with support for both DRX and eDRX, the former with a 1-to-1 mapping between the WUS and the PO, and for the latter in an addition with the possible configuration of 1-to-N (many) POs. eNB can configure one WUS gap for UEs using DRX, and another one for UEs using eDRX [TS 36.331].

The UE capabilities can also indicate the minimum WUS gaps required for the UE to be able to decode PDCCH in the associated PO, for DRX and eDRX, respectively [TS 36.331].

A longer WUS gap of 1s or 2s may be used to enable the use of WUR. That is, starting up the main baseband receiver if a WUR is used for the detection of WUS may take more time. If this is supported in the cell, eNB would include timeOffset-eDRX-Long in the WUS-Config in SI. The WUS time gap the UE (and eNB) should apply depends on the reported UE capability.

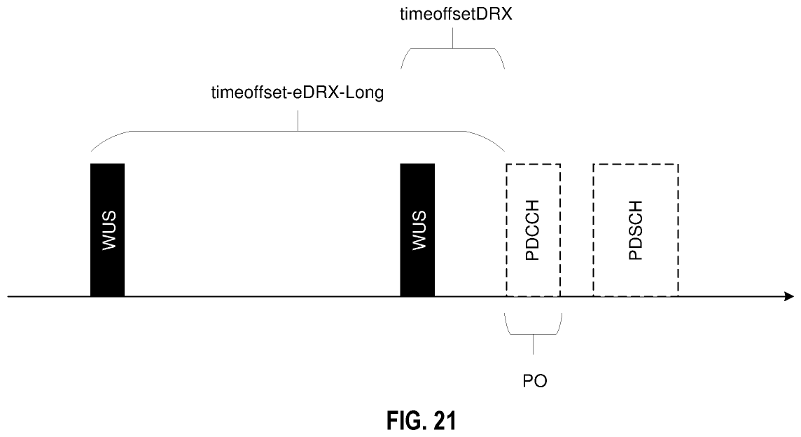

In essence, the UE will only use WUR, or timeOffset-eDRX-Long, if it is capable of starting up the main receiver as quickly as indicated by the value used in SI. If not, it will fall back to using timeOffset-eDRX-Short (without WUR). FIG. 21 shows one example of the use of eDRX and DRX WUS gaps for NB-IoT and LTE-M.

Since UEs share PO, the eNB may, in the worst case, have to transmit up to 3 WUSs for one PO. I.e., corresponding to timeoffsetDRX, timeoffset-eDRX-Short, and timeoffset-eDRX-Long.

Some embodiments herein are also applicable to UE-group WUS that includes UE grouping, such that the number of UEs that are triggered by a WUS is further narrowed down to a smaller subset of the UEs that are associated with a specific paging occasion (PO). The purpose of UE-group WUS is to reduce the false paging rate, i.e., avoid that a given UE is unnecessarily woken up by a WUS transmission intended for another UE. This feature is referred to as Rel-16 group WUS, or GWUS.

Some embodiments herein are applicable to WUR for New Radio (NR), e.g., as described in RP-213645, RP-212005, RP-212254, RP-212367, and RP-212427. Here, WUS is not PDCCH-based and allows for a simpler and low power receiver, i.e., WUR with simple modulation and detection techniques (e.g., using on-off keying, (OOK) modulation and non-coherent detection). The benefit of such WUR is to reduce the energy consumption of the receiver, such that unless there is any paging and data for the UE it can remain in a power saving state. This will extend the battery life of the device, or alternatively enable shorter downlink latency (shorter DRX) at a fixed battery life. For short-range communication, the WUR power can be low enough (~3 uW) that this can even, in combination with energy harvesting, enable that the WUR is continuously on (i.e., DRX or duty-cycling is not used) without the need for a battery. This can be considered as a key enabler of battery-less devices towards 6G.

Some embodiments herein are applicable for UE measurements as described below. A UE performs measurements on one or more DL and/or uplink (UL) reference signal (RS) of one or more cells in different UE activity states, e.g., Radio Resource Control (RRC) idle state, RRC inactive state, RRC connected state, etc. The measured cell may belong to or operate on the same carrier frequency as of the serving cell (e.g., intra-frequency carrier) or it may belong to or operate on a different carrier frequency as of the serving cell (e.g., non-serving carrier frequency). The non-serving carrier may be called an inter-frequency carrier if the serving and measured cells belong to the same radio access technology (RAT) but different carriers. The non-serving carrier may be called an inter-RAT carrier if the serving and measured cells belong to different RATs. Examples of downlink RS are signals in SSB, Channel State Information RS (CSI-RS), Cell-Specific RS (CRS), DeModulatin RS (DMRS), Primary SS (PSS), Secondary SS (SSS), signals in SS/Physical Broadcast Channel (PBCH) block (SSB), discovery reference signal (DRS), Positioning RS (PRS), etc. Examples of uplink RS are signals in Sounding Reference Signal (SRS), DMRS, etc.

Each SSB for example carries NR-PSS, NR-SSS and NR-PBCH in 4 successive symbols. One or multiple SSBs are transmitted in one SSB burst which is repeated with certain periodicity, e.g., 5 ms, 10 ms, 20 ms, 40 ms, 80 ms, and 160 ms. The UE is configured with information about SSB on cells of certain carrier frequency by one or more SS/PBCH block measurement timing configuration (SMTC) configurations. The SMTC configuration comprises parameters such as SMTC periodicity, SMTC occasion length in time or duration, SMTC time offset wrt reference time (e.g., serving cell's SFN), etc. Therefore, SMTC occasion may also occur with certain periodicity, e.g., 5 ms, 10 ms, 20 ms, 40 ms, 80 ms, and 160 ms.

Examples of measurements are cell identification (e.g., Physical Cell Identity (PCI) acquisition, PSS/SSS detection, cell detection, cell search, etc.), Reference Symbol Received Power (RSRP), Reference Symbol Received Quality (RSRQ), secondary synchronization RSRP (SS-RSRP), SS-RSRQ, Signal-to-interference-plus-noise-ratio (SINR), RS-SINR, SS-SINR, CSI-RSRP, CSI-RSRQ, received signal strength indicator (RSSI), acquisition of system information (SI), cell global ID (CGI) acquisition, Reference Signal Time Difference (RSTD), UE RX-TX time difference measurement, Radio Link Monitoring (RLM), which consists of Out of Synchronization (out of sync) detection and In Synchronization (in-sync) detection, etc.

The UE is typically configured by the network (e.g., via RRC message) with measurement configuration and measurement reporting configuration, e.g., measurement gap pattern, carrier frequency information, types of measurements (e.g., RSRP, etc.), higher layer filtering coefficient, time to trigger report, reporting mechanism (e.g., periodic, event triggered reporting, event triggered periodic reporting, etc.), etc.

The measurements may be done for various purposes. Some example measurement purposes are: UE mobility (e.g., cell change, cell selection, cell reselection, handover, RRC connection re-establishment, etc.), UE positioning or location determination self-organizing network (SON), minimization of drive tests (MDT), operation and maintenance (O&M), network planning and optimization, etc.

Some embodiments herein are applicable in a context where relaxed monitoring criteria is specified for a neighbour cell, e.g., as specified in TS 36.304 V16.6.0. In RRC idle and RRC inactive states in this regard, the UE can be configured to relax neighbour cell measurements (e.g., for cell reselection) when the UE meets one or more relaxed measurement criteria (RMC). The UE can be configured for applying relaxed measurements via higher layer signalling, e.g., in system information block (SIB) such as in SIB2. Examples of criteria are UE in low mobility, UE not-at-cell-edge, UE is stationary, combined criteria (e.g., UE in low mobility AND not-at-cell-edge, stationary AND not-at-cell-edge), etc.

Relaxed Measurement Criterion for UE with Low Mobility

For a UE with low mobility, the relaxed measurement criterion is fulfilled when the UE speed is below a certain threshold. The UE speed can be expressed in terms of distance per unit time (e.g., Y1 km/hour) and/or in Doppler frequency (e.g., Y2 Hertz). In one specific example the relaxed measurement criterion for a UE with low mobility is fulfilled if the UE is stationary or static or does not move.

In another example, the low mobility criterion is met when the received signal level at the UE wrt the cell is static or quasi-static over certain time period (Ts). The received signal from a cell (e.g., serving cell) is static or quasi-static if it does not change by more than certain margin over certain time period, e.g., the variance of the measured signal levels is within a certain threshold. Examples of received signal are signal strength, path loss, RSRP, L1-RSRP, L1-SINR, etc. In one specific example the relaxed measurement criterion for UE with low mobility is fulfilled when the following condition is met for the serving cell of the UE:

(Srxlev_{Ref}−Srxlev)<S_{SearchDeltaP},
Where:
   Srxlev=current Srxlev value of the serving cell (dB).
   Srxlev_{Ref}=reference Srxlev value of the serving cell (dB), set as follows:
      After selecting or reselecting a new cell, or
      If (Srxlev-Srxlev_{Ref})>0, or
      If the relaxed measurement criterion has not been met for a duration of T_{SearchDeltaP}:
         Then the UE set value of Srxlev_{Ref} to the current Srxlev value of the serving cell.
            Srxlev is further defined as follows:

Srxlev=Qᵣₓₗₑᵥₘₑₐₛ−(Qᵣₓₗₑᵥₘᵢₙ+Q_{rxlevminoffset})−P_{compensation}−Qoffsetₜₑₘₚ

### Where:

Srxlev: It is the cell selection received (RX) level value (dB).
Qᵣₓₗₑᵥₘₑₐₛ: It is the measured cell RX level value (RSRP).
Qᵣₓₗₑᵥₘᵢₙ is the minimum required RX level in the cell (dBm). It is signalled by the cell.
Q_{rxlevminoffset} is the offset to the signalled Qrxlevmin. It is signalled by the cell.
Qoffsetₜₑₘₚ: It is the offset temporarily applied to a cell. It is signalled by the cell.

### Relaxed Measurement Criterion for Stationary UE

The relaxed measurement criterion for stationary UE is defined in a way similar to UE with low mobility. However, the actual values for the thresholds for stationary UE might be different compared to those used for low mobility criterion. For example, the UE meets stationary criterion if the received signal from a cell (e.g., serving cell) does not change by more than a certain margin (Hs) over a certain time period (Ts). One the other hand, UE meets low mobility criterion if the received signal with respect to the cell does not change by more than a certain margin (Hm) over a certain time period (Tm). In one example, êHsê<êHmê and/or Ts>Tm. In another example êHsê=êHmê and/or Ts>Tm. In another example êHsê<êHmê and/or Ts=Tm.

### Relaxed Measurement Criterion for UE not at Cell Edge

In one example, relaxed measurement criterion for UE not at cell edge is fulfilled when the received signal level at the UE from a cell (e.g., serving cell) is above threshold, e.g., signal strength is above signal strength threshold and/or signal quality is above signal quality threshold.

In another example, the relaxed measurement criterion for UE not at cell edge is fulfilled when the following condition is met for the serving cell of the UE:

Srxlev>S_{SearchThresholdP}, and,

Squal>S_{SearchThresholdQ}, if S_{SearchThresholdQ} is configured,
Where:
   Srxlev=current Srxlev value of the serving cell (dB).
   Squal=current Squal value of the serving cell (dB).
      Squal is further defined as follows:

Squal=Q_{qualmeas}−(Q_{qualmin}+Q_{qualminoffset})−Qoffsetₜₑₘₚ

### Where:

Squal: It is the cell selection quality value (dB)
Q_{qualmeas}: It is the measured cell quality level value (RSRQ).
Q_{qualmin} is the minimum required quality level in the cell (dB). It is signalled by the cell.
Q_{qualminoffset} is the offset to the signalled Qqualmin. It is signalled by the cell.

### Combination of Relaxed Measurement Criteria

The UE can be configured with multiple versions (e.g., Rel-16 not-at-cell edge, Rel-17 not-at-cell edge) of not-at-cell edge criteria in which case the actual values for thresholds might be different because the purpose would be to identify the UEs located at different ranges with respect to the cell center.

### Relaxed Measurement Requirements

When one or more relaxed measurement criteria are met, then the UE is allowed to relax measurements or perform relaxed measurements. The measurement relaxation is realized by meeting relaxed measurement requirements. For example, the UE is allowed to meet one or more relaxed measurement requirements for performing a measurement provided that it is configured with lowMobilityEvaluation IE and also meets the low mobility criterion as defined above. In another example, the UE is allowed to meet one or more relaxed measurement requirements for performing a measurement provided that it is configured with cellEdgeEvaluation IE and also meets the not at cell edge as defined above. In another example, the UE is allowed to meet one or more relaxed measurement requirements for performing a measurement provided that it is configured with combineRelaxedMeasCondition IE and also meets the low mobility criterion and not at cell edge as defined above. The parameters/IE lowMobilityEvaluation, cellEdgeEvaluation and combineRelaxedMeasCondition are defined in TS 38.331 V16.6.0.

The UE is allowed to relax one or more of neighbour cell measurements, e.g., intra-frequency measurements, inter-frequency and inter-RAT measurements, when the UE meets one or more relaxed measurement criteria.

Examples of requirements are measurement time, measurement accuracy, measurement reporting periodicity, number of cells measured over measurement time, etc. Examples of measurement time are cell identification or cell detection time, evaluation period or measurement period (e.g., L1 measurement period, L1-RSRP measurement period, L1-SINR measurement period, OOS evaluation period, IS evaluation period, BFD evaluation period, BFD evaluation period, L1 indication interval, IS indication interval, OOS indication interval, BFD indication interval, etc.), etc. Examples of measurement accuracy are L1-RSRP accuracy (e.g., within ±X1 dB wrt reference L1-RSRP value), L1-SINR accuracy (e.g., within ±X2 dB wrt reference L1-SINR value). For example, the measurement time of a relaxed measurement (RM) is longer than the measurement time of the corresponding normal measurement (NM) (i.e., when measurement is not relaxed). In one example the measurement time for RM (T_{meas_RM}) is a function of K and T_{meas_NM}. Examples of functions are maximum, sum, product, etc. In one specific example: T_{meas_RM}=K*T_{meas_NM}: where K>1.

In one example, measurement relaxation is realized by extending the measurement time compared to the measurement time when no relaxation is applied. In another example, measurement relaxation is realized by not performing any neighbour cell measurements. In another example, measurement relaxation is realized by not performing any neighbour cell measurements for a certain time period, which may be pre-defined or configured by the network node. Examples of measurement time in low RRC activity state (e.g., RRC idle, RRC inactive states, etc.) are cell detection time (Tdetect) measurement period (Tmeasure), evaluation time (Tevaluate), etc. For example, when UE is configured with lowMobilityEvaluation and also meets low mobility criterion, then the UE performs intra-frequency neighbour cell measurements (e.g., T_{detect,NR_Intra}, T_{measure,NR_Intra}, and T_{evaluate,NR_Intra}) with relaxation by applying scaling factor K1=3. Otherwise, when no measurement relaxation is applied then K=1. Some embodiments in this context address the problem that WUR operation presents for UE mobility. WUR UEs need to be able to detect cell-change in order not to become unreachable by the network in downlink. But if WUR UEs need to obey the existing requirement of performing RRM measurements frequently, i.e., serving cell measurement every DRX cycle, the WUR gains will be severely limited (since the main receiver then has to be started up relatively frequently and therefore cannot be kept in the deep sleep state). Some embodiments herein recognize two solutions to this problem, but both have drawbacks:

RRM measurement relaxations: One solution would be to introduce the existing, or new WUR-specific, serving cell measurement relaxation for WUR. The relaxation means UEs fulfilling certain conditions (i.e., UE not-at-cell-edge, UE is of low mobility, UE is stationary, Rel-17 RedCap relaxation condition, or a combination of those) are allowed to perform the RRM measurements less frequency. This solution is therefore not applicable to e.g., (mobile) UEs located at the cell edge that need energy consumption reduction where the WUR gain is most needed.

WUR mobility measurements: The other solution would be to introduce a new reference signal which can be used for mobility measurements using the WUR, so that the WUR gains would be applicable to all WUR UEs. However, one of the big advantages of NR compared to LTE is the ultra-lean design and the minimization of always-on signals. Therefore, due to added signaling overhead, network energy consumption, inter-cell interference, and difficulties for spectrum sharing with other technologies (e.g., dynamic spectrum sharing with LTE, in-band operation of NB-IoT, etc.) the resistance to such solution could be strong.

Certain aspects of the disclosure and their embodiments may provide solutions to these or other challenges. Generally, some embodiments enable flexible WUR operation both with and without dedicated WUR broadcast signal for mobility measurements. Some embodiments in this regards generally provide flexibility for the WUR feature deployment by having configurable support for the RRM measurements. For example, some embodiments provide configurability between WUR mobility measurements and legacy RRM measurements (using the main receiver), e.g., as part of the WUR configuration in the network in system information broadcast.

Here, in some embodiments with regard to WUR mobility measurements, a new WUR-specific signal broadcast is used for WUR. WUR UEs are required to perform serving cell RRM measurements (and optionally also neighbor cell measurements) on this new signal.

With regard to legacy RRM measurements using the main receiver, WUR UEs in some embodiments must periodically start their main receiver to perform RRM measurements. Existing or new WUR-specific RRM measurement relaxations can be applied.

Some embodiments include mechanisms and procedures for the case where the WUR can be used for mobility measurements, i.e., when a WUR reference signal is broadcasted. That is, according to some embodiments, a UE occasionally uses the main receiver for more thorough mobility measurements (e.g., a fail-safe mechanism), to read system information upon cell change, to update WUR parameters, etc.

Certain embodiments may provide one or more of the following technical advantage(s). Some embodiments make it easier to support WUR operation in networks by letting operators decide whether to turn on WUR reference signal broadcast to have somewhat larger WUR gains, or avoid these additional always-on signals in the network. The configurability also makes the WUR feature more flexible and future proof since potential collisions with in-band operation of other technologies can be avoided (e.g., dynamic spectrum sharing of LTE, or in-band operation of NB-IoT). Alternatively or additionally, some embodiments allow addressing the tradeoff between UE energy efficiency and network energy and spectral efficiency.

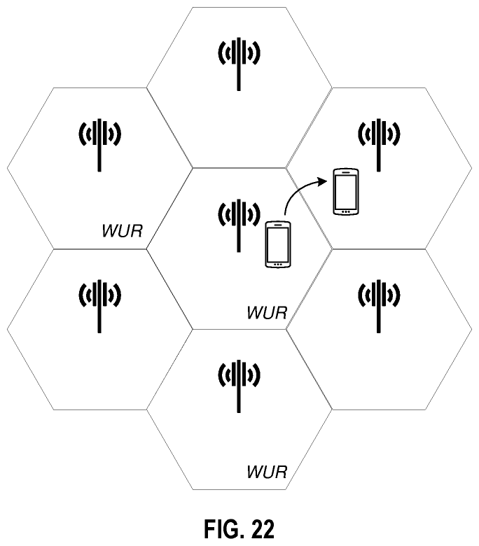

More specifically, when a UE is in WUR operation, the UE is monitoring the DL with the WUR instead of the main receiver. In this case, the UE still needs to be able to detect if it is still located in the same cell or if has moved to a new cell. This is illustrated in FIG. 22, which shows cell change for UE in WUR operation.

In legacy operation, by contrast, the UE is required to perform RRM measurements once every discontinuation reception (DRX) cycle; that is, when it wakes up to monitor PDCCH it must check if the serving cell is still the strongest cell or if a neighbor cell has become stronger (see TR 38.304 V17.2.0 for further details). In case of cell-change, the UE needs to be able to determine if the new cell supports WUR and either fall back to legacy monitoring of the downlink (e.g., DRX or eDRX operation) if it doesn't, or acquire the WUR configuration of the new cell if it does. If the legacy RRM measurement condition applies also to WUR operation, e.g., with duty-cycled WUR, the UE would once per duty-cycle/DRX not only have to monitor the DL with WUR but also start up the main receiver to perform the RRM measurements. This would remove most, or all, of the WUR gains compared to baseline (DRX or Rel-17 PEI). Some embodiments herein consider two different solution tracks to this problem:

Solution A: A new periodic downlink broadcast signal is introduced which can be received with the WUR to perform mobility measurements, e.g., a WUR-SS (synchronization signal) or WUR-SSB (where the ‘WUR-SSB’ would contain similar content as the legacy SSB potentially with a smaller payload which can be received using the WUR). Pros: Main receiver does not have to be started unless there is data activity which maximizes the WUR gains. Cons: New always-on signal is required which adds to signaling overhead, network (NW) energy consumption, NW product complexity, inter-cell interference, and complicates co-existence, etc.

Solution B: Start-up of main receiver to perform measurements as in current specification (i.e. on SSB, CSI-RS, CRS, DMRS, PSS, SSS, etc.). Pros: No new always-on signal is required and WUR can be supported in the cell with a minimum overhead and drawbacks. Cons: Gain is limited due to periodic start of the main receiver for mobility measurements.

### Embodiment X1: Configurability

Consider some examples of the embodiments in FIGS. WW1 and 12, e.g., as captured in enumerated Embodiments A1-A24 and B1-B25.

According to some embodiments herein, it is made configurable whether solution A or B is used in a cell. This could for example be indicated as a Boolean parameter in the WUR configuration in the cell, e.g., where ssbMobilityMeasurement is an example of the signaling 20 in FIGS. 1, WW1, and 12 as well as enumerated Embodiments A1-A24 and B1-B25. An ASN.1 example of an addition to TS 38.331 V17.2.0 is given below (additions underlined):

DownlinkConfigCommonSIB field descriptions
[Omitted field descriptions]
pcch-Config
The paging related configuration.
wur-Config
The WUR related configuration.
ssbMobilityMeasurement
If present, WUR UEs use SSB for mobility measurements and cell identification. Otherwise,
the WUR UEs use WUR-SS or WUR-SSB for mobility measurements and cell identification.
[Omitted field descriptions]

DownlinkConfigCommonSIB information element

```
  -- ASN1START
  -- TAG-DOWNLINKCONFIGCOMMONSIB-START
```

| | |
|---|---|
| DownlinkConfigCommonSIB ::= | SEQUENCE { |
| frequencyInfoDL | FrequencyInfoDL-SIB, |
| initialDownlinkBWP | BWP-DownlinkCommon, |
| bcch-Config | BCCH-Config, |
| pcch-Config | PCCH-Config, |

```
    ...,
    [[
```

| | | |
|---|---|---|
| pei-Config-r17 | PEI-Config-r17 | OPTIONAL, -- Need R |
| initialDownlinkBWP-RedCap-r17 | BWP-DownlinkCommon | OPTIONAL -- Need R |

```
    ]],
    [[
    wur-Config-r18 WUR-Config-r18 OPTIONAL -- Need R
    ]]
  }
```

| | |
|---|---|
| BCCH-Config ::= | SEQUENCE { |
| modificationPeriodCoeff | ENUMERATED {n2, n4, n8, n16}, |

```
    ...
  }
```

| | |
|---|---|
| PCCH-Config ::= | SEQUENCE { |
| defaultPagingCycle | PagingCycle, |
| nAndPagingFrameOffset | CHOICE { |
| oneT | NULL, |
| halfT | INTEGER (0..1), |
| quarterT | INTEGER (0..3), |
| oneEighthT | INTEGER (0..7), |
| oneSixteenthT | INTEGER (0..15) |

},

| | |
|---|---|
| ns | ENUMERATED {four, two, one}, |
| firstPDCCH-MonitoringOccasionOfPO | CHOICE { |

| | |
|---|---|
| sCS15KHZoneT | SEQUENCE (SIZE |

(1..maxPO-perPF)) OF INTEGER (0..139),

| | |
|---|---|
| sCS15KHZoneT-SCS15KHZhalfT | SEQUENCE |

```
(SIZE (1..maxPO-perPF)) OF INTEGER (0..279),
        sCS60KHZoneT-SCS30KHZhalfT-SCS15KHZquarterT
SEQUENCE (SIZE (1..maxPO-perPF)) OF INTEGER (0..559),
        sCS120KHZoneT-SCS60KHZhalfT-SCS30KHZquarterT-SCS15KHZoneEighthT
SEQUENCE (SIZE (1..maxPO-perPF)) OF INTEGER (0..1119),
        sCS120KHZhalfT-SCS60KHZquarterT-SCS30KHZoneEighthT-
```

| | |
|---|---|
| SCS15KHZoneSixteenthT | SEQUENCE (SIZE (1..maxPO-perPF)) OF INTEGER (0..2239), |

sCS480KHZoneT-SCS120KHZquarterT-SCS60KHZoneEighthT-

| | |
|---|---|
| SCS30KHZoneSixteenthT | SEQUENCE (SIZE (1..maxPO-perPF)) OF INTEGER (0..4479), |

```
        sCS480KHZhalfT-SCS120KHZoneEighthT-SCS60KHZoneSixteenthT
SEQUENCE (SIZE (1..maxPO-perPF)) OF INTEGER (0..8959),
        sCS480KHZquarterT-SCS120KHZoneSixteenthT
SEQUENCE (SIZE (1..maxPO-perPF)) OF INTEGER (0..17919)
    } OPTIONAL, -- Need R
    ...,
    [[
```

| | |
|---|---|
| nrofPDCCH-MonitoringOccasionPerSSB-InPO-r16 | INTEGER (2..4) |

```
OPTIONAL -- Cond Shared Spectrum2
    ]],
    [[
```

| | | |
|---|---|---|
| ranPagingInIdlePO-r17 | ENUMERATED {true} | OPTIONAL, -- |

Need R
firstPDCCH-MonitoringOccasionOfPO-v1710 CHOICE {

| | |
|---|---|
| sCS480KHZoneEighthT | SEQUENCE (SIZE (1..maxPO-perPF)) OF INTEGER |

(0..35839),

| | |
|---|---|
| sCS480KHZoneSixteenthT | SEQUENCE (SIZE (1..maxPO-perPF)) OF INTEGER |

(0..71679)

| | |
|---|---|
| } | OPTIONAL -- Need R |

```
    ]]
  }
```

| | |
|---|---|
| PEI-Config-r17 ::= | SEQUENCE { |
| po-NumPerPEI-r17 | ENUMERATED {po1, po2, po4, po8} |
| payloadSizeDCI-2-7-r17 | INTEGER (1..maxDCI-2-7-Size-r17), |
| pei-FrameOffset-r17 | INTEGER (0..16), |
| subgroupConfig-r17 | SubgroupConfig-r17, |
| lastUsedCellOnly-r17 | ENUMERATED {true} |

```
OPTIONAL, -- Need R
    ...
  }
```

| | |
|---|---|
| SubgroupConfig-r17 ::= | SEQUENCE { |
| subgroupsNumPerPO-r17 | INTEGER (1.. maxNrofPagingSubgroups-r17), |
| subgroupsNumForUEID-r17 | INTEGER (1.. maxNrofPagingSubgroups-r17) |

```
OPTIONAL, -- Need S
    ...
  }
  WUR-Config-r18 ::= SEQUENCE {
    [Other WUR configuration parameters here]
    ssbMobilityMeasurement-r18 ENUMERATED {true} OPTIONAL, -- Need R
    ...
  }
  -- TAG-DOWNLINKCONFIGCOMMONSIB-STOP
  -- ASN1STOP
```

Alternatively, alternative A could be optional and implicitly indicated by the presence of configuration parameters for the new WUR always-on signal in system information, e.g., WUR-SS or WUR-SSB. An ASN.1 example of an addition to TS 38.331 is given below (additions underlined):

| | |
|---|---|
| SubgroupConfig-r17 ::= | SEQUENCE { |
| subgroupsNumPerPO-r17 INTEGER | (1..maxNrofPagingSubgroups-r17), |
| subgroups NumForUEID-r17 | INTEGER (1..maxNrofPagingSubgroups-r17) |

```
OPTIONAL, -- Need S
    ...
  }
  WUR-Config-r18 ::= SEQUENCE {
    [Other WUR configuration parameters here]
    ssWur-Config-r18 SsWur-Config-r18
    ...
  }
```

### Embodiment X2: Reduced WUR Mobility Measurements

Consider some examples of the embodiments in FIGS. 3 and 13, e.g., as captured in enumerated Embodiments AA1-AA8 and BB1-BB6.

In another embodiment, WUR UEs are only required to perform serving cell measurements if serving cell RSRP/RSRQ (using for example WUR-SS or WUR-SSB) is above a certain configurable threshold. I.e., if the serving cell is strong there is no need for the WUR UE to measure on neighbor cells. If the measured RSRP/RSRQ is not above said threshold, the UE is mandated to perform full mobility measurements including neighbor cells. Either the WUR can be used for this (limited to cells supporting WUR) or the main receiver is started for full RRM measurement relaxation of serving and neighbor cells (considering also cells not supporting WUR). In either case, WUR operation can continue if a suitable cell is found which supports WUR, if not, WUR operation is aborted.

DownlinkConfigCommonSIB field descriptions
[Omitted field descriptions]
pcch-Config
The paging related configuration.
wur-Config
The WUR related configuration.
ssWur-Config-r18
The WUR synchronization signal configuration. If present, WUR UEs use WUR-SS for
mobility measurements and cell identification. Otherwise, the WUR UEs use SSB for
mobility measurements and cell identification.
[Omitted field descriptions]

### Embodiment X3: Procedure Upon Cell Change

Consider some examples of the embodiments in FIGS. 11 and 14, e.g., as captured in enumerated Embodiments AAA1-AAA33 and BBB1-BBB33.

When the WUR UE changes cells, e.g., cell re-selection in Idle or Inactive, it needs to adapt to the RRM mobility measurement configuration in the new cell (and possibly any other WUR parameter).

For solution B and relying on main receiver measurements, this would follow legacy procedure (measuring on SSB, acquiring MIB and system information as needed).

For solution A and relying on WUR mobility measurements, however, it is assumed in some embodiments that the UE does not know the WUR configuration in the new cell, or even if the new cell supports WUR at all. In one embodiment, the main receiver is always used upon cell change, i.e., when the serving cell can no longer be detected. In one embodiment, this corresponds to when the WUR measurements have failed for a number of N occasions, or not succeeded for a time T (see details further below). In another embodiment, this corresponds to when the RSRP for the WUR reference signal (measured with the WUR) falls below a certain threshold (either hard-coded in spec, or semi-statically configured, e.g., in system information). Note that these embodiments can be applied separately or jointly. In some embodiments, the main receiver would, when any of the above conditions are fulfilled (WUR measurement failure or weak RSRP), be started to determine a new cell to camp on, to synchronize, and acquire system information in that cell. Using the main receiver, it would be determined if the new cell supports WUR, and if so, the WUR configuration would be acquired (including the configuration for the WUR reference signal, e.g., WUR-SS or WUR-SSB). The UE can after this switch back to using WUR for mobility measurements (applying the obtained WUR configuration) and allowing for the main receiver to go back to a deep sleep state.

### Embodiment X4: WUR Configuration Change

Consider some examples of the embodiments in FIGS. 9, 10 and 18, e.g., as captured in enumerated Embodiments AAAAA1-AAAAAA10 and BBBBBB1-BBBBBB3.

In another embodiment, in WUR operation (A) the main receiver is still used to monitor for system information change notification. I.e., if no such information can be contained in the WUR reference signal, a UE in WUR operation needs to occasionally check if there has been a system information (SI) update. In one embodiment, this is done by periodically waking up the main receiver to acquire the value Tag in system information (SIB1). The periodicity to this would typically be longer than the periodicity for WUR mobility measurements and for monitoring WUS occasions using the WUR (if not WUR gains would be insignificant). The periodicity could for example be M times per Broadcast Control Channel (BCCH) system information modification period configured in the cell. In another alternative, it is controlled by a timer, i.e., the value Tag in system information (SIB1) is acquired using the main receiver when a timer Tₛᵢ expires (and restarted after this event).

In one embodiment, an SI change notification is transmitted in WUS to WUR UEs. That is the WUS could contain a field “system information update notification” that would be sent out by the gNB to UEs in the cell in case of system information update (gNB would need to ensure UEs in all configured WUS monitoring occasions and WUS UE groups are reached). gNB would set this indication during one BCCH system information modification period if the system information it to be updated the subsequent BCCH system information modification period. The indication could either be joint with system information overall (i.e., it would be set also if non-WUR related SI is changed), or it would be WUR specific (only notifying change of WUR configuration).

In one embodiment, the new WUR reference signal, e.g., a WUR synchronization signal (WUR-SS) or WUR-SSB, contain a ‘system information update notification’. gNB would set this indication during one BCCH system information modification period if the system information is to be updated the subsequent BCCH system information modification period. The indication could either be joint with system information overall (i.e., it would be set also if non-WUR related SI is changed), or it would be WUR specific (only notifying change of WUR configuration).

In one embodiment, WUR UEs are only obliged to start to main receiver and check the value Tag in system information (SIB1) if they have not been able to monitor WUS in their WUS monitoring occasions in a given period of time (e.g., the BCCH system information modification period), e.g., if the UE has been out-of-coverage and comes back.

### Embodiment X5: Fail-Safe Procedure

Consider some examples of the embodiments in FIGS. 5 and 9, e.g., as captured in enumerated Embodiments AAAA1-AAAA10 and AAAAAA1-AAAAAA6.

In another embodiment, the mobility measurements using the main receiver (Solution B) are considered to be more trustworthy, and therefore they are triggered periodically but infrequently also when the UE is performing mobility measurements using WUR (Solution A). In this case, then, Solution B is used as a fail-safe mechanism. That is, when the UE is in WUR operation performing mobility measurements, e.g., on WUR-SS or WUR-SSB, full mobility measurements are performed with the main receiver every X ms (e.g., configurable in SI or RRC), as a fail-safe mechanism. The value X may have a configurable range to provide a good trade-off between WUR energy consumption gains and ensuring that UEs in WUR operation does not become unreachable in DL upon cell-change, etc.

Consider some examples of the embodiments in FIGS. 4 and/or FIG. 15, e.g., as captured in enumerated Embodiments AAA1-AAA33 and BBB1-BBB33 in the EMBODIMENTS section herein.

In another embodiment, WUR measurement failure will instead trigger RRM measurement using the main receiver (i.e., event-based instead of periodic). In one alternative implementation, WUR measurement failure is deemed to occur if WUR fails to perform mobility measurement, e.g., detect WUR-SS or WUR-SSB, within one time duration, where the time duration may be configured by network. In such a case, the main receiver will be woken up to perform (legacy) RRM mobility measurements. In another alternative implementation, WUR measurement failure is deemed to occur upon expiration of a timer. In this case, if WUR fails to perform mobility measurement, e.g., detect WUR-SS or WUR-SSB, a timer is started upon this WUR measurement failure (possibly one or more, parameter N). If there hasn't been successful WUR mobility measurement (possibly one or more, parameter M) before the expiration of the timer, WUR measurement failure is deemed to occur. In this case, the main receiver will be woken up to perform (legacy) RRM mobility measurements. M successful attempt will stop the timer without action.

### Embodiment X6: Relaxed Mobility Measurements while in WUR Operation

Consider some examples of the embodiments in FIGS. 6 and 16, e.g., as captured in enumerated Embodiments AAAAA1-AAAAA7 and BBBBB1-BBBBB7.

In another embodiment, the mobility measurements are made using the main receiver (Solution B). To benefit from the low power consumption of the WUR, the measurements are performed with a different periodicity than when WUR is not used. The periodicity when WUR is used can either be stated explicitly as every X ms, or be performed every Y period of the legacy RRM measurements (e.g., if Y=2, every other RRM measurement is skipped). The values of X and Y could for example be specified or configured in RRC or SI. If they are configured in RRC they could be configured in the same IE that contains the WUR configuration.

### Embodiment X7: Triggering of Main Receiver to Wake Up to Perform Mobility-Related Measurements Based on Some Rules

Consider some examples of the embodiments in FIGS. 4 and 9, e.g., as captured in enumerated Embodiments AAA1-AAA33 and BBB1-BBB33.

In another embodiment, the mobility related measurements are performed using the main receiver (Solution B). The main receiver is woken up to perform mobility-related measurements only if one or more conditions or rules are satisfied. One example of such conditions or rules is when the number of WUS monitoring attempts, duty-cycles, or time duration over which WUS is not detected by WUR is larger than a certain threshold, it triggers the main receiver to wake up and perform mobility-related measurements. The threshold value can be configured by the network (with a possible range reported by UE) or indicated by UE.

### Embodiment X8: Switching Mechanism for Mobility Measurements

Consider some more examples of the embodiments in FIGS. 4 and 9, e.g., as captured in enumerated Embodiments AAA1-AAA33 and BBB1-BBB33.

In another embodiment, the mobility related measurements are performed using WUR or the main radio in a dynamic manner to efficiently capture the tradeoff between UE energy efficiency and network energy/spectral efficiency. Specifically, under some conditions WUR is used for mobility measurements; otherwise the main radio performs mobility measurements.

In one embodiment, mobility-related measurements are done by WUR or the main radio changes periodically. For example, every T ms or every N DRX cycles the function of mobility measurements is switched between WUR and the main radio. The switching periodicity can be configurable to address the tradeoff between UE energy efficiency and network energy/spectral efficiency.

In another embodiment, using WUR for mobility measurements increases the power saving gain. The switching between WUR and the main radio can depend on the UE battery level. For example, if the UE battery level falls below a certain threshold, WUR is used for mobility measurements in order to improve UE energy efficiency.

In yet another embodiment, in general, UEs located farther away from the gNB suffer from higher energy consumption. Hence, using WUR can be more useful for UEs located closer to the cell edge. In one embodiment, the use of WUR for mobility measurements depend on the distance of UE to the gNB. For example, if distance between gNB and the UE is larger than a certain threshold D, the WUR is used for mobility measurements, otherwise the main radio is used. This distance may correspond to RSRP or RSRQ measurements on a DL reference signal, e.g., the WUR is used for mobility measurements if the measured RSRP or RSRQ value is below a certain threshold (e.g., semi-statically configured in system information). In another alternative, the main receiver measurements are considered more reliable, and instead the main receiver is used for mobility measurements if the measured RSRP/RSRQ is below the configured threshold (i.e., at the cell-edge), if not WUR is used for mobility measurements (i.e., in the cell center).

In still other embodiments, WUR has a certain sensitivity which can be lower (i.e., worse coverage) than the main radio. Therefore, it may not be feasible to always use WUR for mobility measurements. In one embodiment, whether WUR is used for mobility measurements depends on the architecture and sensitivity of WUR as well as the deployment scenario. For example, in indoor or dense urban deployments where WUR has a sufficient sensitivity, it is used for mobility measurements. However, for macro deployments requiring high sensitivity receivers, the main radio is used for mobility measurements. Additionally, WUR architecture can determine whether WUR is used for mobility measurements. For instance, a high-end WUR architecture is used for mobility measurements, while in case of a low-end WUR architecture the main radio is used.

Note that a commonly used modulation for the WUS/WUP is on-off keying (OOK), which is a binary modulation where a logical one is represented by sending a (any) signal (ON) and a logical zero is represented by not sending any signal (OFF); or vice versa.

The demodulation of digital signals in a wireless system can be achieved either as coherent, in which the frequency and phase of the carrier have been previously recovered, or as non-coherent.

Examples of downlink RS are signals in SSB, CSI-RS, CRS, DMRS, PSS, SSS, signals in SS/PBCH block (SSB), discovery reference signal (DRS), PRS etc. Examples of uplink RS are signals in SRS, DMRS etc.

Each SSB carries NR-PSS, NR-SSS and NR-PBCH in 4 successive symbols. One or multiple SSBs are transmit in one SSB burst which is repeated with certain periodicity e.g. 5 ms, 10 ms, 20 ms, 40 ms, 80 ms and 160 ms. The UE is configured with information about SSB on cells of certain carrier frequency by one or more SS/PBCH block measurement timing configuration (SMTC) configurations. The SMTC configuration comprising parameters such as SMTC periodicity, SMTC occasion length in time or duration, SMTC time offset wrt reference time (e.g. serving cell's SFN) etc. Therefore, SMTC occasion may also occur with certain periodicity e.g. 5 ms, 10 ms, 20 ms, 40 ms, 80 ms and 160 ms.

Examples of measurements are cell identification (e.g. PCI acquisition, PSS/SSS detection, cell detection, cell search etc), Reference Symbol Received Power (RSRP), Reference Symbol Received Quality (RSRQ), secondary synchronization RSRP (SS-RSRP), SS-RSRQ, SINR, RS-SINR, SS-SINR, CSI-RSRP, CSI-RSRQ, received signal strength indicator (RSSI), acquisition of system information (SI), cell global ID (CGI) acquisition, Reference Signal Time Difference (RSTD), UE RX-TX time difference measurement, Radio Link Monitoring (RLM), which consists of Out of Synchronization (out of sync) detection and In Synchronization (in-sync) detection etc.

The measurements are done for various purposes. Some example measurement purposes are: UE mobility (e.g. cell change, cell selection, cell reselection, handover, RRC connection re-establishment etc), UE positioning or location determination self-organizing network (SON), minimization of drive tests (MDT), operation and maintenance (O&M), network planning and optimization etc.

Embodiments herein also include corresponding apparatuses. Embodiments herein for instance include a communication device 12 configured to perform any of the steps of any of the embodiments described above for the communication device 12.

Embodiments also include a communication device 12 comprising processing circuitry and power supply circuitry. The processing circuitry is configured to perform any of the steps of any of the embodiments described above for the communication device 12. The power supply circuitry is configured to supply power to the communication device 12.

Embodiments further include a communication device 12 comprising processing circuitry. The processing circuitry is configured to perform any of the steps of any of the embodiments described above for the communication device 12. In some embodiments, the communication device 12 further comprises communication circuitry.

Embodiments further include a communication device 12 comprising processing circuitry and memory. The memory contains instructions executable by the processing circuitry whereby the communication device 12 is configured to perform any of the steps of any of the embodiments described above for the communication device 12.

Embodiments moreover include a user equipment (UE). The UE comprises an antenna configured to send and receive wireless signals. The UE also comprises radio front-end circuitry connected to the antenna and to processing circuitry, and configured to condition signals communicated between the antenna and the processing circuitry. The processing circuitry is configured to perform any of the steps of any of the embodiments described above for the communication device 12. In some embodiments, the UE also comprises an input interface connected to the processing circuitry and configured to allow input of information into the UE to be processed by the processing circuitry. The UE may comprise an output interface connected to the processing circuitry and configured to output information from the UE that has been processed by the processing circuitry. The UE may also comprise a battery connected to the processing circuitry and configured to supply power to the UE.

Embodiments herein also include a network node 14 configured to perform any of the steps of any of the embodiments described above for the network node 14.

Embodiments also include a network node 14 comprising processing circuitry and power supply circuitry. The processing circuitry is configured to perform any of the steps of any of the embodiments described above for the network node 14. The power supply circuitry is configured to supply power to the network node 14.

Embodiments further include a network node 14 comprising processing circuitry. The processing circuitry is configured to perform any of the steps of any of the embodiments described above for the network node 14. In some embodiments, the network node 14 further comprises communication circuitry.

Embodiments further include a network node 14 comprising processing circuitry and memory. The memory contains instructions executable by the processing circuitry whereby the network node 14 is configured to perform any of the steps of any of the embodiments described above for the network node 14.

More particularly, the apparatuses described above may perform the methods herein and any other processing by implementing any functional means, modules, units, or circuitry. In one embodiment, for example, the apparatuses comprise respective circuits or circuitry configured to perform the steps shown in the method figures. The circuits or circuitry in this regard may comprise circuits dedicated to performing certain functional processing and/or one or more microprocessors in conjunction with memory. For instance, the circuitry may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory may include program instructions for executing one or more telecommunications and/or data communications protocols as well as instructions for carrying out one or more of the techniques described herein, in several embodiments. In embodiments that employ memory, the memory stores program code that, when executed by the one or more processors, carries out the techniques described herein.

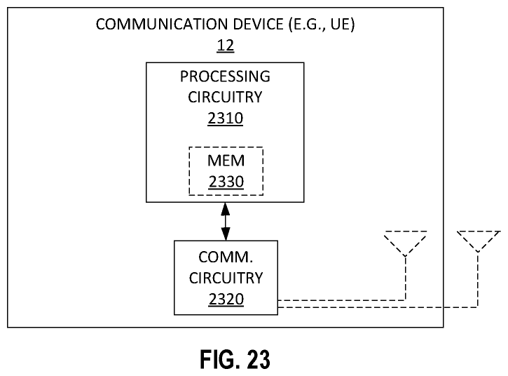

FIG. 23 for example illustrates a communication device 12 as implemented in accordance with one or more embodiments. As shown, the communication device 12 includes processing circuitry 2310 and communication circuitry 2320. The communication circuitry 2320 (e.g., radio circuitry) is configured to transmit and/or receive information to and/or from one or more other nodes, e.g., via any communication technology. Such communication may occur via one or more antennas that are either internal or external to the communication device 2300. The processing circuitry 2310 is configured to perform processing described above, e.g., in any of FIGS. WW1-10, such as by executing instructions stored in memory 2330. The processing circuitry 2310 in this regard may implement certain functional means, units, or modules.

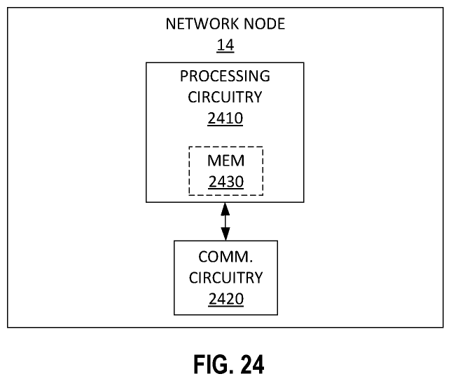

FIG. 24 illustrates a network node 14 as implemented in accordance with one or more embodiments. As shown, the network node 14 includes processing circuitry 2410 and communication circuitry 2420. The communication circuitry 2420 is configured to transmit and/or receive information to and/or from one or more other nodes, e.g., via any communication technology. The processing circuitry 2410 is configured to perform processing described above, e.g., in any of FIGS. 12-18, such as by executing instructions stored in memory 2430. The processing circuitry 2410 in this regard may implement certain functional means, units, or modules.

Those skilled in the art will also appreciate that embodiments herein further include corresponding computer programs.

A computer program comprises instructions which, when executed on at least one processor of an apparatus, cause the apparatus to carry out any of the respective processing described above. A computer program in this regard may comprise one or more code modules corresponding to the means or units described above.

Embodiments further include a carrier containing such a computer program. This carrier may comprise one of an electronic signal, optical signal, radio signal, or computer readable storage medium.

In this regard, embodiments herein also include a computer program product stored on a non-transitory computer readable (storage or recording) medium and comprising instructions that, when executed by a processor of an apparatus, cause the apparatus to perform as described above.

Embodiments further include a computer program product comprising program code portions for performing the steps of any of the embodiments herein when the computer program product is executed by a computing device. This computer program product may be stored on a computer readable recording medium.

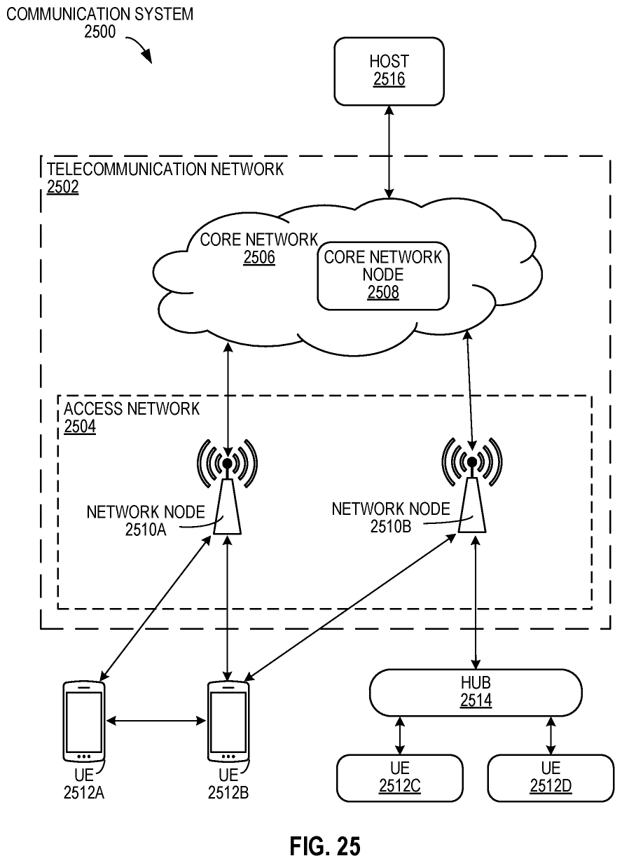

FIG. 25 shows an example of a communication system 2500 in accordance with some embodiments.

In the example, the communication system 2500 includes a telecommunication network 2502 that includes an access network 2504, such as a radio access network (RAN), and a core network 2506, which includes one or more core network nodes 2508. The access network 2504 includes one or more access network nodes, such as network nodes 2510a and 2510b (one or more of which may be generally referred to as network nodes 2510), or any other similar 3^{rd} Generation Partnership Project (3GPP) access node or non-3GPP access point. The network nodes 2510 facilitate direct or indirect connection of user equipment (UE), such as by connecting UEs 2512a, 2512b, 2512c, and 2512d (one or more of which may be generally referred to as UEs 2512) to the core network 2506 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 2500 may include any number of wired or wireless networks, network nodes, UEs, and/or any other components or systems that may facilitate or participate in the communication of data and/or signals whether via wired or wireless connections. The communication system 2500 may include and/or interface with any type of communication, telecommunication, data, cellular, radio network, and/or other similar type of system.

The UEs 2512 may be any of a wide variety of communication devices, including wireless devices arranged, configured, and/or operable to communicate wirelessly with the network nodes 2510 and other communication devices. Similarly, the network nodes 2510 are arranged, capable, configured, and/or operable to communicate directly or indirectly with the UEs 2512 and/or with other network nodes or equipment in the telecommunication network 2502 to enable and/or provide network access, such as wireless network access, and/or to perform other functions, such as administration in the telecommunication network 2502.

In the depicted example, the core network 2506 connects the network nodes 2510 to one or more hosts, such as host 2516. These connections may be direct or indirect via one or more intermediary networks or devices. In other examples, network nodes may be directly coupled to hosts. The core network 2506 includes one more core network nodes (e.g., core network node 2508) that are structured with hardware and software components. Features of these components may be substantially similar to those described with respect to the UEs, network nodes, and/or hosts, such that the descriptions thereof are generally applicable to the corresponding components of the core network node 2508. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 2516 may be under the ownership or control of a service provider other than an operator or provider of the access network 2504 and/or the telecommunication network 2502, and may be operated by the service provider or on behalf of the service provider. The host 2516 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 2500 of FIG. 25 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 2502 is a cellular network that implements 3GPP standardized features. Accordingly, the telecommunications network 2502 may support network slicing to provide different logical networks to different devices that are connected to the telecommunication network 2502. For example, the telecommunications network 2502 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 2512 are configured to transmit and/or receive information without direct human interaction. For instance, a UE may be designed to transmit information to the access network 2504 on a predetermined schedule, when triggered by an internal or external event, or in response to requests from the access network 2504. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 2514 communicates with the access network 2504 to facilitate indirect communication between one or more UEs (e.g., UE 2512c and/or 2512d) and network nodes (e.g., network node 2510b). In some examples, the hub 2514 may be a controller, router, content source and analytics, or any of the other communication devices described herein regarding UEs. For example, the hub 2514 may be a broadband router enabling access to the core network 2506 for the UEs. As another example, the hub 2514 may be a controller that sends commands or instructions to one or more actuators in the UEs. Commands or instructions may be received from the UEs, network nodes 2510, or by executable code, script, process, or other instructions in the hub 2514. As another example, the hub 2514 may be a data collector that acts as temporary storage for UE data and, in some embodiments, may perform analysis or other processing of the data. As another example, the hub 2514 may be a content source. For example, for a UE that is a VR headset, display, loudspeaker or other media delivery device, the hub 2514 may retrieve VR assets, video, audio, or other media or data related to sensory information via a network node, which the hub 2514 then provides to the UE either directly, after performing local processing, and/or after adding additional local content. In still another example, the hub 2514 acts as a proxy server or orchestrator for the UEs, in particular in if one or more of the UEs are low energy IoT devices.

The hub 2514 may have a constant/persistent or intermittent connection to the network node 2510b. The hub 2514 may also allow for a different communication scheme and/or schedule between the hub 2514 and UEs (e.g., UE 2512c and/or 2512d), and between the hub 2514 and the core network 2506. In other examples, the hub 2514 is connected to the core network 2506 and/or one or more UEs via a wired connection. Moreover, the hub 2514 may be configured to connect to an M2M service provider over the access network 2504 and/or to another UE over a direct connection. In some scenarios, UEs may establish a wireless connection with the network nodes 2510 while still connected via the hub 2514 via a wired or wireless connection. In some embodiments, the hub 2514 may be a dedicated hub—that is, a hub whose primary function is to route communications to/from the UEs from/to the network node 2510b. In other embodiments, the hub 2514 may be a non-dedicated hub—that is, a device which is capable of operating to route communications between the UEs and network node 2510b, but which is additionally capable of operating as a communication start and/or end point for certain data channels.

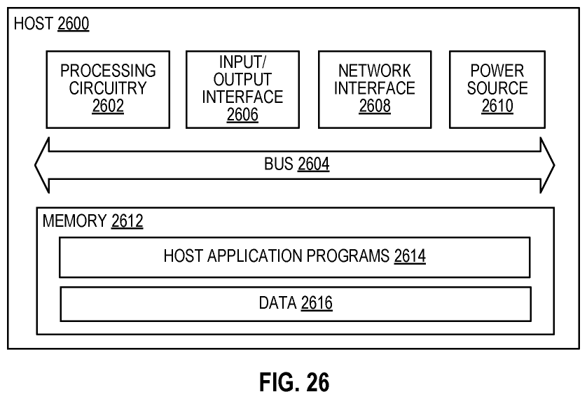

FIG. 26 is a block diagram of a host 2600, which may be an embodiment of the host 2516 of FIG. 25, in accordance with various aspects described herein. As used herein, the host 2600 may be or comprise various combinations hardware and/or software, including a standalone server, a blade server, a cloud-implemented server, a distributed server, a virtual machine, container, or processing resources in a server farm. The host 2600 may provide one or more services to one or more UEs.

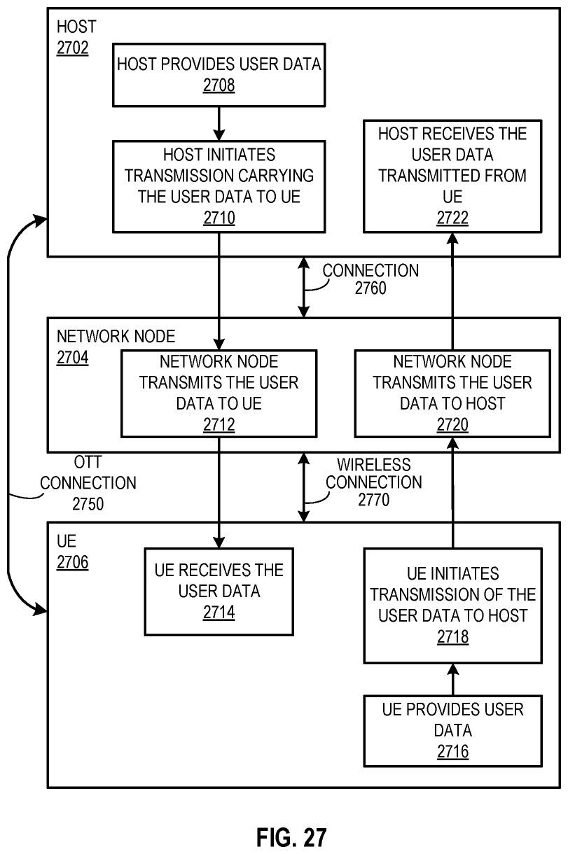

The host 2600 includes processing circuitry 2602 that is operatively coupled via a bus 2604 to an input/output interface 2606, a network interface 2608, a power source 2610, and a memory 2612. Other components may be included in other embodiments. Features of these components may be substantially similar to those described with respect to the devices of previous figures, such as FIGS. 26 and 27, such that the descriptions thereof are generally applicable to the corresponding components of host 2600.

The memory 2612 may include one or more computer programs including one or more host application programs 2614 and data 2616, which may include user data, e.g., data generated by a UE for the host 2600 or data generated by the host 2600 for a UE. Embodiments of the host 2600 may utilize only a subset or all of the components shown. The host application programs 2614 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 2614 may also provide for user authentication and licensing checks and may periodically report health, routes, and content availability to a central node, such as a device in or on the edge of a core network. Accordingly, the host 2600 may select and/or indicate a different host for over-the-top services for a UE. The host application programs 2614 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 27 shows a communication diagram of a host 2702 communicating via a network node 2704 with a UE 2706 over a partially wireless connection in accordance with some embodiments. Example implementations, in accordance with various embodiments, of the UE (such as a UE 2512a of FIG. 25 and/or UE 2600 of FIG. 26), network node (such as network node 2510a of FIG. 25 and/or network node 2700 of FIG. 27), and host (such as host 2516 of FIG. 25 and/or host 2600 of FIG. 26) discussed in the preceding paragraphs will now be described with reference to FIG. 27.

Like host 2600, embodiments of host 2702 include hardware, such as a communication interface, processing circuitry, and memory. The host 2702 also includes software, which is stored in or accessible by the host 2702 and executable by the processing circuitry. The software includes a host application that may be operable to provide a service to a remote user, such as the UE 2706 connecting via an over-the-top (OTT) connection 2750 extending between the UE 2706 and host 2702. In providing the service to the remote user, a host application may provide user data which is transmitted using the OTT connection 2750.

The network node 2704 includes hardware enabling it to communicate with the host 2702 and UE 2706. The connection 2760 may be direct or pass through a core network (like core network 2506 of FIG. 25) and/or one or more other intermediate networks, such as one or more public, private, or hosted networks. For example, an intermediate network may be a backbone network or the Internet.

The UE 2706 includes hardware and software, which is stored in or accessible by UE 2706 and executable by the UE's processing circuitry. The software includes a client application, such as a web browser or operator-specific “app” that may be operable to provide a service to a human or non-human user via UE 2706 with the support of the host 2702. In the host 2702, an executing host application may communicate with the executing client application via the OTT connection 2750 terminating at the UE 2706 and host 2702. In providing the service to the user, the UE's client application may receive request data from the host's host application and provide user data in response to the request data. The OTT connection 2750 may transfer both the request data and the user data. The UE's client application may interact with the user to generate the user data that it provides to the host application through the OTT connection 2750.

The OTT connection 2750 may extend via a connection 2760 between the host 2702 and the network node 2704 and via a wireless connection 2770 between the network node 2704 and the UE 2706 to provide the connection between the host 2702 and the UE 2706. The connection 2760 and wireless connection 2770, over which the OTT connection 2750 may be provided, have been drawn abstractly to illustrate the communication between the host 2702 and the UE 2706 via the network node 2704, without explicit reference to any intermediary devices and the precise routing of messages via these devices.

As an example of transmitting data via the OTT connection 2750, in step 2708, the host 2702 provides user data, which may be performed by executing a host application. In some embodiments, the user data is associated with a particular human user interacting with the UE 2706. In other embodiments, the user data is associated with a UE 2706 that shares data with the host 2702 without explicit human interaction. In step 2710, the host 2702 initiates a transmission carrying the user data towards the UE 2706. The host 2702 may initiate the transmission responsive to a request transmitted by the UE 2706. The request may be caused by human interaction with the UE 2706 or by operation of the client application executing on the UE 2706. The transmission may pass via the network node 2704, in accordance with the teachings of the embodiments described throughout this disclosure. Accordingly, in step 2712, the network node 2704 transmits to the UE 2706 the user data that was carried in the transmission that the host 2702 initiated, in accordance with the teachings of the embodiments described throughout this disclosure. In step 2714, the UE 2706 receives the user data carried in the transmission, which may be performed by a client application executed on the UE 2706 associated with the host application executed by the host 2702.

In some examples, the UE 2706 executes a client application which provides user data to the host 2702. The user data may be provided in reaction or response to the data received from the host 2702. Accordingly, in step 2716, the UE 2706 may provide user data, which may be performed by executing the client application. In providing the user data, the client application may further consider user input received from the user via an input/output interface of the UE 2706. Regardless of the specific manner in which the user data was provided, the UE 2706 initiates, in step 2718, transmission of the user data towards the host 2702 via the network node 2704. In step 2720, in accordance with the teachings of the embodiments described throughout this disclosure, the network node 2704 receives user data from the UE 2706 and initiates transmission of the received user data towards the host 2702. In step 2722, the host 2702 receives the user data carried in the transmission initiated by the UE 2706.

One or more of the various embodiments improve the performance of OTT services provided to the UE 2706 using the OTT connection 2750, in which the wireless connection 2770 forms the last segment.

In an example scenario, factory status information may be collected and analyzed by the host 2702. As another example, the host 2702 may process audio and video data which may have been retrieved from a UE for use in creating maps. As another example, the host 2702 may collect and analyze real-time data to assist in controlling vehicle congestion (e.g., controlling traffic lights). As another example, the host 2702 may store surveillance video uploaded by a UE. As another example, the host 2702 may store or control access to media content such as video, audio, VR or AR which it can broadcast, multicast or unicast to UEs. As other examples, the host 2702 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 2750 between the host 2702 and UE 2706, in response to variations in the measurement results. The measurement procedure and/or the network functionality for reconfiguring the OTT connection may be implemented in software and hardware of the host 2702 and/or UE 2706. In some embodiments, sensors (not shown) may be deployed in or in association with other devices through which the OTT connection 2750 passes; the sensors may participate in the measurement procedure by supplying values of the monitored quantities exemplified above, or supplying values of other physical quantities from which software may compute or estimate the monitored quantities. The reconfiguring of the OTT connection 2750 may include message format, retransmission settings, preferred routing etc.; the reconfiguring need not directly alter the operation of the network node 2704. Such procedures and functionalities may be known and practiced in the art. In certain embodiments, measurements may involve proprietary UE signaling that facilitates measurements of throughput, propagation times, latency and the like, by the host 2702. The measurements may be implemented in that software causes messages to be transmitted, in particular empty or ‘dummy’ messages, using the OTT connection 2750 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

Some embodiments herein are enumerated below:

### Group A Embodiments

A1. A method performed by a communication device, the method comprising:
   receiving signaling indicating which type of signal and/or which type of receiver the communication device is to use for a purpose.
A2. The method of embodiment A1, wherein the signaling indicates which type of signal the communication device is to use for a purpose, out of multiple types of signals that are usable for the purpose, wherein the multiple types of signals include:
   a first type of signal that is receivable by a first type of receiver; and
   a second type of signal that is receivable by a second type of receiver and is not receivable by the first type of receiver.
A3. The method of embodiment A2, wherein the first type of receiver is a wake-up receiver, WUR.
A4. The method of any of embodiments A2-A3, wherein the first type of receiver is a receiver configured to receive a wake-up signal that triggers the communication device to awaken the second type of receiver from a sleep state.
A5. The method of any of embodiments A2-A4, wherein the first type of receiver is a non-coherent receiver and the second type of receiver is a coherent receiver.
A6. The method of any of embodiments A1-A5, wherein the signaling indicates which type of signal the communication device is to use for a purpose, out of multiple types of signals that are usable for the purpose, wherein the multiple types of signals include:
   a first type of signal that is an on-off keying, OOK, signal or a frequency shift keying, FSK, signal; and
   a second type of signal that is based on a Zadoff-Chu sequence or a maximum length sequence, m-sequence.
A7. The method of any of embodiments A1-A6, wherein the signaling indicates which type of signal the communication device is to use for a purpose, out of multiple types of signals that are usable for the purpose, wherein the multiple types of signals include:
   a first type of signal that is a WUR synchronization signal, WUR-SS, or that is included in a WUR synchronization signal block, WUR-SSB, wherein the WUR-SS or WUR-SSB is receivable by and/or specific for a WUR; and
   a second type of signal that is a SS or SSB which is not receivable by and/or is not specific for a WUR.
A8. The method of any of embodiments A1-A7, wherein the signaling indicates which type of signal the communication device is to use for a purpose, out of multiple types of signals that are usable for the purpose, wherein the multiple types of signals include
   a first type of synchronization signal and a second type of synchronization signal; or
   a synchronization signal in a first type of synchronization signal block, SSB, and a synchronization signal in a second type of SSB.
A9. The method of any of embodiments A1-A7, wherein the signaling indicates which type of signal the communication device is to use for a purpose, out of multiple types of signals that are usable for the purpose, wherein the multiple types of signals include a first type of reference signal and a second type of reference signal.
A10. The method of any of embodiments A1-A9, wherein the purpose is mobility measurements or radio resource management, RRM, measurements.
A11. The method of any of embodiments A1-A10, wherein the purpose is cell identification.
A12. The method of any of embodiments A1-A11, wherein the purpose is synchronization.
A13. The method of any of embodiments A1-A12, wherein the signaling indicates which type of signal and/or which type of receiver the communication device is to use for the purpose in a Radio Resource Control, RRC, idle state or in an RRC inactive state.
A14. The method of any of embodiments A1-A13, wherein the signaling indicates which type of signal and/or which type of receiver the communication device is to use for the purpose in a cell.
A15. The method of any of embodiments A1-A14, wherein the signaling is broadcast signaling and/or is included in System Information.
A16. The method of any of embodiments A1-A15, wherein the signaling is included in a wake-up receiver configuration that configures a wake-up receiver of the communication device.
A17. The method of any of embodiments A1-A16, wherein the signaling comprises a message, wherein a value of, or a presence or absence of, a certain information element, IE, in the message indicates which type of signal and/or which type of receiver the communication device is to use for the purpose.
A18. The method of any of embodiments A1-A17, further comprising using the indicated type of signal and/or the indicated type of receiver for the purpose.
A19. The method of any of embodiments A1-A18, wherein the signaling indicates which type of receiver the communication device is to use for the purpose.
A20. The method of embodiment A19, wherein the signaling indicates which type of receiver the communication device is to use for the purpose, out of multiple types of receivers usable for the purpose, wherein the multiple types include a first type of receiver and a second type of receiver.
A21. The method of embodiment A20, wherein the first type of receiver is a wake-up receiver, WUR.
A22. The method of any of embodiments A20-A21, wherein the first type of receiver is a receiver configured to receive a wake-up signal that triggers the communication device to awaken the second type of receiver from a sleep state.
A22. The method of any of embodiments A20-A22, wherein the first type of receiver is a non-coherent receiver and the second type of receiver is a coherent receiver.
A23. A method performed by a communication device, the method comprising:
   receiving signaling indicating which type of signal and/or which type of receiver the communication device is to use for mobility measurements and/or cell identification.
A24. The method of embodiment A23, wherein the signaling indicates whether the communication device is to use, for mobility measurements and/or cell identification:
   a first type of signal that is a WUR synchronization signal, WUR-SS, or that is included in a WUR synchronization signal block, WUR-SSB, wherein the WUR-SS or WUR-SSB is receivable by and/or specific for a WUR; or
   a second type of signal that is a SS or SSB which is not receivable by and/or is not specific for a WUR.
AA1. A method performed by a communication device, the method comprising:
   performing a serving cell measurement on a serving cell of the communication device; based on a result of the serving cell measurement, making a decision on whether or not to perform a neighbor cell measurement on one or more neighbor cells of the communication device; and
   performing, or not performing, the neighbor cell measurement in accordance with the decision.
AA2. The method of embodiment AA1, wherein the serving cell measurement is a reference signal received power, RSRP, measurement or a reference signal received quality, RSRQ, measurement.
AA3. The method of any of embodiments AA1-AA2, wherein making the decision comprises:
   making the decision to perform the neighbor cell measurement if the result of the serving cell measurement is below a first threshold; and
   making the decision to not perform the neighbor cell measurement if the result of the serving cell measurement is above a second threshold, wherein either the first and second thresholds are the same or the first threshold is below the second threshold.
AA4. The method of any of embodiments AA1-AA3, wherein the decision is a decision on in which of multiple measurement modes the communication device is to operate, wherein the multiple measurement modes include:
   a serving cell only measurement mode in which the communication device performs the serving cell measurement, without performing any neighbor cell measurement; and
   a full measurement mode in which the communication device performs both the serving cell measurement and the neighbor cell measurement.
AA5. The method of any of embodiments AA1-AA4, wherein the serving cell measurement is performed on a signal that the communication device receives from the serving cell using a wake-up receiver of the communication device.
AA6. The method of any of embodiments AA1-AA5, wherein the serving cell measurement is performed on a WUR-SS or WUR-SSB received on the serving cell.
AA7. The method of any of embodiments AA1-AA6, wherein the decision is to perform the neighbor cell measurement, and wherein the method comprises performing the neighbor cell measurement.
AA8. The method of embodiment AA7, further comprising, for each of the one or more neighbor cells, receiving a signal from the neighbor cell using a wake-up receiver of the communication device and performing the neighbor cell measurement on the received signal.
AAA1. A method performed by a communication device, the method comprising:
   making a decision on which type of signal and/or which type of receiver to use for performing a measurement; and
   performing the measurement according to the decision.
AAA2. The method of embodiment AAA1, wherein the decision is made based on:
   a result of the measurement as previously performed; and/or
   a distance between the communication device and a serving radio network node serving the communication device.
AAA3. The method of any of embodiments AAA1-AAA2, wherein making the decision comprises:
   deciding to use a first type of signal and/or a first type of receiver for performing the measurement if a result of the measurement as previously performed using the first type of signal and/or the first type of receiver is above a first threshold; and
   deciding to use a second type of signal and/or a second type of receiver for performing the measurement if the result of the measurement as previously performed using the first type of signal and/or the first type of receiver is below a second threshold.
AAA4. The method of any of embodiments AAA1-AAA3, wherein making the decision comprises:
   deciding to use a first type of signal and/or a first type of receiver for performing the measurement if a distance between the communication device and a serving radio network node serving the communication device is above a first threshold; and
   deciding to use a second type of signal and/or a second type of receiver for performing the measurement if the distance between the communication device and the serving radio network node serving the communication device is below a second threshold.
AAA5. The method of any of embodiments AAA1-AAA3, wherein making the decision comprises:
   deciding to use a first type of signal and/or a first type of receiver for performing the measurement if a distance between the communication device and a serving radio network node serving the communication device is below a first threshold; and
   deciding to use a second type of signal and/or a second type of receiver for performing the measurement if the distance between the communication device and the serving radio network node serving the communication device is above a second threshold.
AAA6. The method of any of embodiments AAA1-AAA5, wherein making the decision comprises deciding to use a second type of signal and/or a second type of receiver for performing the measurement if:
   one or more attempts to perform the measurement using a first type of signal and/or a first type of receiver have failed a threshold number of times, have failed for a threshold amount of time, and/or have failed over a threshold number of duty cycles; and/or
   a timer expires, wherein the communication device is configured to start the timer upon failure of one or more attempts to perform the measurement using a first type of signal and/or a first type of receiver, and wherein the communication device is configured to stop the timer upon success of one or more attempts to perform the measurement using the first type of signal and/or the first type of receiver.
AAA7. The method of any of embodiments AAA1-AAA6, wherein the decision is made as part of making decisions to use different types of signals and/or different types of receivers at different times.
AAA8. The method of embodiment AAA7, wherein making the decisions comprises:
   periodically deciding to perform the measurement with a first type of signal and/or a first type of receiver, according to a first period; and
   periodically deciding to perform the measurement with a second type of signal and/or a second type of receiver, according to a second period that is longer than the first period.
AAA9. The method of embodiment AAA8, further comprising receiving signaling indicating the first period and/or the second period.
AAA10. The method of any of embodiments AAA8-AAA9, wherein the second period is a multiple of the first period.
AAA11. The method of any of embodiments AAA8-AAA10, wherein the second period is aligned with the first period, with the measurement being performed only with the second type of signal and/or the second type of receiver during any overlap between the first period and the second period.
AAA12. The method of any of embodiments AAA1-AAA11, wherein the communication device is powered by a battery, and wherein the decision is made based on a charge level of the battery.
AAA13. The method of embodiment AAA12, wherein making the decision comprises:
   deciding to use a first type of signal and/or a first type of receiver for performing the measurement if the charge level is below a first threshold; and
   deciding to use a second type of signal and/or a second type of receiver for performing the measurement if the charge level is above a second threshold.
AAA14. The method of any of embodiments AAA1-AAA13, wherein the decision is made based on:
   a deployment scenario or radio environment of the communication device; and/or
   sensitivities or architectures of types of receivers of the communication device.
AAA15. The method of any of embodiments AAA1-AAA14, wherein making the decision comprises:
   deciding to use a first type of signal and/or a first type of receiver for performing the measurement if the communication device is in an indoor environment or a dense urban deployment; and
   deciding to use a second type of signal and/or a second type of receiver for performing the measurement if the communication device is in an outdoor environment or a rural deployment.
AAA16. The method of any of embodiments AAA1-AAA15, wherein the decision is made based on which type of signal and/or which type of receiver a serving cell, or a target cell, of the communication device supports.
AAA17. The method of any of embodiments AAA1-AAA16, wherein the decision is made based on whether or not the communication device needs to change, or has changed, a serving cell of the communication device.
AAA18. The method of embodiment AAA17, wherein the decision is made to preferentially use a second type of signal and/or a second type of receiver when the communication device needs to change, or has changed, a serving cell of the communication device.
AAA19. The method of any of embodiments AAA1-AAA18, wherein the decision is a decision on which type of signal to use for performing the measurement.
AAA20. The method of embodiment AAA19, wherein the decision is a decision on which type of signal to use for performing the measurement, out of multiple types of signals with which the communication device is capable of performing the measurement, wherein the multiple types of signals include a first type of signal and a second type of signal.
AAA21. The method of embodiment AAA20, wherein:
   the first type of signal is an on-off keying, OOK, signal or a frequency shift keying, FSK, signal; and
   the second type of signal is based on a Zadoff-Chu sequence or a maximum length sequence, m-sequence.
AAA22. The method of embodiment AAA20, wherein:
   the first type of signal is WUR synchronization signal, WUR-SS, or that is included in a WUR synchronization signal block, WUR-SSB, wherein the WUR-SS or WUR-SSB is receivable by and/or specific for a WUR; and
   the second type of signal is a SS or SSB which is not receivable by and/or is not specific for a WUR.
AAA23. The method of embodiment AAA20, wherein the first type of signal and the second type of signal are:
   a first type of synchronization signal and a second type of synchronization signal; or
   a synchronization signal in a first type of synchronization signal block, SSB, and a synchronization signal in a second type of SSB.
AAA24. The method of embodiment AAA20, wherein the first type of signal and the second type of signal are a first type of reference signal and a second type of reference signal.
AAA25. The method of any of embodiments AAA1-AAA24, wherein the decision is a decision on which type of receiver to use for performing the measurement.
AAA26. The method of embodiment AAA25, wherein the decision is a decision on which type of receiver to use for performing the measurement, out of multiple types of receivers with which the communication device is equipped, wherein the multiple types include a first type of receiver and a second type of receiver.
AAA27. The method of embodiment AAA26, wherein the first type of receiver is a wake-up receiver, WUR.
AAA28. The method of any of embodiments AAA26-AAA27, wherein the first type of receiver is a receiver configured to receive a wake-up signal that triggers the communication device to awaken the second type of receiver from a sleep state.
AAA29. The method of any of embodiments AAA26-AAA28, wherein the first type of receiver is a non-coherent receiver and the second type of receiver is a coherent receiver.
AAA30. The method of any of embodiments AAA1-AAA29, wherein the measurement is a mobility measurement, a radio resource management, RRM, measurement, a synchronization measurement, or a cell identification measurement.
AAA31. The method of any of embodiments AAA1-AAA30, wherein the measurement is a reference signal received power, RSRP, measurement or a reference signal received quality, RSRQ, measurement.
AAA32. The method of any of embodiments AAA1-AAA31, further comprising using a result of the measurement for mobility, RRM, synchronization, or cell identification.
AAA33. The method of any of embodiments AAA1-AAA32, wherein the decision is made according to one or more rules, and wherein the method further comprises receiving signaling configuring at least one of the one or more rules.
AAAA1. A method performed by a communication device, the method comprising:
   performing a measurement at different times with different types of signals and/or different types of receivers.
AAAA2. The method of embodiment AAAA1, wherein performing the measurement comprises:
   periodically performing the measurement with a first type of signal and/or a first type of receiver, according to a first period; and
   periodically performing the measurement with a second type of signal and/or a second type of receiver, according to a second period that is longer than the first period.
AAAA3. The method of embodiment AAAA2, further comprising receiving signaling indicating the first period and/or the second period.
AAAA4. The method of any of embodiments AAAA2-AAAA3, wherein the second period is a multiple of the first period.
AAAA5. The method of any of embodiments AAAA2-AAAA3, wherein the second period is aligned with the first period, with the measurement being performed only with the second type of signal and/or the second type of receiver during any overlap between the first period and the second period.
AAAA6. A method performed by a communication device, the method comprising:
   receiving signaling indicating a first period according to which the communication device is to periodically perform a measurement with a first type of signal and/or a first type of receiver; and/or
   receiving signaling indicating a second period according to which the communication device is to periodically perform a measurement with a second type of signal and/or a second type of receiver.
AAAA7. The method of embodiment AAAA6, further comprising performing the measurement at different times with different types of signals and/or different types of receivers, wherein performing the measurement comprises:
   periodically performing the measurement with the first type of signal and/or the first type of receiver, according to the first period; and
   periodically performing the measurement with the second type of signal and/or the second type of receiver, according to the second period, wherein the second period is longer than the first period.
AAAA8. The method of any of embodiments AAAA6-AAAA7, wherein the signaling indicates the first period and the second period.
AAAA9. The method of any of embodiments AAAA6-AAAA8, wherein the second period is a multiple of the first period.
AAAA10. The method of any of embodiments AAAA6-AAAA9, wherein the second period is aligned with the first period, with the measurement being performed only with the second type of signal and/or the second type of receiver during any overlap between the first period and the second period.
AAAAA1. A method performed by a network node, the method comprising:
   determining a period with which the communication device is to periodically perform a measurement, based on whether or not the communication device has or is operating with a wake-up receiver; and
   periodically performing the measurement with the determined period.
AAAAA2. The method of embodiment AAAAA1, wherein determining the period comprises:
   determining the period to be a first period if the communication device has or is operating with a wake-up receiver; and
   determining the period to be a second periodicity if the communication device does not have or is not operating with a wake-up receiver, wherein the second period is shorter than the first period.
AAAAA3. The method of embodiment AAAAA2, further comprising receiving signaling indicating the first period and/or the second period.
AAAAA4. The method of any of embodiments AAAAA1-AAAAA3, wherein periodically performing the measurement comprises periodically performing the measurement with a receiver that is not a wake-up receiver.
AAAAA5. A method performed by a communication device, the method comprising:
   making a decision of whether or not to relax measurements, based on whether or not the communication device has or is operating with a wake-up receiver; and
   relaxing or not relaxing measurements according to the decision.
AAAAA6. The method of embodiment AAAAA5, wherein the decision is made to relax measurements if the communication device has or is operating with a wake-up receiver.
AAAAA7. The method of any of embodiments AAAAA5-AAAAA6, wherein the measurements are mobility measurements, radio resource management, RRM, measurements, synchronization measurements, or cell identification measurements.
AAAAAA1. A method performed by a communication device that has a first receiver and a second receiver, the method comprising:
   using the first receiver to monitor for a wake-up signal that is to trigger the communication device to awaken the second receiver; and
   periodically awakening the second receiver, even if no wake-up signal is received, to check for signaling indicating an update to System Information.
AAAAAA2. The method of embodiment AAAAAA1, wherein the second receiver is periodically awakened to check for a value tag in System Information Block #1, SIB1, indicating an update to System Information, wherein SIB1 includes scheduling information for one or more other System Information Blocks.
AAAAAA3. The method of any of embodiments AAAAAA1-AAAAAA2, wherein the second receiver is periodically awakened with a period that is longer than a period of wake-up signal occasions that the first receiver monitors for a wake-up signal.
AAAAAA4. The method of any of embodiments AAAAAA1-AAAAAA2, wherein the second receiver is periodically awakened upon expiration of a timer.
AAAAAA5. The method of any of embodiments AAAAAA1-AAAAAA4, wherein periodically awakening the second receiver comprises awakening the second receiver if the first receiver has been unable to monitor for the wake-up signal, and/or if the communication device has been out of coverage, for at least a threshold amount of time.
AAAAAA6. The method of any of embodiments AAAAAA1-AAAAAA5, further comprising:
   based on the check, receiving, using the second receiver, signaling indicating an update to System Information; and
   based on the signaling, monitoring for updated System Information.
AAAAAA7. A method performed by a communication device that has a first receiver and a second receiver, the method comprising:
   receiving a signal that indicates an update to System Information, wherein the signal is a wake-up signal, a WUR reference signal, a WUR synchronization signal, or a signal included in a WUR SSB.
AAAAAA8. The method of embodiment AAAAAA7, wherein the signal is specific for indicating an update to System Information that governs a configuration of a WUR of the communication device.
AAAAAA9. The method of embodiment AAAAAA7, wherein the signal is generic for indicating an update to any kind of System Information.
AAAAAA10. The method of any of embodiments AAAAAA7-AAAAAA9, further comprising, based on the signal, monitoring for updated System Information.
AA. The method of any of the previous embodiments, further comprising:
   providing user data; and
   forwarding the user data to a host computer via the transmission to a base station.

### Group B Embodiments

B1. A method performed by a network node, the method comprising:
   transmitting, to a communication device, signaling indicating which type of signal and/or which type of receiver the communication device is to use for a purpose.
B2. The method of embodiment B1, wherein the signaling indicates which type of signal the communication device is to use for a purpose, out of multiple types of signals that are usable for the purpose, wherein the multiple types of signals include:
   a first type of signal that is receivable by a first type of receiver; and
   a second type of signal that is receivable by a second type of receiver and is not receivable by the first type of receiver.
B3. The method of embodiment B2, wherein the first type of receiver is a wake-up receiver, WUR.
B4. The method of any of embodiments B2-B3, wherein the first type of receiver is a receiver configured to receive a wake-up signal that triggers the communication device to awaken the second type of receiver from a sleep state.
B5. The method of any of embodiments B2-B4, wherein the first type of receiver is a non-coherent receiver and the second type of receiver is a coherent receiver.
B6. The method of any of embodiments B1-B5, wherein the signaling indicates which type of signal the communication device is to use for a purpose, out of multiple types of signals that are usable for the purpose, wherein the multiple types of signals include:
   a first type of signal that is an on-off keying, OOK, signal or a frequency shift keying, FSK, signal; and
   a second type of signal that is based on a Zadoff-Chu sequence or a maximum length sequence, m-sequence.
B7. The method of any of embodiments B1-B6, wherein the signaling indicates which type of signal the communication device is to use for a purpose, out of multiple types of signals that are usable for the purpose, wherein the multiple types of signals include:
   a first type of signal that is a WUR synchronization signal, WUR-SS, or that is included in a WUR synchronization signal block, WUR-SSB, wherein the WUR-SS or WUR-SSB is receivable by and/or specific for a WUR; and
   a second type of signal that is a SS or SSB which is not receivable by and/or is not specific for a WUR.
B8. The method of any of embodiments B1-B7, wherein the signaling indicates which type of signal the communication device is to use for a purpose, out of multiple types of signals that are usable for the purpose, wherein the multiple types of signals include
   a first type of synchronization signal and a second type of synchronization signal; or
   a synchronization signal in a first type of synchronization signal block, SSB, and a synchronization signal in a second type of SSB.
B9. The method of any of embodiments B1-B7, wherein the signaling indicates which type of signal the communication device is to use for a purpose, out of multiple types of signals that are usable for the purpose, the multiple types of signals include a first type of reference signal and a second type of reference signal.
B10. The method of any of embodiments B1-B9, wherein the purpose is mobility measurements or radio resource management, RRM, measurements.
B11. The method of any of embodiments B1-B10, wherein the purpose is cell identification.
B12. The method of any of embodiments B1-B11, wherein the purpose is synchronization.
B13. The method of any of embodiments B1-B12, wherein the signaling indicates which type of signal and/or which type of receiver the communication device is to use for the purpose in a Radio Resource Control, RRC, idle state or in an RRC inactive state.
B14. The method of any of embodiments B1-B13, wherein the signaling indicates which type of signal and/or which type of receiver the communication device is to use for the purpose in a cell.
B15. The method of any of embodiments B1-B14, wherein the signaling is broadcast signaling and/or is included in System Information.
B16. The method of any of embodiments B1-B15, wherein the signaling is included in a wake-up receiver configuration that configures a wake-up receiver of the communication device.
B17. The method of any of embodiments B1-B16, wherein the signaling comprises a message, wherein a value of, or a presence or absence of, a certain information element, IE, in the message indicates which type of signal and/or which type of receiver the communication device is to use for the purpose.
B18. The method of any of embodiments B1-B18, wherein the signaling indicates which type of receiver the communication device is to use for the purpose.
B19. The method of embodiment B18, wherein the signaling indicates which type of receiver the communication device is to use for the purpose, out of multiple types of receivers usable for the purpose, wherein the multiple types include a first type of receiver and a second type of receiver.
B20. The method of embodiment B19, wherein the first type of receiver is a wake-up receiver, WUR.
B21. The method of any of embodiments B19-B20, wherein the first type of receiver is a receiver configured to receive a wake-up signal that triggers the communication device to awaken the second type of receiver from a sleep state.
B22. The method of any of embodiments B19-B21, wherein the first type of receiver is a non-coherent receiver and the second type of receiver is a coherent receiver.
B22A. The method of any of embodiments B1-B21, further comprising making a decision about which type of signal and/or which type of receiver the communication device is to use for the purpose.
B23. A method performed by a network node, the method comprising:
   transmitting, to a communication device, signaling indicating which type of signal and/or which type of receiver the communication device is to use for mobility measurements and/or cell identification.
B24. The method of embodiment B23, wherein the signaling indicates whether the communication device is to use, for mobility measurements and/or cell identification:
   a first type of signal that is a WUR synchronization signal, WUR-SS, or that is included in a WUR synchronization signal block, WUR-SSB, wherein the WUR-SS or WUR-SSB is receivable by and/or specific for a WUR; or
   a second type of signal that is a SS or SSB which is not receivable by and/or is not specific for a WUR.
B25. The method of any of embodiments B23-B24, making a decision about which type of signal and/or which type of receiver the communication device is to use for the mobility measurements and/or cell identification.
BB1. A method performed by a network node, the method comprising:
   transmitting, to a communication device, signaling that indicates a serving cell measurement threshold based on which the communication device is to make a decision on whether or not to perform a neighbor cell measurement on one or more neighbor cells of the communication device.
BB2. The method of embodiment BB1, wherein the serving cell measurement threshold is a reference signal received power, RSRP, measurement threshold or a reference signal received quality, RSRQ, measurement threshold.
BB3. The method of any of embodiments BB1-BB2, wherein the communication device is to:
   make the decision to perform the neighbor cell measurement if a result of a serving cell measurement is below the serving cell measurement threshold; or
   make the decision to not perform the neighbor cell measurement if a result of a serving cell measurement is above the serving cell measurement threshold.
BB4. The method of any of embodiments BB1-BB3, wherein the decision is a decision on in which of multiple measurement modes the communication device is to operate, wherein the multiple measurement modes include:
   a serving cell only measurement mode in which the communication device performs a serving cell measurement, without performing any neighbor cell measurement; and
   a full measurement mode in which the communication device performs both a serving cell measurement and the neighbor cell measurement.
BB5. The method of any of embodiments BB1-BB4, wherein the decision is to be made based on a serving cell measurement performed on a signal that the communication device receives from a serving cell using a wake-up receiver of the communication device.
BB6. The method of any of embodiments BB1-BB5, wherein the decision is to be made based on a serving cell measurement performed on a WUR-SS or WUR-SSB received on a serving cell.
BBB1. A method performed by a network node, the method comprising:
   transmitting, to a communication device, signaling that configures or governs a decision by the communication device on which type of signal and/or which type of receiver the communication device is to use for performing a measurement.
BBB2. The method of embodiment BBB1, wherein the decision is to be made based on:
   a result of the measurement as previously performed; and/or
   a distance between the communication device and a serving radio network node serving the communication device.
BBB3. The method of any of embodiments BBB1-BBB2, wherein the signaling configures the communication device to:
   decide to use a first type of signal and/or a first type of receiver for performing the measurement if a result of the measurement as previously performed using the first type of signal and/or the first type of receiver is above a first threshold; and
   decide to use a second type of signal and/or a second type of receiver for performing the measurement if the result of the measurement as previously performed using the first type of signal and/or the first type of receiver is below a second threshold;
   wherein the signaling indicates the first threshold and/or the second threshold.
BBB4. The method of any of embodiments BBB1-BBB3, wherein the signaling configures the communication device to:
   decide to use a first type of signal and/or a first type of receiver for performing the measurement if a distance between the communication device and a serving radio network node serving the communication device is above a first threshold; and
   decide to use a second type of signal and/or a second type of receiver for performing the measurement if the distance between the communication device and the serving radio network node serving the communication device is below a second threshold;
   wherein the signaling indicates the first threshold and/or the second threshold.
BBB5. The method of any of embodiments BBB1-BBB3, wherein the signaling configures the communication device to:
   decide to use a first type of signal and/or a first type of receiver for performing the measurement if a distance between the communication device and a serving radio network node serving the communication device is below a first threshold; and
   decide to use a second type of signal and/or a second type of receiver for performing the measurement if the distance between the communication device and the serving radio network node serving the communication device is above a second threshold;
   wherein the signaling indicates the first threshold and/or the second threshold.
BBB6. The method of any of embodiments BBB1-BBB5, wherein the signaling configures the communication device to use a second type of signal and/or a second type of receiver for performing the measurement if:
   one or more attempts to perform the measurement using a first type of signal and/or a first type of receiver have failed a threshold number of times, have failed for a threshold amount of time, and/or have failed over a threshold number of duty cycles, wherein the signaling indicates the threshold number of times, the threshold amount of time, and/or the threshold number of duty cycles; and/or
   a timer expires, wherein the communication device is configured to start the timer upon failure of one or more attempts to perform the measurement using a first type of signal and/or a first type of receiver, and wherein the communication device is configured to stop the timer upon success of one or more attempts to perform the measurement using the first type of signal and/or the first type of receiver, wherein the signaling indicates a duration of the timer.
BBB7. The method of any of embodiments BBB1-BBB6, wherein the signaling configures the communication device to make the decision as part of making decisions to use different types of signals and/or different types of receivers at different times.
BBB8. The method of embodiment BBB7, wherein the signaling configures the communication device to:
   periodically decide to perform the measurement with a first type of signal and/or a first type of receiver, according to a first period; and
   periodically decide to perform the measurement with a second type of signal and/or a second type of receiver, according to a second period that is longer than the first period;
   wherein the signaling indicates the first period and/or the second period.
BBB9. Reserved.
BBB10. The method of any of embodiments BBB8-BBB9, wherein the second period is a multiple of the first period.
BBB11. The method of any of embodiments BBB8-BBB10, wherein the second period is aligned with the first period, wherein the signaling configures the communication device to perform the measurement only with the second type of signal and/or the second type of receiver during any overlap between the first period and the second period.
BBB12. The method of any of embodiments BBB1-BBB11, wherein the communication device is powered by a battery, and wherein the decision is to be made based on a charge level of the battery.
BBB13. The method of embodiment BBB12, wherein the signaling configures the communication device to:
   decide to use a first type of signal and/or a first type of receiver for performing the measurement if the charge level is below a first threshold; and
   decide to use a second type of signal and/or a second type of receiver for performing the measurement if the charge level is above a second threshold;
   wherein the signaling indicates the first threshold and/or the second threshold.
BBB14. The method of any of embodiments BBB1-BBB13, wherein the signaling configures the communication device to make the decision based on:
   a deployment scenario or radio environment of the communication device; and/or
   sensitivities or architectures of types of receivers of the communication device.
BBB15. The method of any of embodiments BBB1-BBB14, wherein the signaling configures the communication device to:
   decide to use a first type of signal and/or a first type of receiver for performing the measurement if the communication device is in an indoor environment or a dense urban deployment; and
   decide to use a second type of signal and/or a second type of receiver for performing the measurement if the communication device is in an outdoor environment or a rural deployment.
BBB16. The method of any of embodiments BBB1-BBB15, wherein the signaling configures the communication device to make the decision based on which type of signal and/or which type of receiver a serving cell, or a target cell, of the communication device supports.
BBB17. The method of any of embodiments BBB1-BBB16, wherein the signaling configures the communication device to make the decision based on whether or not the communication device needs to change, or has changed, a serving cell of the communication device.
BBB18. The method of embodiment BBB17, wherein the signaling configures the communication device to decide to preferentially use a second type of signal and/or a second type of receiver when the communication device needs to change, or has changed, a serving cell of the communication device.
BBB19. The method of any of embodiments BBB1-BBB18, wherein the decision is a decision on which type of signal to use for performing the measurement.
BBB20. The method of embodiment BBB19, wherein the decision is a decision on which type of signal to use for performing the measurement, out of multiple types of signals with which the communication device is capable of performing the measurement, wherein the multiple types of signals include a first type of signal and a second type of signal.
BBB21. The method of embodiment BBB20, wherein:
   the first type of signal is an on-off keying, OOK, signal or a frequency shift keying, FSK, signal; and
   the second type of signal is based on a Zadoff-Chu sequence or a maximum length sequence, m-sequence.
BBB22. The method of embodiment BBB20, wherein:
   the first type of signal is WUR synchronization signal, WUR-SS, or that is included in a WUR synchronization signal block, WUR-SSB, wherein the WUR-SS or WUR-SSB is receivable by and/or specific for a WUR; and
   the second type of signal is a SS or SSB which is not receivable by and/or is not specific for a WUR.
BBB23. The method of embodiment BBB20, wherein the first type of signal and the second type of signal are:
   a first type of synchronization signal and a second type of synchronization signal; or
   a synchronization signal in a first type of synchronization signal block, SSB, and a synchronization signal in a second type of SSB.
BBB24. The method of embodiment BBB20, wherein the first type of signal and the second type of signal are a first type of reference signal and a second type of reference signal.
BBB25. The method of any of embodiments BBB1-BBB24, wherein the decision is a decision on which type of receiver to use for performing the measurement.
BBB26. The method of embodiment BBB25, wherein the decision is a decision on which type of receiver to use for performing the measurement, out of multiple types of receivers with which the communication device is equipped, wherein the multiple types include a first type of receiver and a second type of receiver.
BBB27. The method of embodiment BBB26, wherein the first type of receiver is a wake-up receiver, WUR.
BBB28. The method of any of embodiments BBB26-BBB27, wherein the first type of receiver is a receiver configured to receive a wake-up signal that triggers the communication device to awaken the second type of receiver from a sleep state.
BBB29. The method of any of embodiments BBB26-BBB28, wherein the first type of receiver is a non-coherent receiver and the second type of receiver is a coherent receiver.
BBB30. The method of any of embodiments BBB1-BBB29, wherein the measurement is a mobility measurement, a radio resource management, RRM, measurement, a synchronization measurement, or a cell identification measurement.
BBB31. The method of any of embodiments BBB1-BBB30, wherein the measurement is a reference signal received power, RSRP, measurement or a reference signal received quality, RSRQ, measurement.
BBB32. The method of any of embodiments BBB1-BBB31, further comprising receiving a result of the measurement for mobility, RRM, synchronization, or cell identification.
BBB33. The method of any of embodiments BBB1-BBB32, wherein the decision is made according to one or more rules, and wherein the signaling configures at least one of the one or more rules.
BBBBB1. A method performed by a network node, the method comprising:
   transmitting, to a communication device, signaling indicating:
   a first period with which the communication device is to periodically perform a measurement when the communication device has or is operating with a wake-up receiver; and/or
   a second period with which the communication device is to periodically perform a measurement when the communication device does not have or is not operating with a wake-up receiver.
BBBBB2. The method of embodiment BBBBB1, wherein:
   the first period is a period with which the communication device is to periodically perform the measurement with a receiver that is not a wake-up receiver, when the communication device has or is operating with a wake-up receiver; and/or
   the second period is a period with which the communication device is to periodically perform the measurement with a receiver that is not a wake-up receiver, when the communication device does not have or is not operating with a wake-up receiver.
BBBBB5. A method performed by a network node, the method comprising:
   transmitting, to a communication device, signaling that configures the communication device to make a decision of whether or not to relax measurements based on whether or not the communication device has or is operating with a wake-up receiver.
BBBBB6. The method of embodiment BBBBB5, wherein the signaling configures the communication device to decide to relax measurements if the communication device has or is operating with a wake-up receiver.
BBBBB7. The method of any of embodiments BBBBB5-BBBBB6, wherein the measurements are mobility measurements, radio resource management, RRM, measurements, synchronization measurements, or cell identification measurements.
BBBBBB1. A method performed by a network node, the method comprising:
   transmitting a signal that indicates an update to System Information, wherein the signal is a wake-up signal, a WUR reference signal, a WUR synchronization signal, or a signal included in a WUR SSB.
BBBBBB2. The method of embodiment BBBBBB1, wherein the signal is specific for indicating an update to System Information that governs a configuration of a WUR of a communication device.
BBBBBB3. The method of embodiment BBBBBB1, wherein the signal is generic for indicating an update to any kind of System Information.
BB. The method of any of the previous embodiments, further comprising:
   obtaining user data; and
   forwarding the user data to a host computer or a communication device.

### Group C Embodiments

C1. A communication device configured to perform the method of any of the Group A embodiments.
C2. A communication device comprising processing circuitry configured to perform the method of any of the Group A embodiments.
C3. A communication device comprising:
   communication circuitry; and
   processing circuitry configured to perform the method of any of the Group A embodiments.
C4. A communication device comprising:
   processing circuitry configured to perform the method of any of the Group A embodiments; and
   power supply circuitry configured to supply power to the communication device.
C5. A communication device comprising:
   processing circuitry and memory, the memory containing instructions executable by the processing circuitry whereby the communication device is configured to perform the method of any of the Group A embodiments.
C6. The communication device of any of embodiments C1-C5, wherein the communication device is a wireless communication device.
C7. A user equipment (UE) comprising:
   an antenna configured to send and receive wireless signals;
   radio front-end circuitry connected to the antenna and to processing circuitry, and configured to condition signals communicated between the antenna and the processing circuitry;
   the processing circuitry being configured to perform the method of any of the Group A embodiments;
   an input interface connected to the processing circuitry and configured to allow input of information into the UE to be processed by the processing circuitry;
   an output interface connected to the processing circuitry and configured to output information from the UE that has been processed by the processing circuitry; and
   a battery connected to the processing circuitry and configured to supply power to the UE.
C8. A computer program comprising instructions which, when executed by at least one processor of a communication device, causes the communication device to perform the method of any of the Group A embodiments.
C9. A carrier containing the computer program of embodiment C7, wherein the carrier is one of an electronic signal, optical signal, radio signal, or computer readable storage medium.
C10. A network node configured to perform the method of any of the Group B embodiments.
C11. A network node comprising processing circuitry configured to perform the method of any of the Group B embodiments.
C12. A network node comprising:
   communication circuitry; and
   processing circuitry configured to perform the method of any of the Group B embodiments.
C13. A network node comprising:
   processing circuitry configured to perform the method of any of the Group B embodiments;
   power supply circuitry configured to supply power to the network node.
C14. A network node comprising:
   processing circuitry and memory, the memory containing instructions executable by the processing circuitry whereby the network node is configured to perform the method of any of the Group B embodiments.
C15. The network node of any of embodiments C10-C14, wherein the network node is a base station.
C16. A computer program comprising instructions which, when executed by at least one processor of a network node, causes the network node to perform the method of any of the Group B embodiments.
C17. The computer program of embodiment C16, wherein the network node is a base station.
C18. A carrier containing the computer program of any of embodiments C16-C17, wherein the carrier is one of an electronic signal, optical signal, radio signal, or computer readable storage medium.

### Group D Embodiments

D1. A host configured to operate in a communication system to provide an over-the-top (OTT) service, the host comprising:
   processing circuitry configured to provide user data; and
   a network interface configured to initiate transmission of the user data to a network node in a cellular network for transmission to a user equipment (UE), the network node having a communication interface and processing circuitry, the processing circuitry of the network node configured to perform the method of any of the Group B embodiments to transmit the user data from the host to the UE.
D2. The host of the previous embodiment, wherein:
   the processing circuitry of the host is configured to execute a host application that provides the user data; and
   the UE comprises processing circuitry configured to execute a client application associated with the host application to receive the transmission of user data from the host.
D3. A method implemented in a host configured to operate in a communication system that further includes a network node and a user equipment (UE), the method comprising:
   providing user data for the UE; and
   initiating a transmission carrying the user data to the UE via a cellular network comprising the network node, wherein the network node performs the method of any of the Group B embodiments to transmit the user data from the host to the UE.
D4. The method of the previous embodiment, further comprising, at the network node, transmitting the user data provided by the host for the UE.
D5. The method of any of the previous 2 embodiments, wherein the user data is provided at the host by executing a host application that interacts with a client application executing on the UE, the client application being associated with the host application.
D6. A communication system configured to provide an over-the-top service, the communication system comprising:
   a host comprising:
   processing circuitry configured to provide user data for a user equipment (UE), the user data being associated with the over-the-top service; and
   a network interface configured to initiate transmission of the user data toward a cellular network node for transmission to the UE, the network node having a communication interface and processing circuitry, the processing circuitry of the network node configured to perform the method of any of the Group B embodiments to transmit the user data from the host to the UE.
D7. The communication system of the previous embodiment, further comprising:
   the network node; and/or
   the user equipment.
D8. The communication system of the previous 2 embodiments, wherein:
   the processing circuitry of the host is configured to execute a host application, thereby providing the user data; and
   the host application is configured to interact with a client application executing on the UE, the client application being associated with the host application.
D9. A host configured to operate in a communication system to provide an over-the-top (OTT) service, the host comprising:
   processing circuitry configured to initiate receipt of user data; and
   a network interface configured to receive the user data from a network node in a cellular network, the network node having a communication interface and processing circuitry, the processing circuitry of the network node configured to perform method of any of the Group B embodiments to receive the user data from the UE for the host.
D10. The host of the previous 2 embodiments, wherein:
   the processing circuitry of the host is configured to execute a host application, thereby providing the user data; and
   the host application is configured to interact with a client application executing on the UE, the client application being associated with the host application.
D11. The host of the any of the previous 2 embodiments, wherein the initiating receipt of the user data comprises requesting the user data.
D12. A method implemented by a host configured to operate in a communication system that further includes a network node and a user equipment (UE), the method comprising:
   at the host, initiating receipt of user data from the UE, the user data originating from a transmission which the network node has received from the UE, wherein the network node performs the method of any of the Group B embodiments to receive the user data from the UE for the host.
D13. The method of the previous embodiment, further comprising at the network node, transmitting the received user data to the host.
D14. A host configured to operate in a communication system to provide an over-the-top (OTT) service, the host comprising:
   processing circuitry configured to provide user data; and
   a network interface configured to initiate transmission of the user data to a cellular network for transmission to a user equipment (UE), wherein the UE comprises a communication interface and processing circuitry, the communication interface and processing circuitry of the UE being configured to perform the method of any of the Group A embodiments to receive the user data from the host.
D15. The host of the previous embodiment, wherein the cellular network further includes a network node configured to communicate with the UE to transmit the user data to the UE from the host.
D16. The host of the previous 2 embodiments, wherein:
   the processing circuitry of the host is configured to execute a host application, thereby providing the user data; and
   the host application is configured to interact with a client application executing on the UE, the client application being associated with the host application.
D17. A method implemented by a host operating in a communication system that further includes a network node and a user equipment (UE), the method comprising:
   providing user data for the UE; and
   initiating a transmission carrying the user data to the UE via a cellular network comprising the network node, wherein the UE performs the method of any of the Group A embodiments to receive the user data from the host.
D18. The method of the previous embodiment, further comprising:
   at the host, executing a host application associated with a client application executing on the UE to receive the user data from the UE.
D19. The method of the previous embodiment, further comprising:
   at the host, transmitting input data to the client application executing on the UE, the input data being provided by executing the host application,
   wherein the user data is provided by the client application in response to the input data from the host application.
D20. A host configured to operate in a communication system to provide an over-the-top (OTT) service, the host comprising:
   processing circuitry configured to utilize user data; and
   a network interface configured to receipt of transmission of the user data to a cellular network for transmission to a user equipment (UE),
   wherein the UE comprises a communication interface and processing circuitry, the communication interface and processing circuitry of the UE being configured to perform the method of any of the Group A embodiments to transmit the user data to the host.
D21. The host of the previous embodiment, wherein the cellular network further includes a network node configured to communicate with the UE to transmit the user data from the UE to the host.
D22. The host of the previous 2 embodiments, wherein:
   the processing circuitry of the host is configured to execute a host application, thereby providing the user data; and
   the host application is configured to interact with a client application executing on the UE, the client application being associated with the host application.
D23. A method implemented by a host configured to operate in a communication system that further includes a network node and a user equipment (UE), the method comprising:
   at the host, receiving user data transmitted to the host via the network node by the UE, wherein the UE performs the method of any of the Group A embodiments to transmit the user data to the host.
D24. The method of the previous embodiment, further comprising:
   at the host, executing a host application associated with a client application executing on the UE to receive the user data from the UE.
D25. The method of the previous embodiments, further comprising:
   at the host, transmitting input data to the client application executing on the UE, the input data being provided by executing the host application,
   wherein the user data is provided by the client application in response to the input data from the host application.

### REFERENCES

1. RP-213645, “New SID: Study on low-power Wake-up Signal and Receiver for NR”, RAN plenary #94, December 2021.
2. RP-222644, “Revised SID on low-power WUS WUR for NR”, RAN plenary #97e, September 2022.

### ABBREVIATIONS

At least some of the following abbreviations may be used in this disclosure. If there is an inconsistency between abbreviations, preference should be given to how it is used above. If listed multiple times below, the first listing should be preferred over any subsequent listing(s).

| | |
|---|---|
| CIC | Cow In Coverage |
| COOC | Cow Out Of Coverage |
| MIB | Master Information Block |
| PBCH | Physical Broadcast Channel |
| PSS | Primary Synchronization Signal |
| SSB | Synchronization Signal Block |
| SSS | Secondary Synchronization Signal |
| WUR | Wake-Up Radio |
| WUS | Wake-Up Signal |
| 1x RTT | CDMA2000 1x Radio Transmission Technology |
| 3GPP | 3rd Generation Partnership Project |
| 5G | 5th Generation |
| 6G | 6^{th} Generation |
| ABS | Almost Blank Subframe |
| ARQ | Automatic Repeat Request |
| AWGN | Additive White Gaussian Noise |
| BCCH | Broadcast Control Channel |
| BCH | Broadcast Channel |
| CA | Carrier Aggregation |
| CC | Carrier Component |
| CCCH SDU | Common Control Channel SDU |
| CDMA | Code Division Multiplexing Access |
| CGI | Cell Global Identifier |
| CIR | Channel Impulse Response |
| CP | Cyclic Prefix |
| CPICH | Common Pilot Channel |
| CPICH | Ec/No CPICH Received energy per chip |
| | divided by the power density in the band |
| CQI | Channel Quality information |
| C-RNTI | Cell RNTI |
| CSI | Channel State Information |
| DCCH | Dedicated Control Channel |
| DL | Downlink |
| DM | Demodulation |
| DMRS | Demodulation Reference Signal |
| DRX | Discontinuous Reception |
| DTX | Discontinuous Transmission |
| DTCH | Dedicated Traffic Channel |
| DUT | Device Under Test |
| E-CID | Enhanced Cell-ID (positioning method) |
| eMBMS | evolved Multimedia Broadcast Multicast Services |
| E-SMLC | Evolved-Serving Mobile Location Centre |
| ECGI | Evolved CGI |
| eNB | E-UTRAN NodeB |
| ePDCCH | Enhanced Physical Downlink Control Channel |
| E-SMLC | Evolved Serving Mobile Location Center |
| E-UTRA | Evolved UTRA |
| E-UTRAN | Evolved UTRAN |
| FDD | Frequency Division Duplex |
| FFS | For Further Study |
| gNB | Base station in NR |
| GNSS | Global Navigation Satellite System |
| HARQ | Hybrid Automatic Repeat Request |
| HO | Handover |
| HSPA | High Speed Packet Access |
| HRPD | High Rate Packet Data |
| LOS | Line of Sight |
| LPP | LTE Positioning Protocol |
| LTE | Long-Term Evolution |
| MAC | Medium Access Control |
| MAC | Message Authentication Code |
| MBSFN | Multimedia Broadcast multicast |
| | service Single Frequency Network |
| MBSFN ABS | MBSFN Almost Blank Subframe |
| MDT | Minimization of Drive Tests |
| MIB | Master Information Block |
| MME | Mobility Management Entity |
| MSC | Mobile Switching Center |
| NPDCCH | Narrowband Physical Downlink Control Channel |
| NR | New Radio |
| OCNG | OFDMA Channel Noise Generator |
| OFDM | Orthogonal Frequency Division Multiplexing |
| OFDMA | Orthogonal Frequency Division Multiple Access |
| OSS | Operations Support System |
| OTDOA | Observed Time Difference of Arrival |
| O&M | Operation and Maintenance |
| PBCH | Physical Broadcast Channel |
| P-CCPCH | Primary Common Control Physical Channel |
| PCell | Primary Cell |
| PCFICH | Physical Control Format Indicator Channel |
| PDCCH | Physical Downlink Control Channel |
| PDCP | Packet Data Convergence Protocol |
| PDP | Power Delay Profile |
| PDSCH | Physical Downlink Shared Channel |
| PGW | Packet Gateway |
| PHICH | Physical Hybrid-ARQ Indicator Channel |
| PLMN | Public Land Mobile Network |
| PMI | Precoder Matrix Indicator |
| PRACH | Physical Random Access Channel |
| PRS | Positioning Reference Signal |
| PSS | Primary Synchronization Signal |
| PUCCH | Physical Uplink Control Channel |
| PUSCH | Physical Uplink Shared Channel |
| RACH | Random Access Channel |
| QAM | Quadrature Amplitude Modulation |
| RAN | Radio Access Network |
| RAT | Radio Access Technology |
| RLC | Radio Link Control |
| RLM | Radio Link Management |
| RNC | Radio Network Controller |
| RNTI | Radio Network Temporary Identifier |
| RRC | Radio Resource Control |
| RRM | Radio Resource Management |
| RS | Reference Signal |
| RSCP | Received Signal Code Power |
| RSRP | Reference Symbol Received Power OR |
| | Reference Signal Received Power |
| RSRQ | Reference Signal Received Quality OR |
| | Reference Symbol Received Quality |
| RSSI | Received Signal Strength Indicator |
| RSTD | Reference Signal Time Difference |
| SCH | Synchronization Channel |
| SCell | Secondary Cell |
| SDAP | Service Data Adaptation Protocol |
| SDU | Service Data Unit |
| SFN | System Frame Number |
| SGW | Serving Gateway |
| SI | System Information |
| SIB | System Information Block |
| SNR | Signal to Noise Ratio |
| SON | Self Optimized Network |
| SS | Synchronization Signal |
| SSS | Secondary Synchronization Signal |
| TDD | Time Division Duplex |
| TDOA | Time Difference of Arrival |
| TOA | Time of Arrival |
| TSS | Tertiary Synchronization Signal |
| TTI | Transmission Time Interval |
| UE | User Equipment |
| UL | Uplink |
| USIM | Universal Subscriber Identity Module |
| UTDOA | Uplink Time Difference of Arrival |
| WCDMA | Wide CDMA |
| WLAN | Wide Local Area Network |

1.-49. (canceled)

50. A method performed by a communication device, the method comprising:
making a decision on which type of signal and/or which type of receiver to use for performing a mobility measurement; and
performing the mobility measurement according to the decision.

51. The method of claim 50, wherein making the decision comprises:
deciding to use a first type of signal and/or a first type of receiver for performing the mobility measurement if a result of the mobility measurement as previously performed using the first type of signal and/or the first type of receiver is above a first threshold; and
deciding to use a second type of signal and/or a second type of receiver for performing the mobility measurement if the result of the mobility measurement as previously performed using the first type of signal and/or the first type of receiver is below a second threshold.

52. The method of claim 50, wherein making the decision comprises:
deciding to use a first type of signal and/or a first type of receiver for performing the mobility measurement if a distance between the communication device and a serving radio network node serving the communication device is above a first threshold; and
deciding to use a second type of signal and/or a second type of receiver for performing the mobility measurement if the distance between the communication device and the serving radio network node serving the communication device is below a second threshold.

53. The method of claim 50, wherein making the decision comprises deciding to use a second type of signal and/or a second type of receiver for performing the measurement if:
one or more attempts to perform the mobility measurement using a first type of signal and/or a first type of receiver have failed a threshold number of times, have failed for a threshold amount of time, and/or have failed over a threshold number of duty cycles; and/or
a timer expires, wherein the communication device is configured to start the timer upon failure of one or more attempts to perform the mobility measurement using a first type of signal and/or a first type of receiver, and wherein the communication device is configured to stop the timer upon success of one or more attempts to perform the mobility measurement using the first type of signal and/or the first type of receiver.

54. The method of claim 50, further comprising receiving signaling indicating a first period and/or a second period to a second period that is longer than the first period, and wherein making the decisions comprises:
periodically deciding to perform the mobility measurement with a first type of signal and/or a first type of receiver, according to the first period; and
periodically deciding to perform the mobility measurement with a second type of signal and/or a second type of receiver, according to the second period.

55. The method of claim 50, wherein the communication device is powered by a battery, and wherein making the decision comprises:
deciding to use a first type of signal and/or a first type of receiver for performing the measurement if a charge level of the battery is below a first threshold; and
deciding to use a second type of signal and/or a second type of receiver for performing the measurement if the charge level is above a second threshold.

56. The method of claim 50, wherein making the decision comprises:
deciding to use a first type of signal and/or a first type of receiver for performing the measurement if the communication device is in an indoor environment or a dense urban deployment; and
deciding to use a second type of signal and/or a second type of receiver for performing the measurement if the communication device is in an outdoor environment or a rural deployment.

57. The method of claim 50, wherein the decision is made to preferentially use a second type of signal and/or a second type of receiver when the communication device needs to change, or has changed, a serving cell of the communication device.

58. The method of claim 50, wherein the decision is a decision on which type of signal to use for performing the measurement, out of multiple types of signals with which the communication device is capable of performing the measurement, wherein the multiple types of signals include a first type of signal and a second type of signal, wherein:
the first type of signal is an on-off keying (OOK) signal or a frequency shift keying (FSK) signal; and
the second type of signal is based on a Zadoff-Chu sequence or a maximum length sequence, m-sequence.

59. The method of claim 50, wherein the decision is a decision on which type of receiver to use for performing the measurement, out of multiple types of receivers with which the communication device is equipped, wherein the multiple types include a first type of receiver and a second type of receiver, wherein the first type of receiver is a wake-up receiver (WUR) and/or is configured to receive a wake-up signal that triggers the communication device to awaken the second type of receiver from a sleep state.

60. A method performed by a network node, the method comprising:
transmitting, to a communication device, signaling that configures or governs a decision by the communication device on which type of signal and/or which type of receiver the communication device is to use for performing a mobility measurement.

61. The method of claim 60 wherein the signaling configures the communication device to:
decide to use a first type of signal and/or a first type of receiver for performing the mobility measurement if a result of the mobility measurement as previously performed using the first type of signal and/or the first type of receiver is above a first threshold; and
decide to use a second type of signal and/or a second type of receiver for performing the mobility measurement if the result of the mobility measurement as previously performed using the first type of signal and/or the first type of receiver is below a second threshold;
wherein the signaling indicates the first threshold and/or the second threshold.

62. The method of claim 60, wherein the signaling configures the communication device to:
decide to use a first type of signal and/or a first type of receiver for performing the mobility measurement if a distance between the communication device and a serving radio network node serving the communication device is above a first threshold; and
decide to use a second type of signal and/or a second type of receiver for performing the mobility measurement if the distance between the communication device and the serving radio network node serving the communication device is below a second threshold;
wherein the signaling indicates the first threshold and/or the second threshold.

63. The method of claim 60, wherein the signaling configures the communication device to use a second type of signal and/or a second type of receiver for performing the mobility measurement if:
one or more attempts to perform the mobility measurement using a first type of signal and/or a first type of receiver have failed a threshold number of times, have failed for a threshold amount of time, and/or have failed over a threshold number of duty cycles, wherein the signaling indicates the threshold number of times, the threshold amount of time, and/or the threshold number of duty cycles; and/or
a timer expires, wherein the communication device is configured to start the timer upon failure of one or more attempts to perform the mobility measurement using a first type of signal and/or a first type of receiver, and wherein the communication device is configured to stop the timer upon success of one or more attempts to perform the mobility measurement using the first type of signal and/or the first type of receiver, wherein the signaling indicates a duration of the timer.

64. The method of claim 60, wherein the signaling configures the communication device to:
periodically decide to perform the mobility measurement with a first type of signal and/or a first type of receiver, according to a first period; and
periodically decide to perform the mobility measurement with a second type of signal and/or a second type of receiver, according to a second period that is longer than the first period;
wherein the signaling indicates the first period and/or the second period.

65. The method of claim 60, wherein the communication device is powered by a battery, and wherein the signaling configures the communication device to:
decide to use a first type of signal and/or a first type of receiver for performing the mobility measurement if the charge level is below a first threshold; and
decide to use a second type of signal and/or a second type of receiver for performing the mobility measurement if the charge level is above a second threshold;
wherein the signaling indicates the first threshold and/or the second threshold.

66. The method of claim 60, wherein the signaling configures the communication device to:
decide to use a first type of signal and/or a first type of receiver for performing the mobility measurement if the communication device is in an indoor environment or a dense urban deployment; and
decide to use a second type of signal and/or a second type of receiver for performing the mobility measurement if the communication device is in an outdoor environment or a rural deployment.

67. The method of claim 60, wherein the signaling configures the communication device to decide to preferentially use a second type of signal and/or a second type of receiver when the communication device needs to change, or has changed, a serving cell of the communication device.

68. A communication device comprising:
communication circuitry; and
processing circuitry configured to:
make a decision on which type of signal and/or which type of receiver to use for performing a mobility measurement; and
perform the mobility measurement according to the decision.

69. A network node comprising:
communication circuitry; and
processing circuitry configured to cause the network node to perform the method of claim 60.
